(19) United States
(12) Patent Application Publication
(10) Pub. No.: US 2002/0062317 A1
(43) Pub. Date: May 23, 2002

(54) Apparatuses and method for information processing

(76) Inventors: Masanori Wakai, Kanagawa (JP); Naoko Yamamoto, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/984,699

(22) Filed: Oct. 31, 2001

(30) Foreign Application Priority Data
Nov. 2, 2000 (JP) 336530/2000

(51) Int. Cl. G06F 7/00

(52) U.S. Cl. 707/100

(57) ABSTRACT

The present invention is an information processor that accepts accesses to a database by applications and characterized by including a notification unit for notifying, when the content of the database is changed by one of said applications, the rest of said applications of the change. When a plurality of applications accesses an identical database, this allows the applications to use the database appropriately without putting restrictions on accesses between applications.

### FIELD OF THE INVENTION

The present invention relates to a database processing technology.

### BACKGROUND OF THE INVENTION

A variety of databases for handling permanent data are being proposed. Such databases are normally said to require complicated know-how including a coding procedure specific to a database module.

Here, the problem is that in the case where a plurality of applications access an identical database, while a specific application is editing data in the database, if another application updates the database, the application performing the editing cannot carry out appropriate processing.

FIG. 83 illustrates problems related to updating when a plurality of applications access an identical database in a conventional technology.

In the same figure, an application A102001 and application X102002 are generating a DB transaction A102004 and a DB transaction X102005 using a DB manager 102003 to access the identical database 102006.

Here, while the application X102002 acquires (I) a DB object a102007 stored in the database 102006, if the application A102001 acquires (II) or deletes (III) the DB object a102007, then even if the application X102002 attempts to update (IV) the DB object a012007 to reflect the result of editing the DB object a102007, this attempt fails because the DB object a102007, the target, has already been deleted and no longer exists at that time.

Thus, when a plurality of applications access an identical database, there would sometimes be unexpected failures in the conventional technology.

FIG. 84 illustrates problems caused by a discrepancy between a display and database when a plurality of applications access an identical database in the conventional technology.

In the same figure, an application A102101 and an application X102102 are accessing an identical database 102103.

Here, while the application X102102 acquires (I) or lists a DB object a102104 etc. stored in a database 102103, even if the application A102101 acquires (II) or deletes (III) the DB object a102104, the application X102102 cannot know the change, which may cause the display content to differ from the content of the database.

As shown above, when a plurality of applications access an identical database, the conventional technology may fail to execute appropriate processing such as redrawing.

Here, the Japanese Patent Laid-open No. 5-265836 specification proposes a technique of controlling permanent data and temporary data by linking these data to each other. On the other hand, the Japanese Patent Laid-open No. 5-265837 specification proposes a technique of notifying a control system of a change of temporary data. Furthermore, the Japanese Patent Laid-open No. 6-337794 specification proposes a technique of forcibly replacing program codes in order for a plurality of programs to share data and programs. Moreover, the Japanese Patent Laid-open No. 8-272744 specification proposes a technique of controlling access right among a plurality of applications.

However, none of these techniques can solve the above-described problems sufficiently. On the other hand, a technique of solving the problem when a plurality of applications access an identical database, by rejecting an acquisition request by an application attempting to access the database later is also proposed. FIG. 85 illustrates an example thereof.

In the same figure, an application A102201 and application X102202 are generating a DB transaction A102204 and a DB transaction X102205 using a DB manager 102203 to access an identical database 102206.

Here, while the application X102202 acquires (I) a DB object a102207 stored in the database 102206, if the application A102201 attempts to acquire (II) the DB object a102207 to delete the DB object a102207, this attempts result in an error and the DB object a102207 is not deleted because the DB object a102007 has already been acquired by the application X102202, and therefore the application X102202 can update (III) the DB object a102207 to reflect the result of editing the DB object a102207.

Thus, using exclusive control makes it possible to avoid unexpected failures even if different applications delete target data.

However, this technique involves a restriction that data being accessed by one application is not accessible to other applications.

### SUMMARY OF THE INVENTION

It is an object of the present invention to allow a plurality of applications accessing an identical database to make full use of the database appropriately without providing any restrictions on access among the applications.

According to the present invention, there is provided an information processor that accepts accesses to a database by applications, comprising notifying means for notifying, when the content of said database is changed by one of said applications, the rest of said applications of the change.

According to the present invention, there is also provided an information processing method that accepts accesses to a database by applications, comprising the step of notifying, when the content of said database is changed by one of said applications, the rest of said applications of the change.

According to the present invention, there is also provided a storage medium that stores a program for rendering a computer that accepts accesses to a database by applications to function as notifying means for notifying, when the content of said database is changed by one of said applications, the rest of said applications of the change.

According to the present invention, there is also provided a program for rendering a computer that accepts accesses to a database by applications to function as notifying means for notifying, when the content of said database is changed by one of said applications, the rest of said applications of the change.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a hardware configuration of an information processor according to an embodiment of the present invention;

FIG. 2 is a flow chart showing processing executed by the information processor;

FIG. 3 illustrates an example of a database processing screen;

FIG. 4 is a flow chart showing details of the database processing in step S205;

FIG. 5 illustrates an example of a transaction generation screen;

FIG. 6 is a flow chart showing details of the transaction generation processing in step S406;

FIG. 7 illustrates an example of a transaction processing screen;

FIG. 8 is a flow chart showing details of the transaction processing in step S408;

FIG. 9 illustrates an example of an additional object selection screen;

FIG. 10 is a flow chart showing details of object selection/addition processing corresponding to an instruction of an addition of an object in event handling processing;

FIG. 11 illustrates an example of an object editing screen when a new object is created;

FIG. 12 is a flow chart showing details of the object generation processing in step S1006;

FIG. 13 illustrates an example of a class selection screen;

FIG. 14 illustrates an example of an object editing screen when an existing object is edited;

FIG. 15 is a flow chart showing details of object selection/editing processing;

FIG. 16 illustrates an example of an object reference screen when an existing object is referenced;

FIG. 17 is a flow chart showing details of object selection/deletion processing;

FIG. 18 is a flow chart showing details of the all objects acquisition confirmation processing in step S1503 and step S1703;

FIG. 19 is a flow chart showing details of the object addition confirmation processing in step S1007;

FIG. 20 is a flow chart showing details of the object update confirmation processing in step S1509;

FIG. 21 is a flow chart showing details of the object deletion confirmation processing in step S1709;

FIG. 22 illustrates a functional configuration of the information processor;

FIG. 23 illustrates internal data of a DB transaction;

FIG. 24 is a flow chart showing details of the DB transaction generation processing in step S603;

FIG. 25 is a flow chart showing details of the DB transaction start processing in step S1801, step S1901, step S2001 and step S2101;

FIG. 26 is a flow chart showing details of the DB transaction confirmation processing in step S1804, step S1904, step S2004 and step S2104;

FIG. 27 is a flow chart showing details of the DB transaction cancellation processing in step S1805, step S1905, step S2005 and step S2105;

FIG. 28 illustrates a relationship between objects used by the information processor;

FIG. 29 illustrates a programming code of an application object;

FIG. 30 illustrates a list of database objects;

FIG. 31 is a flow chart showing details of the all objects acquisition processing in step S1802;

FIG. 32 is a flow chart showing details of the object addition processing in step S1902;

FIG. 33 is a flow chart showing details of the object update processing in step S2002;

FIG. 34 is a flow chart showing details of the object deletion processing in step S2102;

FIG. 35 is a flow chart showing details of the all DB objects acquisition processing in step S5902;

FIG. 36 is a flow chart showing details of the DB object generation/addition processing in step S6002;

FIG. 37 is a flow chart showing details of the DB object deletion processing in step S6204;

FIG. 38 is a flow chart showing details of the DB object value setting processing in step S5907 and step S6003;

FIG. 39 is a flow chart showing details of the object generation processing in step S5906;

FIG. 40 is a flow chart showing details of the object value setting processing in step S5907;

FIG. 41 is a flow chart showing details of the all writable field name acquisition processing in step S7301 and step S7501;

FIG. 42 illustrates layered database operating means of an information processor according to Second Embodiment;

FIG. 43 illustrates a layered DB transaction structure according to Second Embodiment;

FIG. 44 illustrates internal data of the layered DB transaction according to Second Embodiment;

FIG. 45 illustrates an example of a transaction generation screen to select a database type according to Second Embodiment;

FIG. 46 illustrates an example of a transaction generation screen to enter a server name according to Second Embodiment;

FIG. 47 is a flow chart showing details of the DB transaction generation processing according to Second Embodiment;

FIG. 48 illustrates an example of a relationship between packages which are a set of several purposes of the layered DB transaction structure according to Second Embodiment;

FIG. 49 illustrates an example of a relationship between classes of the layered DB transaction structure according to Second Embodiment;

FIG. 50 illustrates an example of a basic class layer of the layered DB transaction structure according to Second Embodiment;

FIG. 51 illustrates an example of the layered transaction structure when a database exists on an identical device as that of an application program according to Second Embodiment;

FIG. 52 illustrates an example of a basic class layer when expanded to a local database according to Second Embodiment;

FIG. 53 illustrates an example of a layered DB transaction structure when a database exists in a device different from that of the application program according to Second Embodiment;

FIG. 54 illustrates an example of a basic class layer when expanded to a remote database according to Second Embodiment;

FIG. 55 illustrates an example of a layered DB transaction structure when a database service is supplied to an application program on a different device according to Second Embodiment;

FIG. 56 illustrates an example of a basic class layer when a remote interface is expanded so that a database IF layer according to Second Embodiment is also accessible to a different device;

FIG. 57 illustrates a flow of notification information accompanying changes in a database according to Third Embodiment;

FIG. 58 illustrates a layered DB transaction structure of the information processor according to Third Embodiment;

FIG. 59 illustrates internal data of a layered DB transaction according to Third Embodiment;

FIG. 60 is a flow chart showing details of the transaction discarding processing in step S409 according to Third Embodiment;

FIG. 61 is a flow chart showing details of DB transaction generation processing according to Third Embodiment;

FIG. 62 is a flow chart showing details of the DB transaction discarding processing in step S10301 according to Third Embodiment;

FIG. 63 is a flow chart showing details of the DB object generation/addition processing in step S6002 according to Third Embodiment;

FIG. 64 is a flow chart showing details of DB object deletion processing according to Third Embodiment;

FIG. 65 is a flow chart showing details of the DB object value setting processing in step S5907 and step S6003 according to Third Embodiment;

FIG. 66 is a flow chart showing details of the DB transaction confirmation processing in step S1804 and step S1904, step S2004 and step S2104 according to Third Embodiment;

FIG. 67 is a flow chart showing details of the update information generation notification processing in step S10906 according to Third Embodiment;

FIG. 68 illustrates an example of notification information generated by the update notification information generation processing in step S11008 according to Third Embodiment;

FIG. 69 is a flow chart showing details of the addition notification information generation processing in step S11002 according to Third Embodiment;

FIG. 70 is a flow chart showing details of the deletion notification information generation processing in step S11005 according to Third Embodiment;

FIG. 71 is a flow chart showing details of the update notification information generation processing in step S11008 according to Third Embodiment;

FIG. 72 is a flow chart showing details of the DBM addition notification information notification processing in step S11003 according to Third Embodiment;

FIG. 73 is a flow chart showing details of the DBM deletion notification information notification processing in step S11006 according to Third Embodiment;

FIG. 74 is a flow chart showing details of the DBM update notification information notification processing in step S11009 according to Third Embodiment;

FIG. 75 is a flow chart showing details of the transaction addition notification information notification processing in step S11503 according to Third Embodiment;

FIG. 76 is a flow chart showing details of the transaction deletion notification information notification processing in step S11603 according to Third Embodiment;

FIG. 77 is a flow chart showing details of the transaction update notification information notification processing in step S11703 according to Third Embodiment;

FIG. 78 is a flow chart showing details of the DB listener addition notification information notification processing in step S11804 according to Third Embodiment;

FIG. 79 is a flow chart showing details of the DB listener deletion notification information notification processing in step S11904 according to Third Embodiment;

FIG. 80 is a flow chart showing details of the DB listener update notification information notification processing in step S12004 according to Third Embodiment;

FIG. 81 illustrates an example of solving problems when a plurality of applications access an identical database according to Third Embodiment;

FIG. 82 illustrates another example of solving problems when a plurality of applications access an identical database according to Third Embodiment;

FIG. 83 illustrates problems related to updating when a plurality of applications access an identical database a conventional technology;

FIG. 84 illustrates problems caused by a discrepancy between a display and database when a plurality of applications access an identical database in a conventional technology; and

FIG. 85 illustrates an example of solving problems through exclusive control when a plurality of applications access an identical database in a conventional technology.

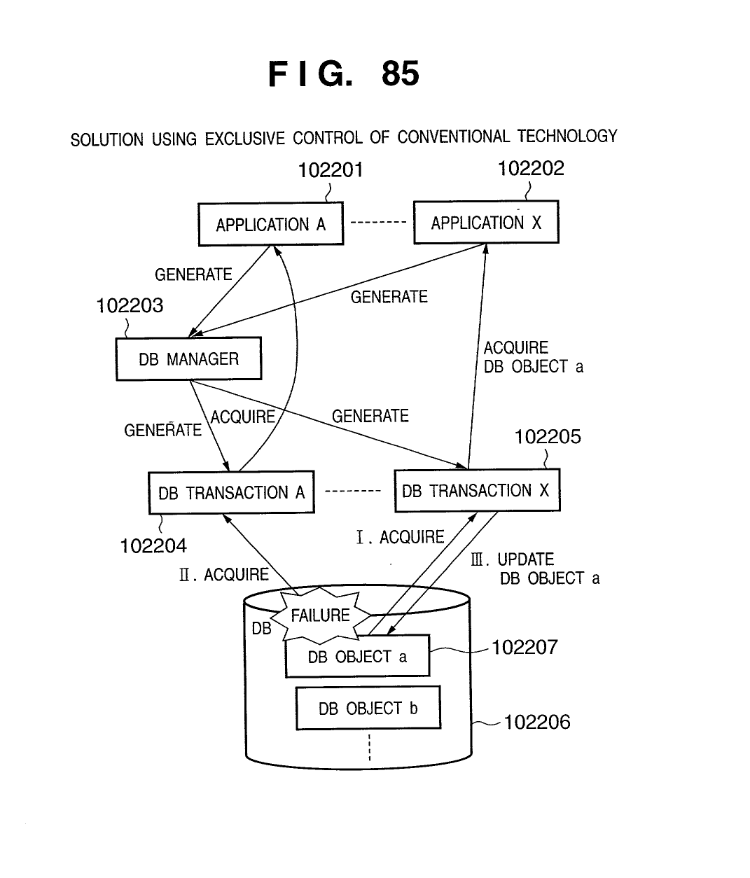

### DETAILED DESCRIPTION OF THE PREFERRED EMBODIMENTS

Preferred embodiments of the present invention will now be described in detail in accordance with the accompanying drawings.

<First Embodiment>

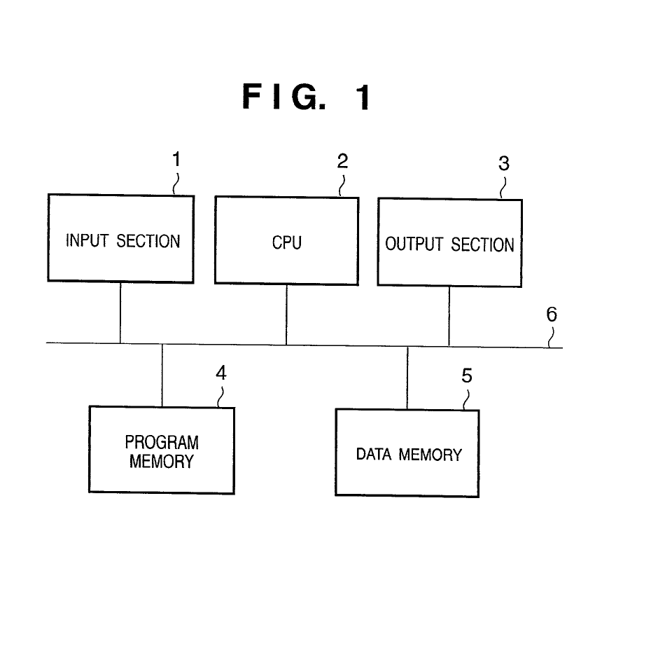

FIG. 1 is a block diagram showing a hardware configuration of an information processor according to First Embodiment and Second Embodiment.

In the same figure, reference numeral 1 denotes an input section to input information (data); 2, a CPU that carries out calculations for various kinds of processing and logical decisions, etc. and controls components connected to a bus 6; 3, an output section that outputs information (data). As the output section 3, a display such as an LCD and CRT and a recording apparatus such as a printer are used.

Reference numeral 4 is a program memory which stores a program for control by the CPU 2 including the processing procedure of a flow chart which will be described later. The program memory 4 can be a ROM or a RAM to which a program is loaded from an external storage apparatus etc.

Reference numeral 5 is a data memory which stores data produced by various kinds of processing and stores data of a database (DB) which will be described later. The data memory 5 can be, for example, a RAM, but the data of the database can be loaded from a non-volatile external storage medium prior to processing or referenced on an as-needed basis.

Reference numeral 6 denotes a bus to transfer an address signal that indicates components to be controlled by the CPU 2, control signals to control components and data sent/received between components.

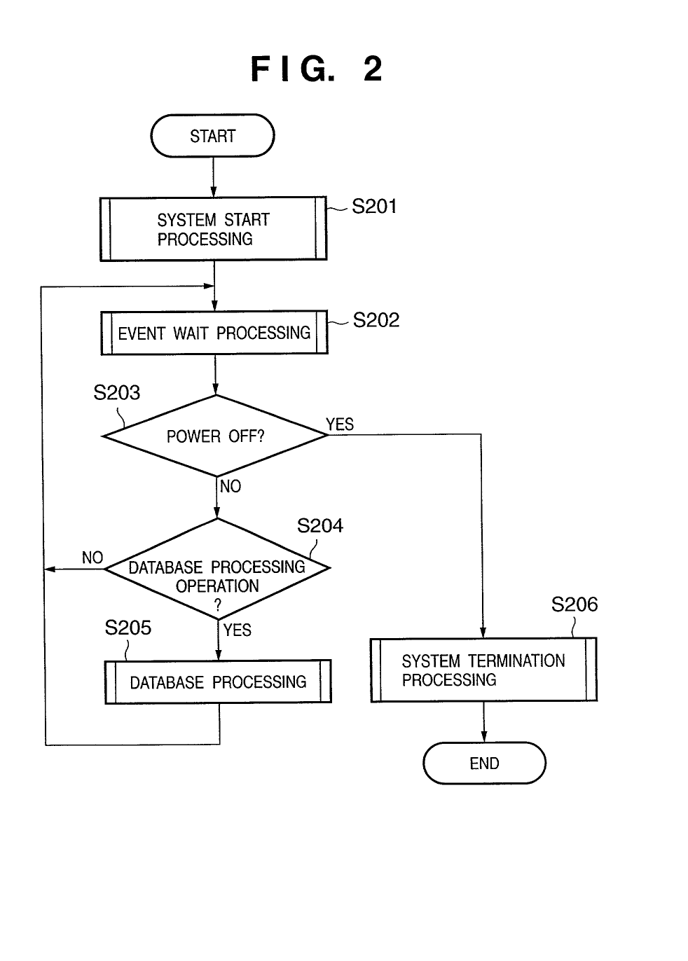

FIG. 2 is a flow chart showing processing executed by the information processor of First Embodiment.

As shown in the same figure, when the system is started, system starting processing is executed and various data is initialized in step S201. Then, instep S202, event waiting processing is executed and the system waits for an event corresponding to the user's operation or events corresponding to various status changes, etc. to occur.

In next step S203, it is determined whether an event that has occurred is an instruction for power OFF or not. If the event is not an instruction for power OFF (step S203: NO), the process moves on to step S204. In step S204, it is determined whether there is an instruction for a database processing operation or not. If there is no instruction for a database processing operation (step S204: NO), the process goes back to step S202. On the other hand, if there is an instruction for a database processing operation (step S204: YES), the process moves onto step S205 and the process goes back to step S202 and repeats the processing after database processing is executed.

On the other hand, in step S203, if the event is an instruction for power OFF (step S203: YES), the process moves on to step S206 and terminates the processing after the system termination processing is executed.

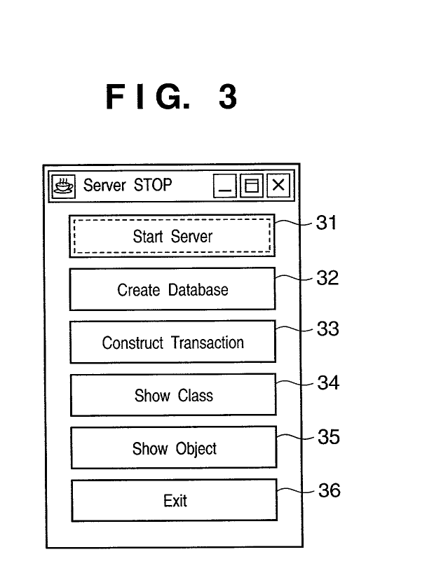

Then, an example of a database processing screen which is displayed in the database processing in step S205 will be explained using FIG. 3.

FIG. 3 illustrates an example of a database processing screen according to First Embodiment.

Reference numeral 31 is a button to instruct a start of a database server service; 32, a button to instruct creation of a database; 33, a button to instruct generation of a transaction; 34, a button to instruct display of class definition information; 35, a button to instruct display of object storage information; 36, a button to instruct an end of processing of a database.

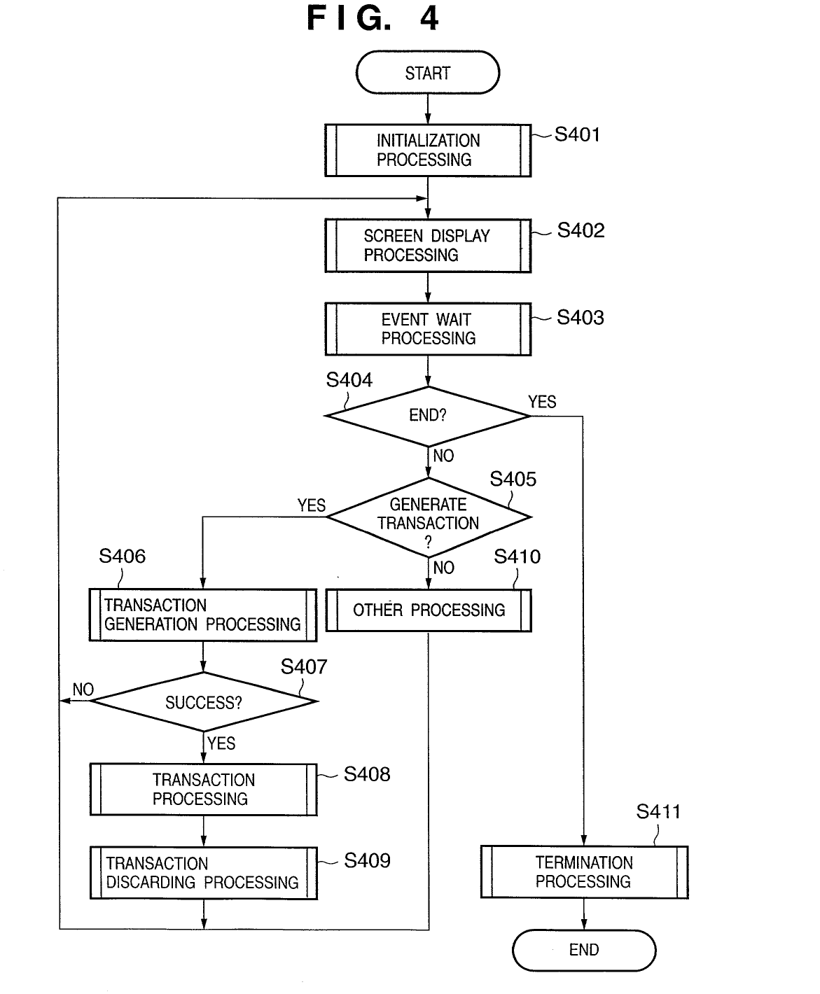

Then, details of the database processing in step S205 will be explained using FIG. 4.

FIG. 4 is a flow chart showing details of the database processing in step S205 of First Embodiment.

When the database processing is started, initialization processing is executed in step S401 to initialize various kinds of internal data.

Then, the screen display processing in step S402 is executed to display the database processing screen explained in FIG. 3. In next step S403, event waiting processing is executed to wait for an event corresponding to the user's operation.

Then, in step S404, it is determined whether an event that has occurred in response to the user's operation is an instruction for an end or not. If the event is an instruction for an end (step S404: YES), the process moves on to step S411 and terminates the processing after executing termination processing. On the other hand, if the event is not an instruction for an end (step S404: NO), the process moves on to step S405.

In step S405, it is determined whether an event is an instruction for generation of a transaction or not. If the event is not an instruction for generation of a transaction (step S405: NO), the process moves on to step S410 and after executing the processing corresponding to the event, goes back to step S402 and repeats the processing. On the other hand, if the event is an instruction for generation of a transaction (step S405: YES), the process moves on to step S406.

In step S406, transaction generation processing is executed to generate a transaction corresponding to the condition indicated by the user. Then, in step S407, it is determined whether the generation of the transaction has been successful or not. If the generation of the transaction has not been successful (step S407: NO), the process goes back to step S402 and repeats the processing. On the other hand, if the generation of the transaction has been successful (step S407: YES), the process moves on to step S408.

In step S408, transaction processing according to the user's instruction is executed. In next step S409, transaction discarding processing is executed to discard processed and unnecessary transactions and the process goes back to step S402 and repeats the processing.

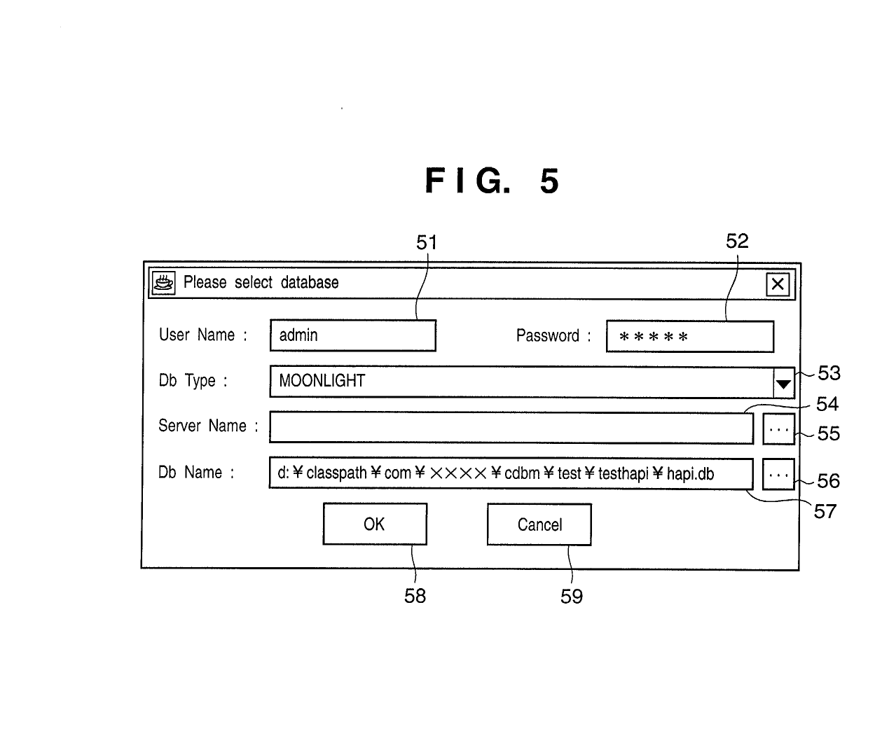

Then, an example of the transaction generation screen displayed in the transaction generation processing in step S406 will be explained using FIG. 5.

FIG. 5 illustrates an example of the transaction generation screen of First Embodiment.

Reference numeral 51 is an area to enter the user's name; 52, an area to enter the password corresponding to the user's name; 53, a combo box to specify the type of a database; 54, an area to enter the name of the server that supplies a service for connection to the database; 55, a button to display a server name selection dialog box used when the server name to be entered in the above-described area to enter the server name is unknown; 56, an area to enter the database name; 57, a button to display a database name selection dialog box used when the database name to be entered in the above-described area to enter the database name is unknown.

Furthermore, reference numeral 58 denotes a button to instruct generation of a transaction using values indicated in the respective areas above. Reference numeral 59 denotes a button to cancel the generation of a transaction.

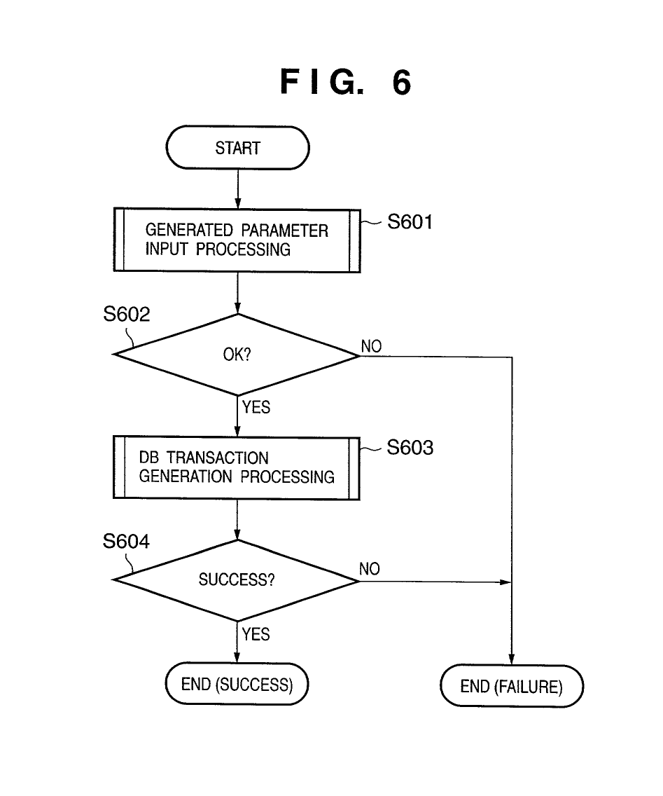

Then, details of the transaction generation processing in step S406 will be explained using FIG. 6.

FIG. 6 is a flow chart showing details of the transaction generation processing in step S406 of First Embodiment.

When the transaction generation processing is started, generation parameter input processing is executed in step S601, the transaction generation processing screen explained in FIG. 5 is displayed and the user specifies various parameters.

In next step S602, it is determined in the above generation parameter input processing whether the user has instructed the generation of a transaction or not. If the generation of a transaction has been instructed (step S602: YES), the process moves on to step S603, executes the DB transaction generation processing to generate a transaction corresponding to various parameters specified by the user.

In next step S604, it is determined whether the DB transaction generation processing has been successful or not. If DB transaction generation processing has been successful (step S604: YES), the processing is regarded as a “success” and terminated.

On the other hand, if the DB transaction generation processing has not been successful in step S604 (step S604: NO) or the generation of a transaction is not instructed in step S602 (step S602: NO), the processing is regarded as a “failure” and terminated.

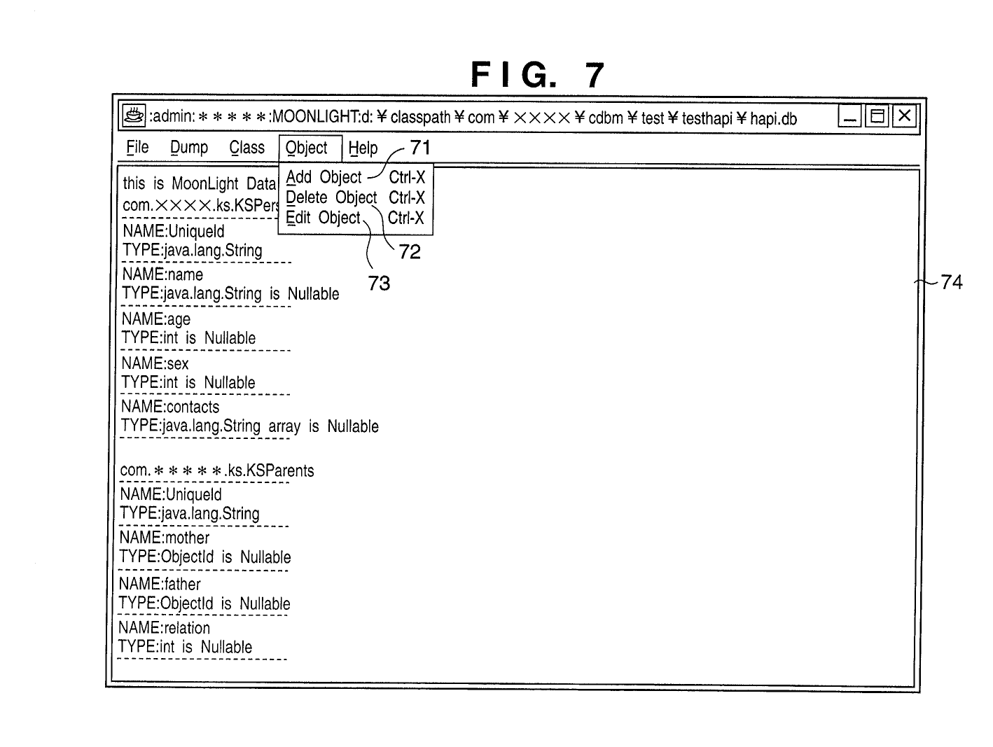

Then, an example of the transaction processing screen displayed in the transaction processing in step S408 will be explained using FIG. 7.

FIG. 7 illustrates an example of the transaction processing screen of First Embodiment.

Reference numeral 71 denotes a menu item instructing the addition of an object; 72, a menu item instructing the deletion of an object; 73, a menu item instructing the editing of an object.

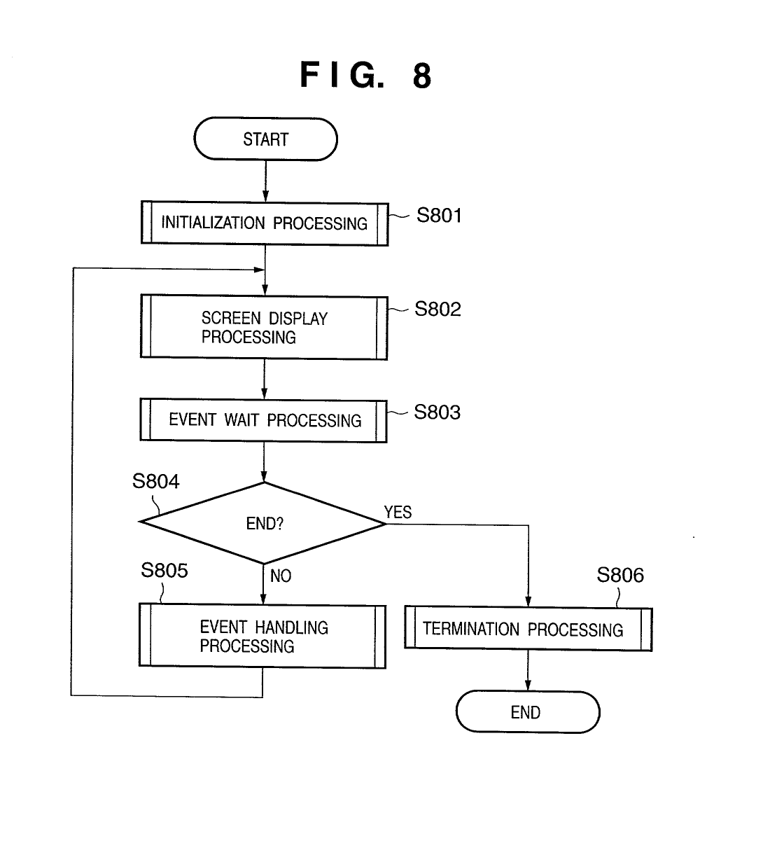

Then, details of the transaction processing in step S408 will be explained using FIG. 8.

FIG. 8 is a flow chart showing details of the transaction processing in step S408 of First Embodiment.

When the transaction processing is started, initialization processing is executed in step S801 to initialize various kinds of internal data.

Then, in step S802, screen display processing is executed to display the transaction processing screen explained in FIG. 7. In next step S803, event waiting processing is executed and the system waits for an event corresponding to the user's operation.

Then, in step S804, it is determined whether the event that has occurred in response to the user's operation is an instruction for an end of the event or not. If the event is an instruction for an end (step S804: YES), the process moves on to step S806 and terminates the processing after executing termination processing. On the other hand, if the event is not an instruction for an end (step S804: NO), the process moves on to step S805, executes event handling processing and after executing the event handling processing, goes back to step S802 and repeats the processing.

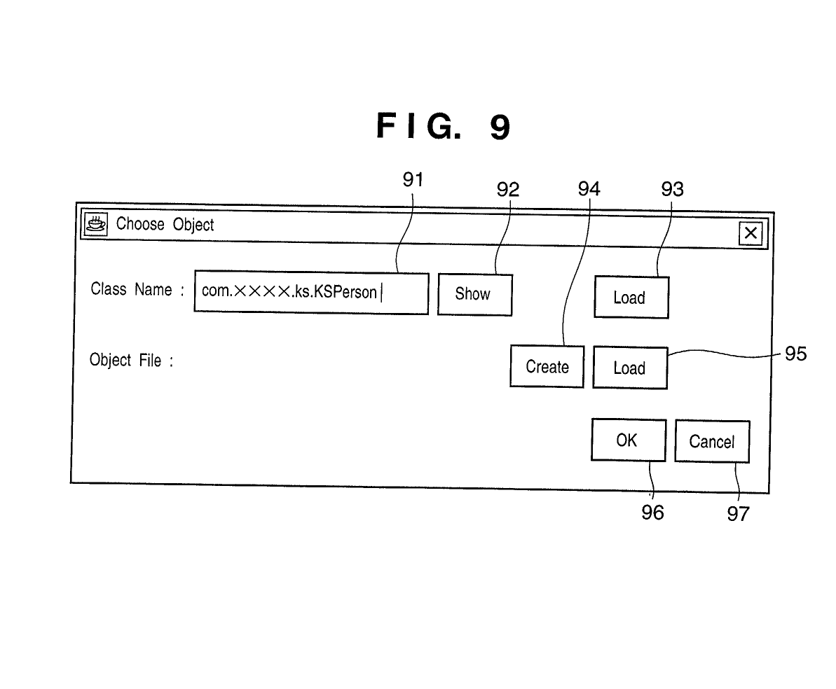

Then, an example of an additional object selection screen displayed by object selection/addition processing corresponding to the instruction for an addition of an object in the event handling processing in step S805 will be explained using FIG. 9.

FIG. 9 illustrates an example of the additional object selection screen of First Embodiment.

Reference numeral 91 denotes an area to enter the class name; 92, a button to display a class information dialog box to display class information specified in the area to enter the class name; 93, a button to display a class file selection dialog box to select/load a file storing the class information used when the class name to be entered in the area to enter the class name is unknown.

Reference numeral 94 denotes a button to generate an object corresponding to the class specified in the area to enter the class name. Reference numeral 95 denotes a button to display an object file selection dialog box to select/load an existing object file.

Reference numeral 96 denotes a button to instruct an addition of an object generated or loaded using each button above. Reference numeral 97 denotes a button to cancel the addition of an object.

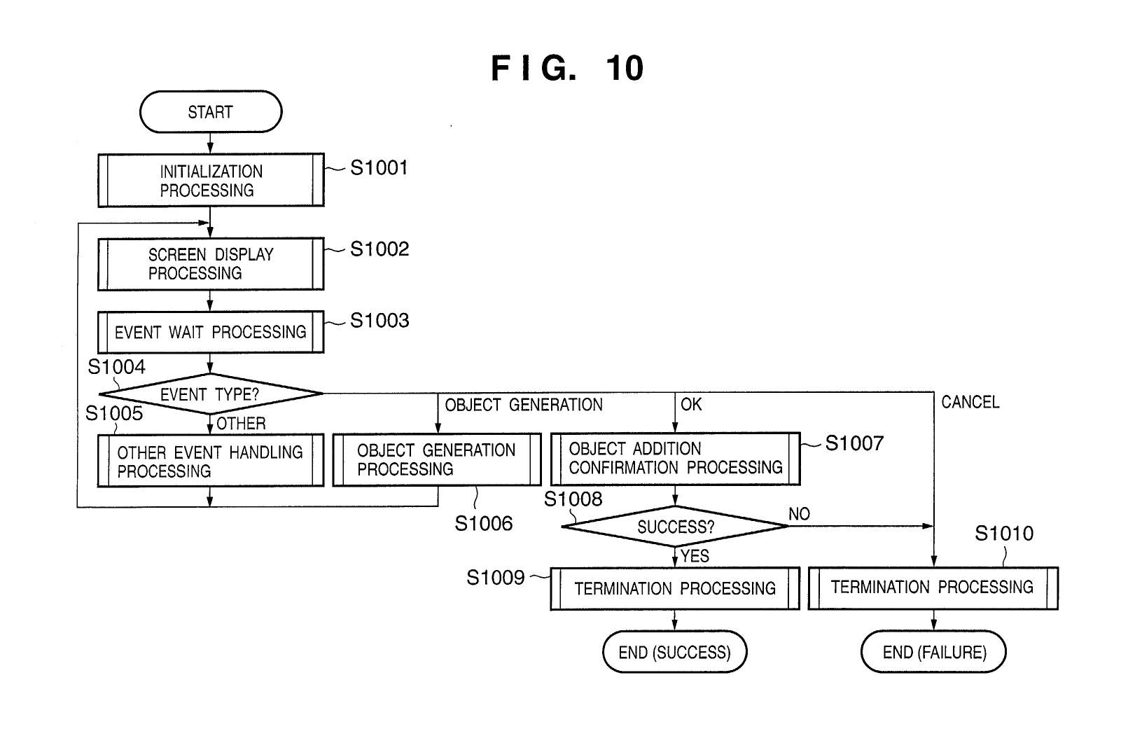

Then, details of object selection/addition processing corresponding to an instruction for an addition of an object in the event handling processing in step S805 will be described using FIG. 10.

FIG. 10 is a flow chart showing details of object selection/addition processing corresponding to an instruction of an addition of an object in event handling processing of First Embodiment.

When the object selection/addition processing is started, initialization processing is carried out in step S1001 to initialize various internal data.

Then, in step S1002, screen display processing is executed to display the additional object selection screen described in FIG. 9. In next step S1003, event waiting processing is executed and the system waits for the event corresponding to the user's operation.

Then, in step S1004, the type of event that has occurred in response to the operation carried out by the user is determined and the process branches to the corresponding processing.

When the event type is an instruction for generation of an object, the process moves on to step S1006, executes object generation processing and after generating the object, the process goes back to step S1002 and repeats the processing.

When the event type is an instruction for an addition of an object generated or loaded above, the process moves on to step S1007, executes object addition confirmation processing and after adding the object to a database, confirms the change. As a result, in next step S1008, it is determined whether the change of the object has been successful or not. If the change of the object has been successful (step S1008: YES), the process moves on to step S1009 and after executing the termination processing, the process regards the change to be “successful”, and terminates the processing. On the other hand, if the change of the object has not been successful (step S1008: NO), after executing the termination processing in step S1010, the process regards the change to be a “failure” and terminates the processing.

When the event type is other than the above-described type, the process moves on to step S1005, after executing other processing corresponding to the event through other event handling processing, the process goes back to step S1002 and repeats the processing.

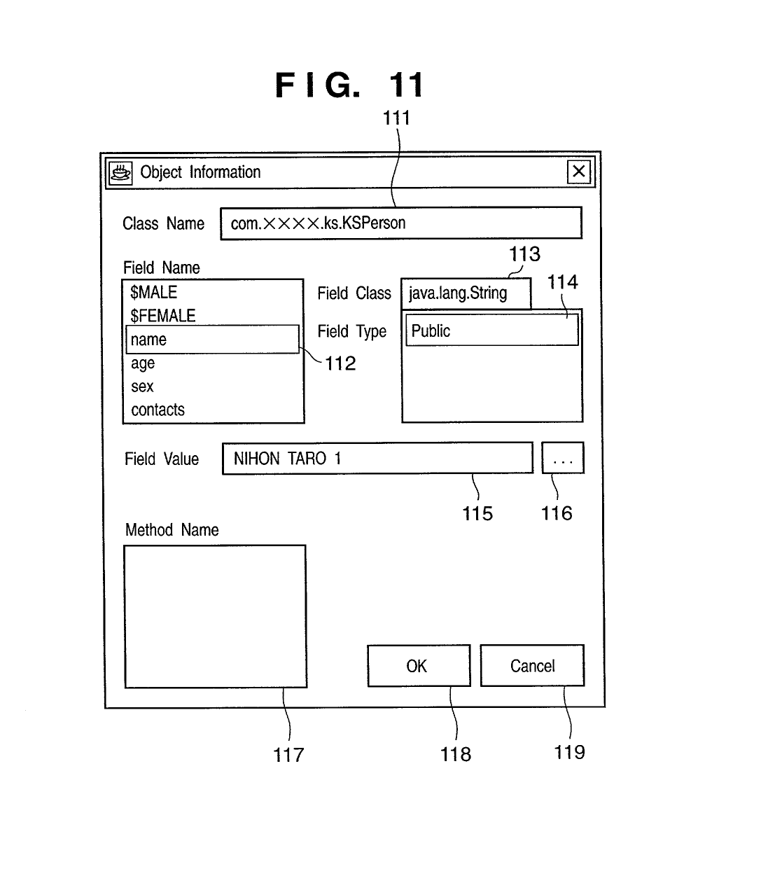

Then, an example of the object editing screen displayed during the object generation processing in step S1006 when an object is newly created will be explained using FIG. 11.

FIG. 11 illustrates an example of an object editing screen of First Embodiment when a new object is created.

Reference numeral 111 is an area to show the class name of an object to be edited; 112, an area to show the field name list that the object class has; 113, an area to show the class name of the field selected from the field name list; 114, an area to show the attribute of the same field.

Reference numeral 115 is an area to enter a value stored in the same field; 116, a button to display an object specification dialog box to specify an object which is difficult to be directly input to the entry area; 117, an area to show the method name list that the object class has.

Reference numeral 118 is a button to indicate a confirmation of the editing content of the object edited above; 119, a button to cancel the editing content of the object.

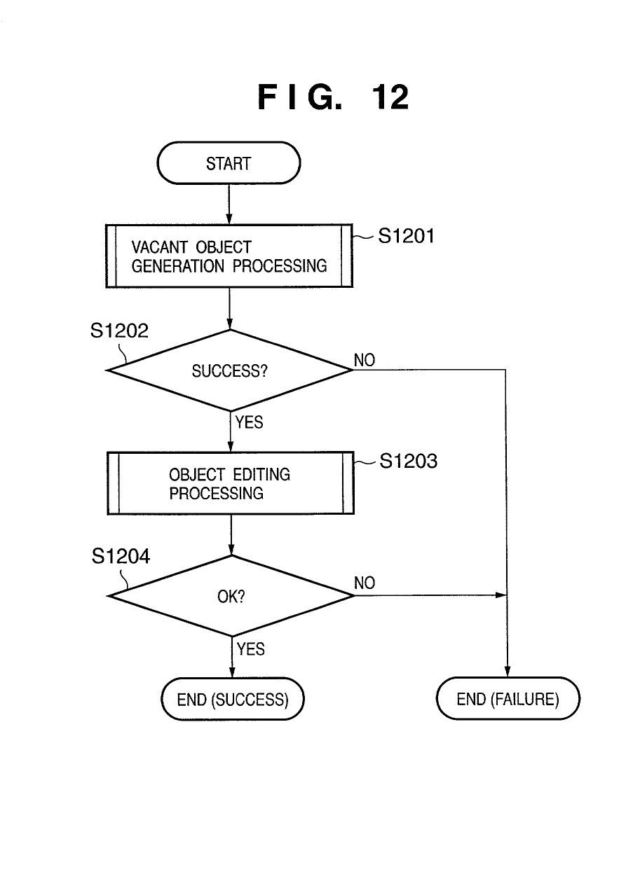

Then, details of the object generation processing in step S1006 will be explained using FIG. 12.

FIG. 12 is a flow chart showing details of the object generation processing in step S1006 of First Embodiment.

When object generation processing is started, vacant object generation processing is executed in step S1201 and a default instance corresponding to the specified class is generated.

As a result of the vacant object generation processing, it is determined in step S1202 whether generation of a default instance has been successful or not. When generation of a default instance has been successful (step S1202: YES), the process moves on to step S1203, executes object editing processing, displays the object editing screen explained in FIG. 11 and accepts the user's operation.

As a result of the object editing processing, it is determined in next step S1204 whether a confirmation of the object editing content has been instructed or not. If the confirmation of the object editing content has been instructed (step S1204: YES), the process regards the object editing as a “success” and terminates the processing.

On the other hand, if the confirmation of the object editing content has not been instructed in step S1204 (step S1204: NO), or the generation of a default instance has not been successful in step S1202 (step S1202: NO), the process regards the object editing as a “failure” and terminates the processing.

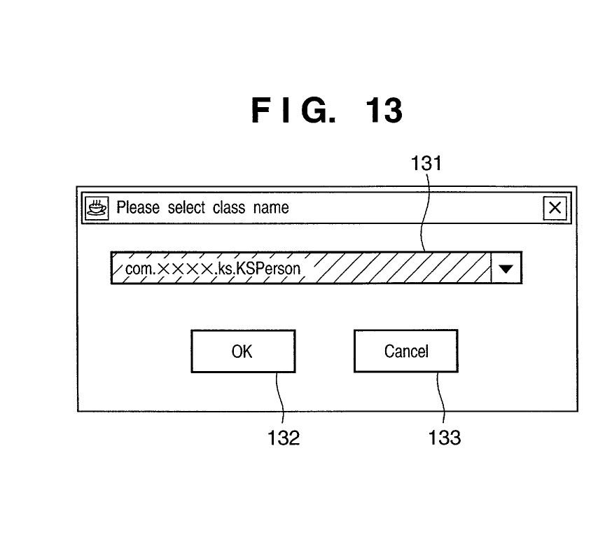

Then, an example of a class selection screen displayed by object selection/editing processing corresponding to an instruction for editing of an object in the event handling processing in step S805 will be explained using FIG. 13.

FIG. 13 illustrates an example of a class selection screen of First Embodiment.

Reference numeral 131 is a class name selection list.

Furthermore, reference numeral 132 is a button to instruct editing of an object corresponding to the class selected above. Reference numeral 133 is a button to cancel the editing of the object.

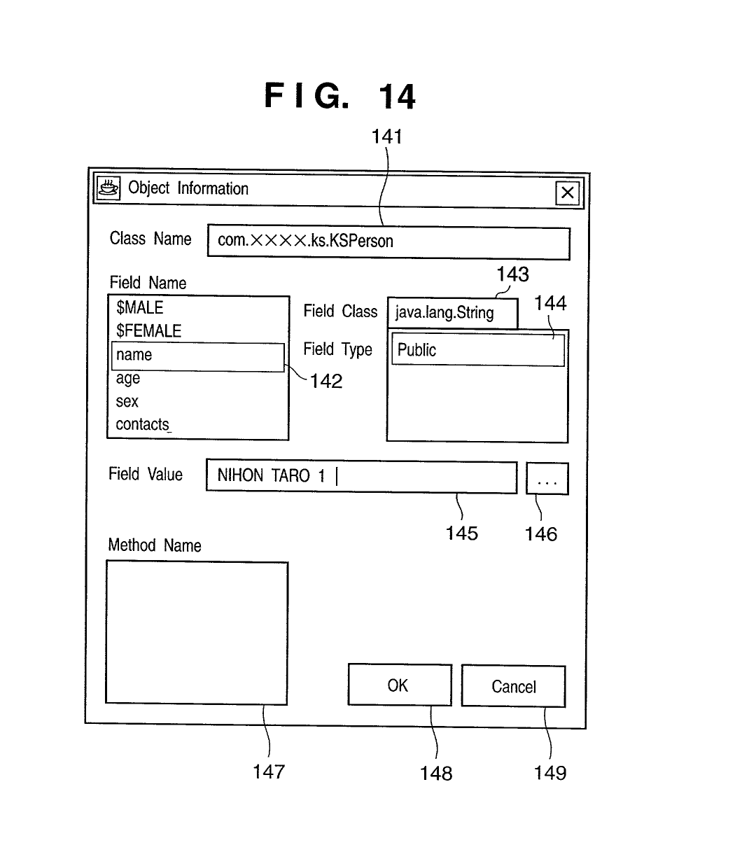

Then, in the event handling processing in step S805, an example of an object editing screen during editing of an existing object which will be displayed by the object selection/editing processing corresponding to the instruction for editing of the object will be explained using FIG. 14.

FIG. 14 illustrates an example of an object editing screen of First Embodiment when an existing object is edited.

The same figure shows that the value of field name “name” in reference numeral 142 at the time of new creation shown in FIG. 11 has been changed by the user's operation from “Japan Taro” to “Japan Taro 1” as indicated by reference numeral 145.

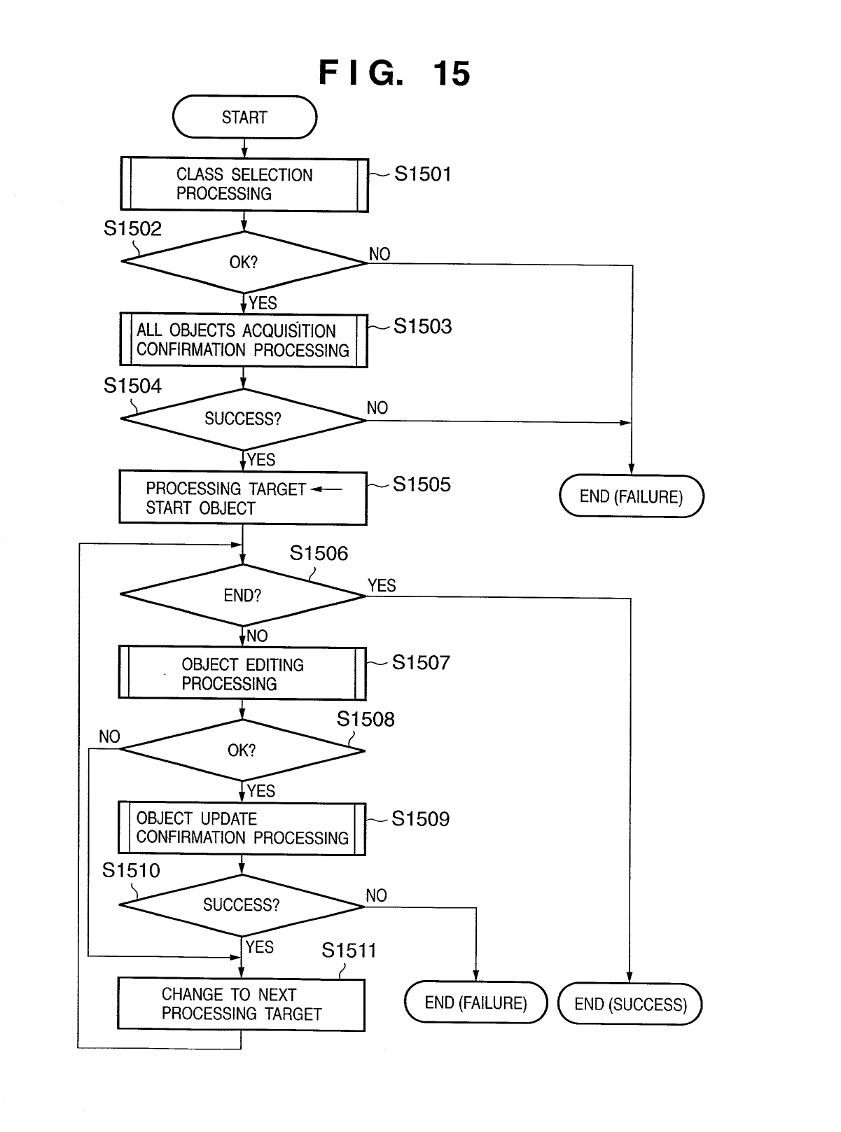

Then, in the event handling processing in step S805, details of the object selection/editing processing corresponding to an instruction for editing of an object will be explained using FIG. 15.

FIG. 15 is a flow chart showing details of object selection/editing processing of First Embodiment.

When the object selection/editing processing is started, class selection processing is executed in step S1501, the class selection screen explained in FIG. 13 is displayed and the selection operation by the user is accepted.

As a result of class selection processing, it is determined in step S1502 whether the editing of an object corresponding to the class has been instructed or not. If the editing of an object has not been instructed (step S1502: NO), the process regards this as a “failure” and terminates the processing. On the other hand, if the editing of an object has been instructed (step S1502: YES), the process moves on to step S1503.

Then, in step S1503, all objects acquisition confirmation processing is executed and all objects corresponding to the selected class are acquired.

As a result of all objects acquisition confirmation processing, it is determined in next step S1504 whether the acquisition of all objects has been successful or not. If the acquisition of all objects has not been successful (step S1504: NO), the process regards this as a “failure” and terminates the processing. On the other hand, if the acquisition of all objects has been successful (step S1504: YES), the process moves on to step S1505.

Then, in step S1505, the processing target is initialized to the start of all the acquired objects and in the following steps, processing is repeated on the respective objects.

In next step S1506, it is determined whether the processing for all objects to be processed has been terminated or not. If the processing for all objects to be processed has been terminated (step S1506: YES), the process regards this as a “success” and terminates the processing. On the other hand, if the processing for all objects to be processed has not been terminated (step S1506: NO), the process moves on to step S1507.

In step S1507, object editing processing is executed and the object editing screen explained in FIG. 14 is displayed and the user's operation is accepted.

As a result of the object editing processing, it is determined in next step S1508 whether the confirmation of the object editing content has been instructed or not. If the confirmation of the object editing content has not been instructed (step S1508: NO), the process moves on to step S1511. On the other hand, if the confirmation of the object editing content has been instructed (step S1508: YES), the process moves-on to step S1509.

In step S1509, object update confirmation processing is executed, data in the database is updated with the confirmed editing content and the result is confirmed.

As a result of the object update confirmation processing, it is determined in next step S1510 whether updating of the data has been successful or not. If updating of the data has not been successful (step S1510: NO), the process regards this as a “failure” and terminates the processing. On the other hand, if updating of the data has been successful (step S1510: YES), the process moves on to step S1511.

In step S1511, the processing target is changed to the next object and the process goes back to step S1506 and repeats the processing.

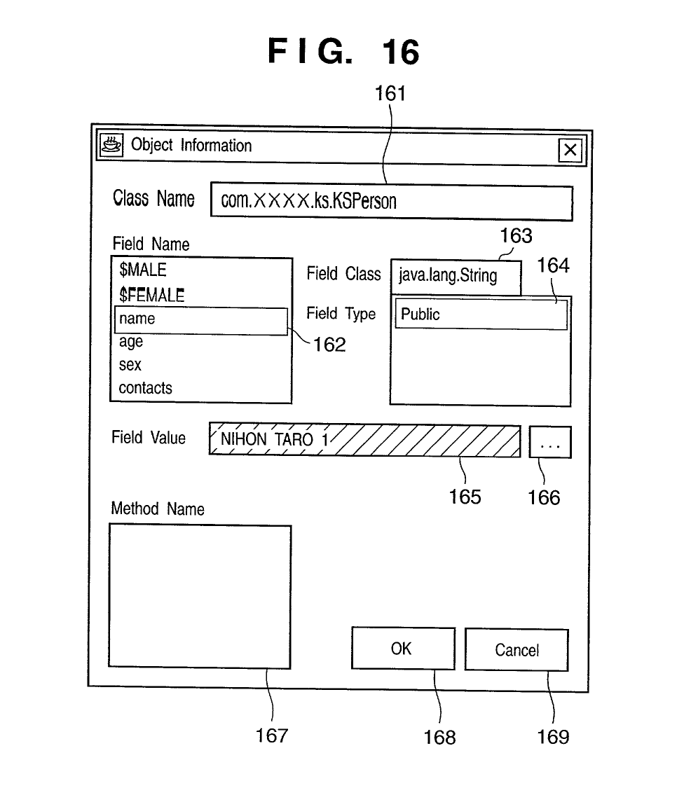

Then, in the event handling processing in step S805, an example of the object reference screen displayed by the object selection/deletion processing corresponding to an instruction for a deletion of an object when an existing object is referenced will be explained using FIG. 16.

FIG. 16 illustrates an example of an object reference screen of First Embodiment when an existing object is referenced.

As shown in the same figure, this object reference screen differs from the screen in FIG. 11 when a new object is created and the screen in FIG. 14 during editing in that entries to the area to enter a value to be stored in the field 165 are disabled.

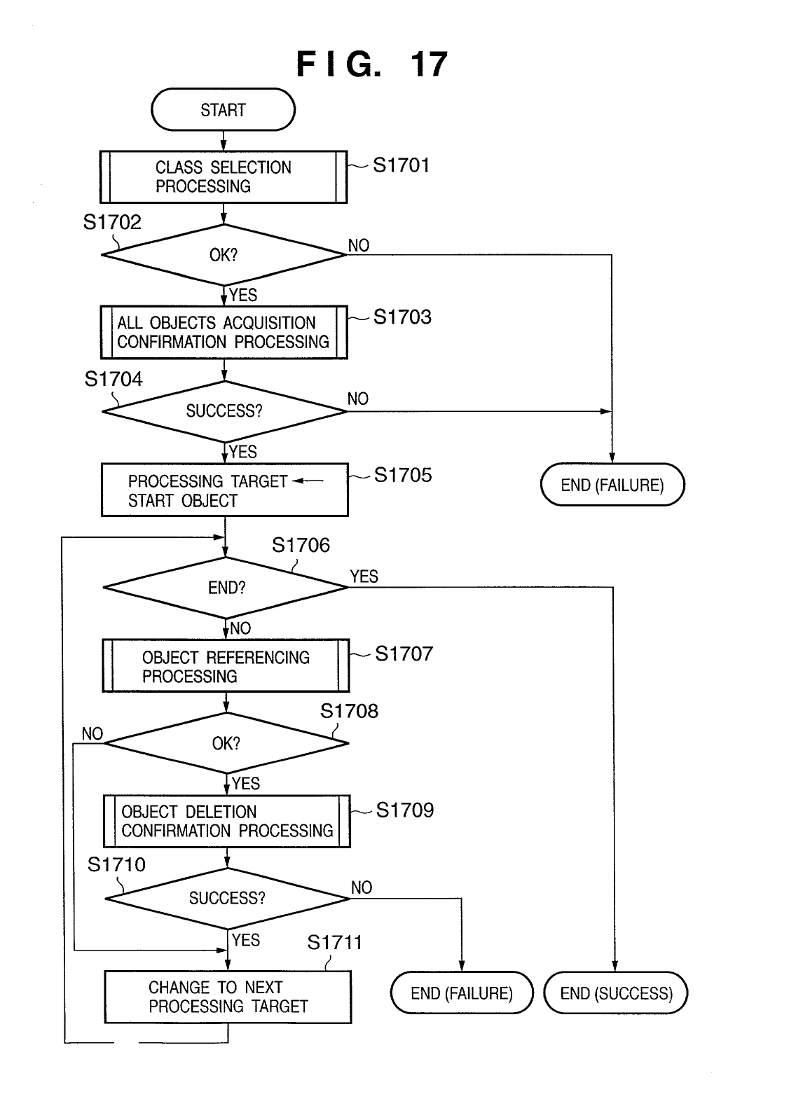

Then, in the event handling processing in step S805, details of object selection/deletion processing corresponding to an instruction for deletion of an object will be explained using FIG. 17.

FIG. 17 is a flow chart showing details of object selection/deletion processing of First Embodiment.

When the object selection/deletion processing is started, class selection processing in step S1701 is executed, the class selection screen explained in FIG. 13 is displayed and the user's operation is accepted.

As a result of the class selection processing, it is determined in next step S1702 whether deletion of an object corresponding to the class has been instructed or not. If deletion of an object corresponding to the class has not been instructed (step S1702: NO), the process regards this as a “failure” and terminates the processing. On the other hand, if deletion of an object corresponding to the class has been instructed (step S1702: YES), the process moves on to step S1703.

Then, in step S1703, all objects acquisition confirmation processing is executed to acquire all the objects corresponding to the selected class.

As a result of the all objects acquisition confirmation processing, it is determined in next step S1704 whether acquisition of all objects has been successful or not. If acquisition of all objects has not been successful (step S1704: NO), the process regards this as a “failure” and terminates the processing. Otherwise, if acquisition of all objects has been successful (step S1704: YES), the process moves on to step S1705.

Then, in step S1705, the processing target is initialized to the start of all the acquired objects and processing on the respective objects is repeated from the next step onward.

In step S1706, it is determined whether processing on all the objects to be processed has been terminated or not. If processing on all the objects to be processed has been terminated (step S1706: YES), the process regards this as a “success” and terminates the processing. On the other hand, if processing on all the objects to be processed has not been terminated (step S1706: NO), the process moves on to step S1707.

Instep S1707, object reference processing is executed, the object reference screen explained in FIG. 16 is displayed and the user's operation is accepted.

As a result of the object reference processing, in next step S1708, it is determined whether deletion of an object has been instructed or not. If deletion of an object has not been instructed (step S1708: NO), the process moves on to step S1711. On the other hand, if deletion of an object has been instructed (step S1708: YES), the process moves on to step S1709.

In step S1709, object deletion confirmation processing is executed, data in the database is deleted and the result is confirmed.

As a result of the object deletion confirmation processing, it is determined in next step S1710 whether the deletion of data has been successful or not. If the deletion of data has not been successful (step S1710: NO), the process regards this as a “failure” and terminates the processing. On the other hand, if the deletion of data has been successful (step S1710: YES), the process moves on to step S1711.

In step S1711, the processing target is changed to the next object, the process goes back to step S1706 and repeats the processing.

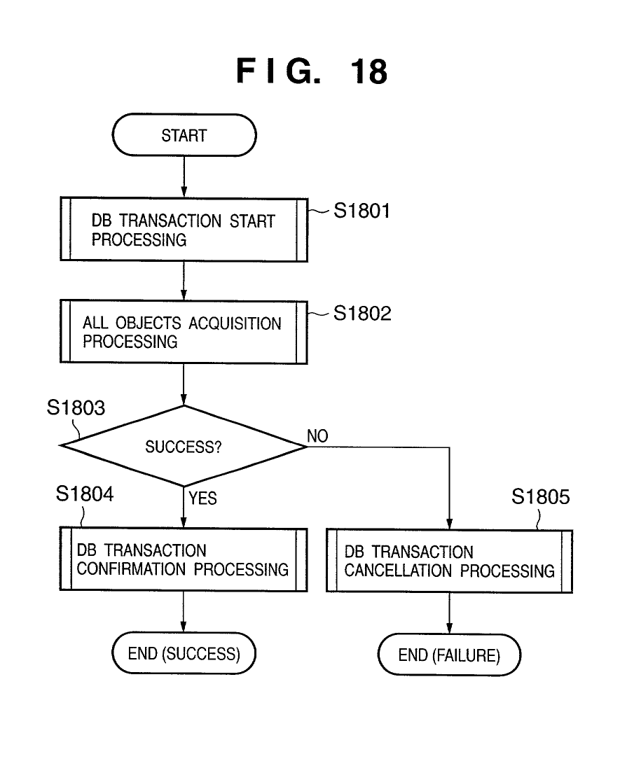

Then, details of all objects acquisition confirmation processing in step S1503 and step S1703 will be explained using FIG. 18.

FIG. 18 is a flow chart showing details of the all objects acquisition confirmation processing in step S1503 and step S1703 of First Embodiment.

When the all objects acquisition confirmation processing is started, DB transaction start processing is executed in step S1801 and the start of a transaction is declared. In next step S1802, the all objects acquisition processing is executed to acquire all objects corresponding to a specified class.

As a result of the all objects acquisition processing, it is determined in next step S1803 whether acquisition of all objects has been successful or not. If acquisition of all objects has been successful (step S1803: YES), the process moves on to step S1804. On the other hand, if acquisition of all objects has not been successful (step S1803: NO), the process moves on to step S1805.

In step S1804, DB transaction confirmation processing is executed, processing for the database so far is confirmed and the process regards this as a “success” and terminates the processing.

In step S1805, DB transaction cancellation processing is executed, processing for the database so far is cancelled and the process regards this as a “failure” and terminates the processing.

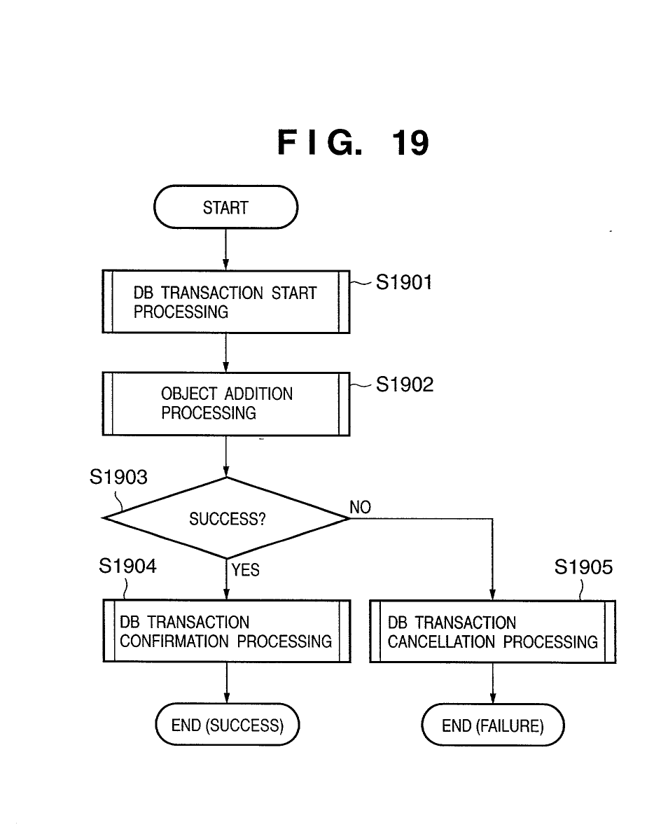

Then, details of the object addition confirmation processing in step S1007 will be explained using FIG. 19.

FIG. 19 is a flow chart showing details of the object addition confirmation processing in step S1007 of First Embodiment.

When the object addition confirmation processing is started, DB transaction start processing is executed in step S1901 and the start of a transaction is declared. Then, in step S1902, object addition processing is executed and a specified object is added to the database.

As a result of the object addition processing, it is determined in next step S1903 whether the addition of an object has been successful or not. If the addition of an object has been successful (step S1903: YES), the process moves on to step S1904. On the other hand, if the addition of an object has not been successful (step S1903: NO), the process moves on to step S1905.

In step S1904, DB transaction confirmation processing is executed, the processing for the database so far is confirmed and regarded as a “success” and terminated.

In step S1905, DB transaction cancellation processing is executed, the processing for the database so far is canceled and regarded as a “failure” and terminated.

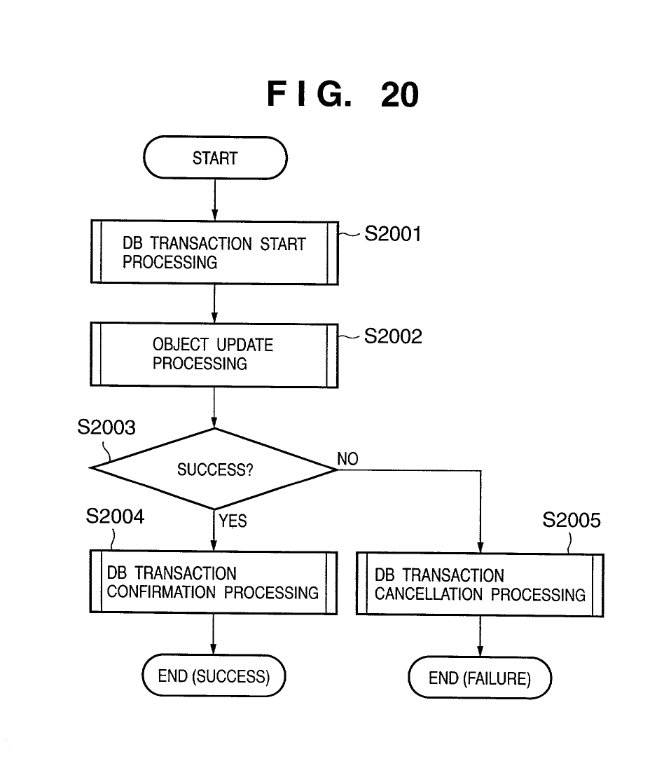

Then, details of object update confirmation processing in step S1509 will be explained using FIG. 20.

FIG. 20 is a flow chart showing details of the object update confirmation processing in step S1509 of First Embodiment.

When the object update confirmation processing is started, DB transaction start processing is executed in step S2001 and the start of a transaction is declared. In next step S2002, object update processing is executed and the database is updated with a specified object.

As a result of the object update processing, it is determined in next step S2003 whether the updating of the object has been successful or not. If the updating of the object has been successful (step S2003: YES), the process moves on to step S2004. On the other hand, if the updating of the object has not been successful (step S2003: NO), the process moves on to step S2005.

In step S2004, DB transaction confirmation processing is executed, the processing for the database so far is confirmed, regarded as a “success” and terminated.

In step S2005, DB transaction cancellation processing is executed, the processing for the database so far is canceled, regarded as a “failure” and terminated.

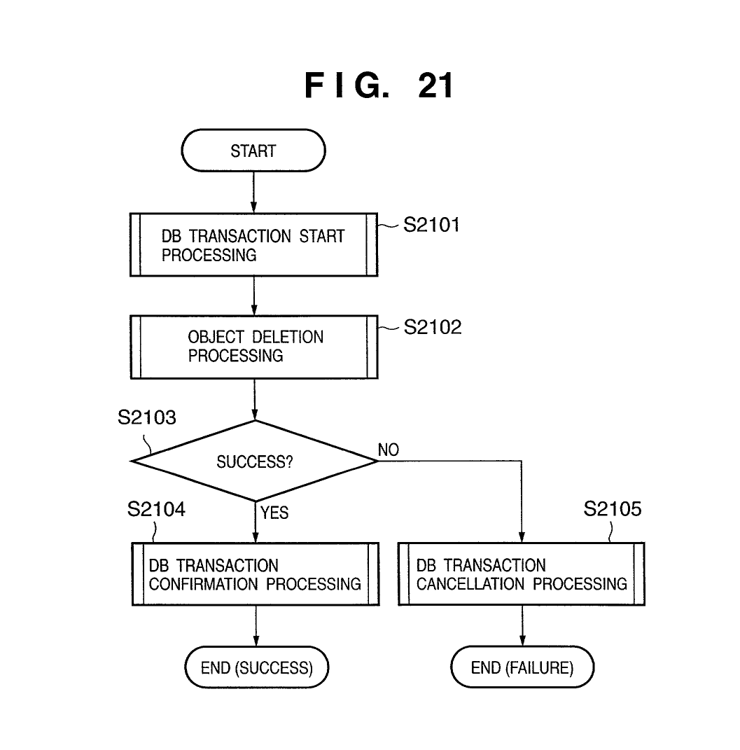

Then, details of object deletion confirmation processing in step S1709 will be explained using FIG. 21.

FIG. 21 is a flow chart showing details of the object deletion confirmation processing in step S1709 of First Embodiment.

When the object deletion confirmation processing is started, DB transaction start processing is executed in step S2101 and the start of a transaction is declared. Then, in step S2102, object deletion processing is executed and a specified object is deleted from the database.

As a result of the object deletion processing, it is determined in next step S2103 whether the deletion of the object has been successful or not. If the deletion of the object has been successful (step S2103: YES), the process moves on to step S2104. On the other hand, if the deletion of the object has not been successful (step S2103: NO), the process moves on to step S2105.

In step S2104, DB transaction confirmation processing is executed, the processing for the database so far is confirmed, regarded as a “success” and terminated.

In step S2105, DB transaction cancellation processing is executed, the processing for the database so far is canceled, regarded as a “failure” and terminated.

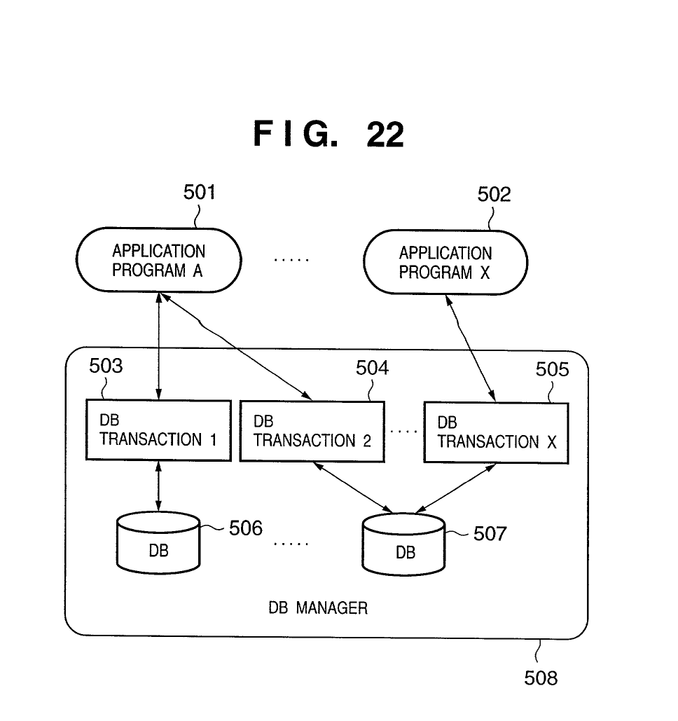

FIG. 22 illustrates a functional configuration of the information processor of First Embodiment.

DB manager 508 generates or discards DB transactions 503, 504 and 505 handling a series of transactions with databases (DB) 506 and 507 corresponding to requests from one or more application program A501 and application program X502.

In the same figure, in response to two requests from application program A501, two DB transactions 503 and 504 are generated and associated with databases 506 and 507, respectively. Furthermore, the DB transaction 505 corresponding to the request from the application program X502 is associated with the identical database 507 as for the DB transaction 504.

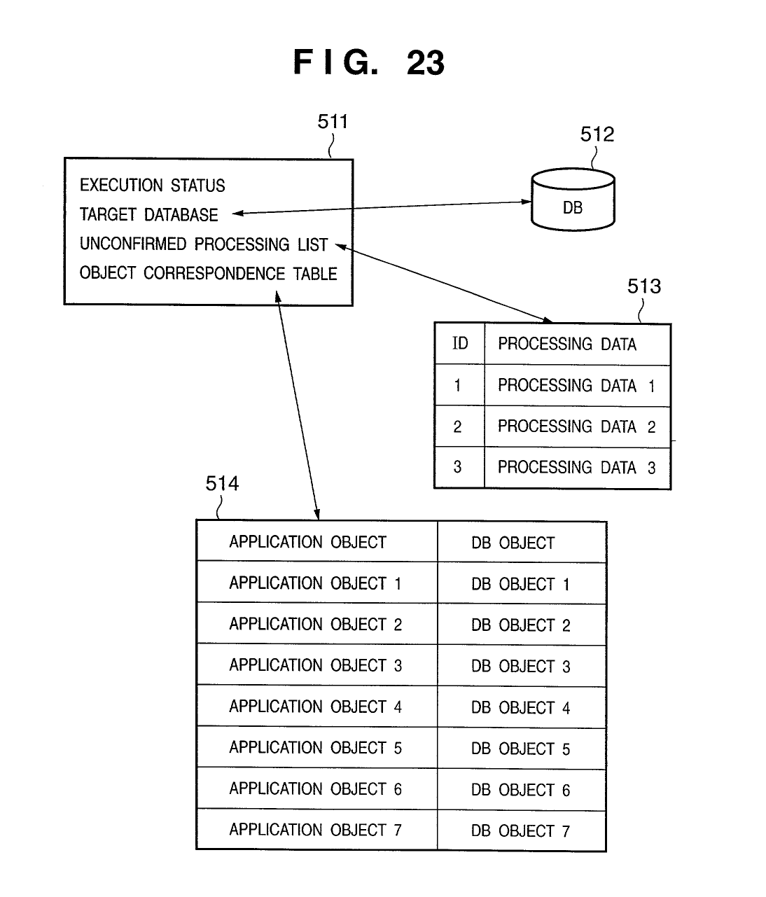

Then, internal data of the DB transaction will be explained using FIG. 23.

FIG. 23 illustrates internal data of a DB transaction of First Embodiment.

As indicated by reference numeral 511, the DB transaction constitutes internal data of an execution status indicating whether a transaction is being executed or not, transaction target database information 512, a list of unconfirmed processing 513 carried out in execution of a transaction and an object correspondence table 514 that stores the correspondence between application objects which have become processing targets after transactions are generated and DB objects.

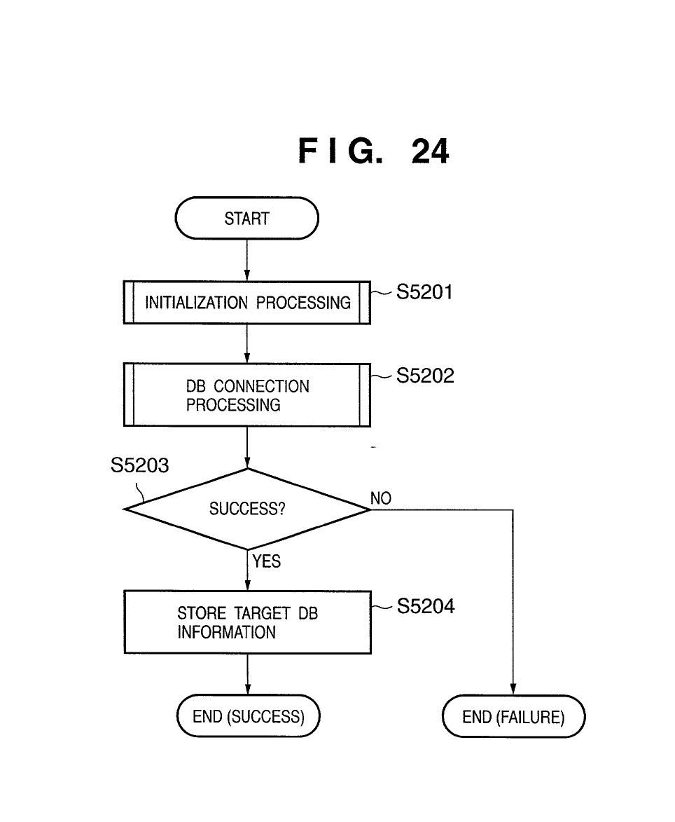

Then, details of the DB transaction generation processing in step S603 will be explained using FIG. 24.

FIG. 24 is a flow chart showing details of the DB transaction generation processing in step S603 of First Embodiment.

When DB transaction generation processing is started, initialization processing is executed in step S5201 to initialize the internal data of the DB transaction explained in FIG. 23.

In next step S5202, DB connection processing is executed to connect to the database under a specified condition.

As a result of the DB connection processing, it is determined in next step S5203 whether the connection of the database has been successful or not. If the connection of the database has not been successful (step S5203: NO), the process regards this as a “failure” and terminates the processing. On the other hand, if the connection of the database has been successful (step S5203: YES), the process moves on to step S5204.

In step S5204, connection-related information is stored in the internal data of the DB transaction and the process regards this as a “success” and terminates the processing.

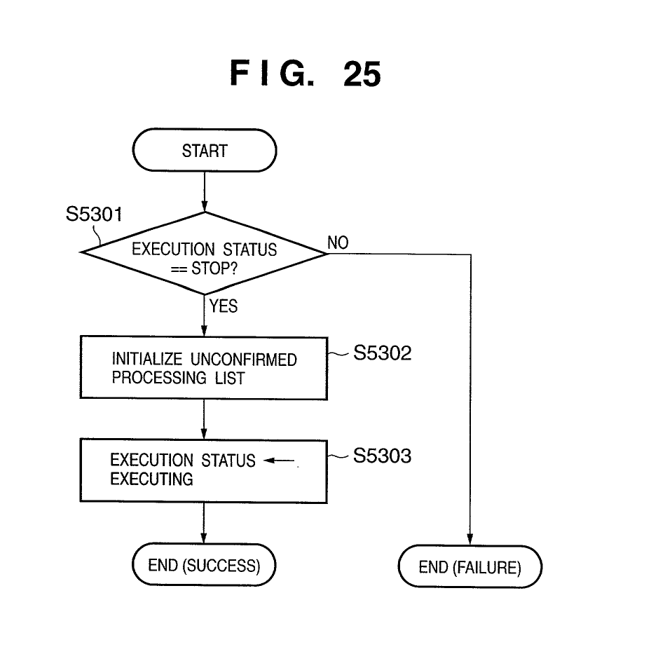

Then, details of DB transaction start processing in step S1801, step S1901, step S2001 and step S2101 in the all objects acquisition confirmation processing in FIG. 18, object addition confirmation processing in FIG. 19, object update confirmation processing in FIG. 20 and object deletion confirmation processing in FIG. 21, respectively will be explained using FIG. 25.

FIG. 25 is a flow chart showing details of the DB transaction start processing in step S1801, step S1901, step S2001 and step S2101 of First Embodiment.

When the DB transaction start processing is started, the execution status of the internal data of the DB transaction is referenced in step S5301 and it is determined whether the execution status is “stop” or not. If the execution status is not “stop” (step S5301: NO), the process regards this as a “failure” and terminates the processing. On the other hand, if the execution status is “stop” (step S5301: YES), the process moves on to step S5302.

Then, in step S5302, the unconfirmed processing list is initialized. In next step S5303, the execution status is changed to “executing” and the process regards this as a “success” and terminates the processing.

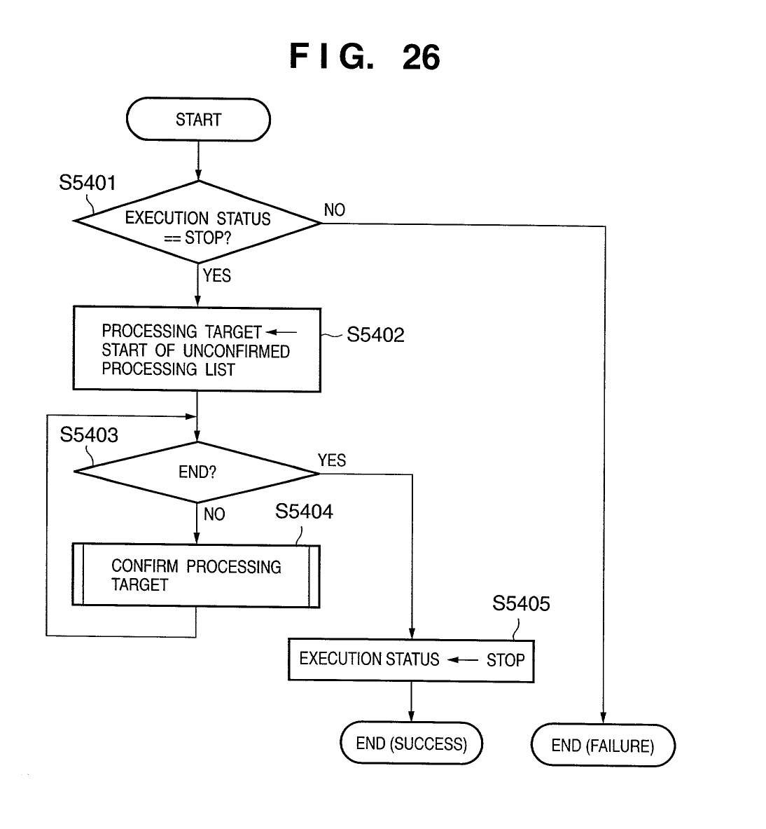

Then, details of DB transaction confirmation processing in step S1804, step S1904, step S2004 and step S2104 in the all objects acquisition confirmation processing in FIG. 18, object addition confirmation processing in FIG. 19, object update confirmation processing in FIG. 20 and object deletion confirmation processing in FIG. 21, respectively will be explained using FIG. 26.

FIG. 26 is a flow chart showing details of the DB transaction confirmation processing in step S1804, step S1904, step S2004 and step S2104 of First Embodiment.

When the DB transaction confirmation processing is started, the execution status of the internal data of the DB transaction is referenced in step S5401 and it is determined whether the execution status is “executing” or not. If the execution status is not “executing” (step S5401: NO), the process regards this as a “failure” and terminates the processing. On the other hand, if the execution status is “executing” (step S5401: YES), the process moves on to step S5402.

Then, in step S5402, the processing target is set at the start of the unconfirmed processing list and then processing for all processing targets is repeated from the next step onward.

In next step S5403, it is determined whether the processing for all processing targets has been terminated or not. If the processing for all processing targets has not been terminated (step S5403: NO), the process moves on to step S5404, executes processing target confirmation processing, confirms the processing content carried out in the database to be processed and goes back to step S5403. On the other hand, if the processing for all processing targets has been terminated (step S5403: YES), the process moves on to step S5405, changes the execution status to “stop”, regards this as a “success” and terminates the processing.

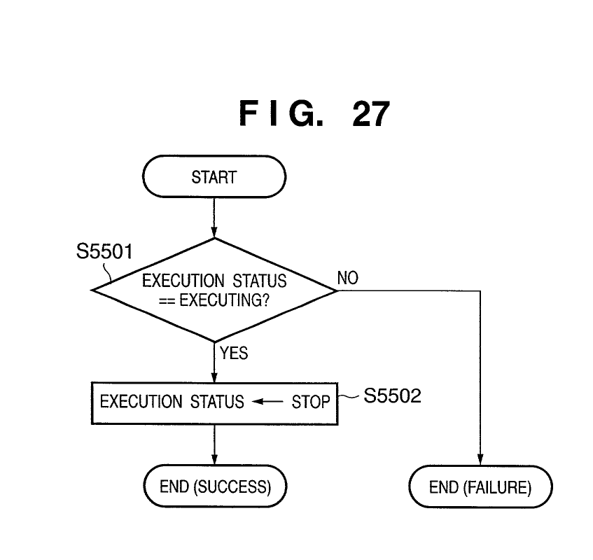

Then, details of DB transaction cancellation processing in step S1805, step S1905, step S2005 and step S2105 in the all objects acquisition confirmation processing in FIG. 18, object addition confirmation processing in FIG. 19, object update confirmation processing in FIG. 20 and object deletion confirmation processing in FIG. 21, respectively will be explained using FIG. 27.

FIG. 27 is a flow chart showing details of the DB transaction cancellation processing in step S1805, step S1905, step S2005 and step S2105 of First Embodiment.

When the DB transaction cancellation processing is started, the execution status of the internal data of the DB transaction is referenced in step S5501 and it is determined whether the execution status is “executing” or not. If the execution status is not “executing” (step S5501: NO), the process regards this as a “failure” and terminates the processing. On the other hand, if the execution status is “executing” (step S5501: YES), the process moves on to step S5502.

Then, in step S5502, the execution status is changed to “stop” and the process regards this as a “success” and terminates the processing.

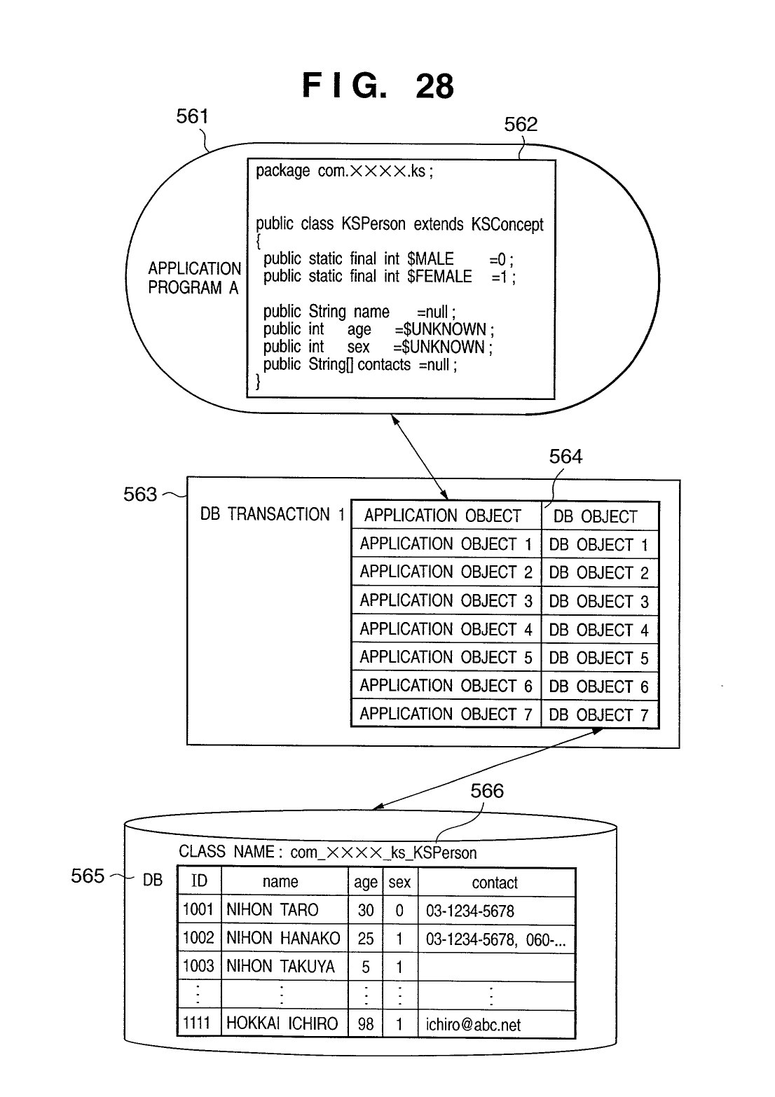

Then, the relationship between objects used in the information processor of First Embodiment will be explained using FIG. 28.

FIG. 28 illustrates a relationship between objects used by the information processor of First Embodiment.

In the same figure, in order to make application object 562 generated or acquired by application program A561 permanent data, database 565 is used.

In this case, instead of directly accessing the database 565, the application program A561 specifies a condition of connection to the database 565 and then accesses the database 565 via the DB transaction 563 generated as explained in the functional configuration in FIG. 22.

More specifically, the application object 562 generated by the application program A561 is internally converted to a DB object 566 by a service provided by the DB transaction 563, and then stored in the database 565. At the same time, the object correspondence table 564 that stores the correspondence between the application object 562 and DB object 566 is updated.

On the contrary, it is possible, through the service provided by the DB transaction 563, to handle the DB object 566 stored in the database 565 after converting the DB object 566 to the application object 562 internally. At the same time, the object correspondence table 564 that stores the correspondence between the application object 562 and DB object 566 is updated.

The above processing allows the application program A561 to acquire, add, update or delete data stored in the database 565 as the application object 562 without being aware of the structure of the object in the database 565.

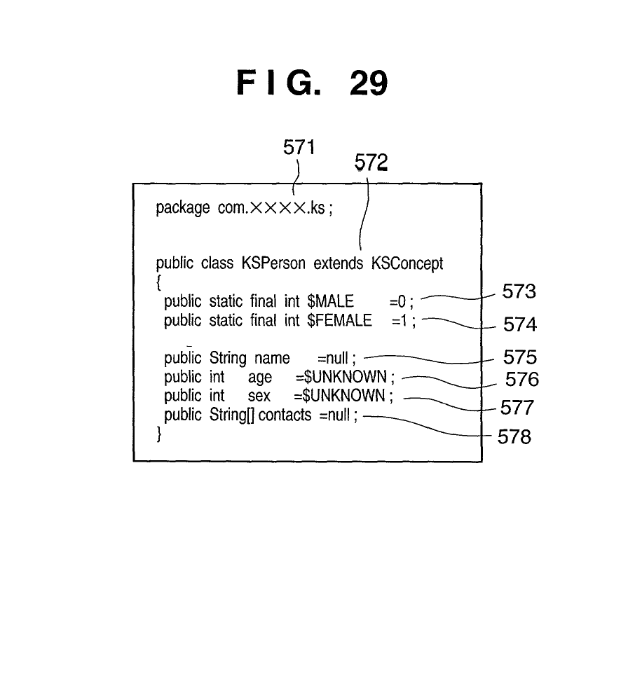

Then, a programming code of an application object used by the information processor according to First Embodiment will be explained using FIG. 29.

FIG. 29 illustrates a programming code of an application object of First Embodiment.

In the same figure, reference numeral 571 denotes a package name indicating a group of classes generated by the programming code. Reference numeral 572 denotes a class name in the package. The class name of a class generated by the programming code is actually “com.xxxx.ks.KSPerson” combined with the package name.

Reference numerals 573 to 578 denote definitions and initial values of fields of the class. For example, according to the definition in the figure, there are six fields of $MALE, $FEMALE, name, age, sex and contacts which can be referenced from outside the class. Of these fields, $MALE and $FEMALE are defined not to be writable.

The application object of the information processor of First Embodiment is obtained by instantiating a class generated by the programming code, and on the contrary, it is possible to acquire the definition information using the service of the application object.

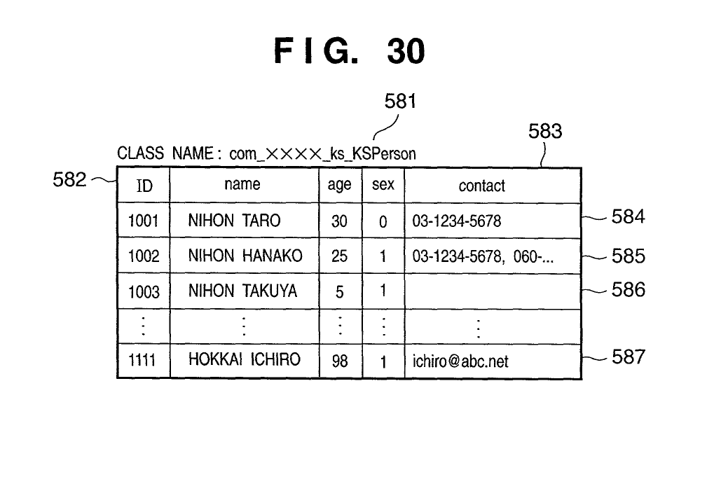

Then, a list of database objects used by the information processor of First Embodiment will be explained using FIG. 30.

FIG. 30 illustrates a list of database objects of First Embodiment.

In the same figure, reference numeral 581 denotes a class name in the database; 582, an identification ID specific to each database object; 583, a field name corresponding to each field of the application object. In the same figure, there are four fields of name, age, sex and contacts.

Reference numerals 584 to 587 denote actual values of the respective data objects.

Here, the class names in the database do not always match the class names of the application objects as shown in the same figure.

Furthermore, as shown in the same figure, not all field values of the application object are stored in the database object. For example, of the fields of the application object, even if the values of write-protected fields are stored in the database object, those values cannot be written to the application object, or the values are automatically initialized when a default instance of the application object is created, and therefore it is possible to determine that those values need not be stored in the database object.

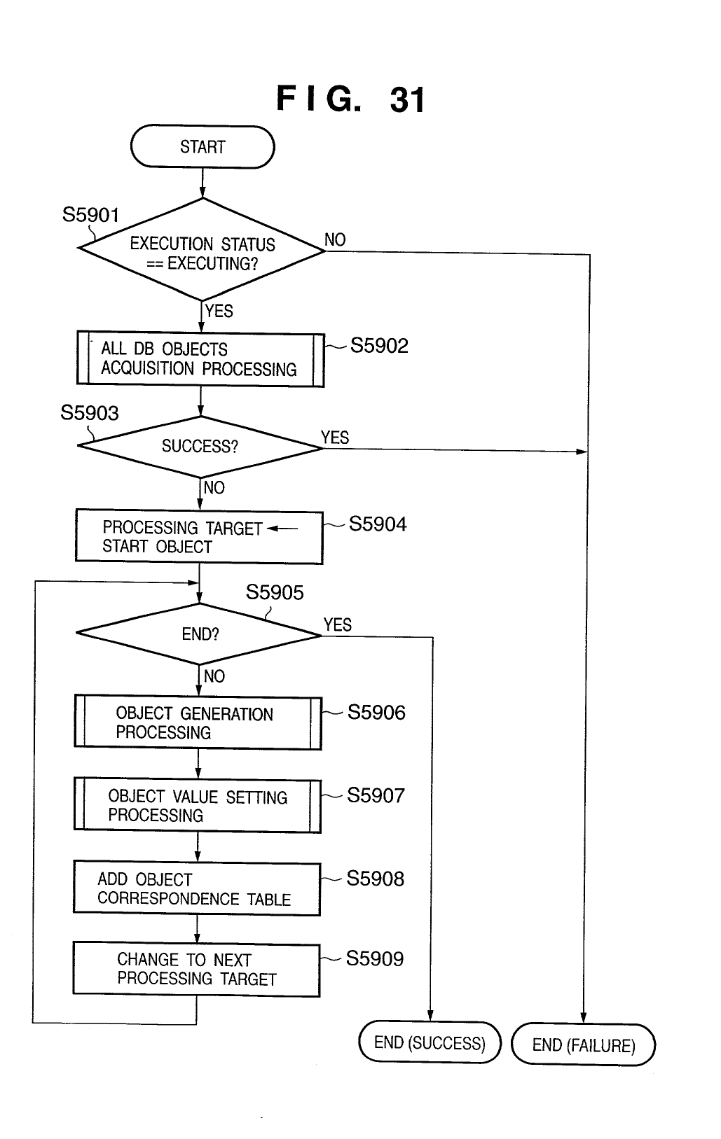

Then, details of the all objects acquisition processing in step S1802 will be explained using FIG. 31.

FIG. 31 is a flow chart showing details of the all objects acquisition processing in step S1802 of First Embodiment.

When the all objects acquisition processing is started, the execution status of the internal data of the DB transaction is referenced in step S5901 to determine whether the execution status is “executing” or not. If the execution status is not “executing” (step S5901: NO), the process regards this as a “failure” and terminates the processing. On the other hand, if the execution status is “executing” (step S5901: YES), the process moves on to step S5902.

Then, in step S5902, the all DB objects acquisition processing is executed and all objects in the database corresponding to the specified class are acquired.

As a result of the DB object acquisition processing, it is determined in next step S5903 whether the acquisition of all objects has been successful or not. If the acquisition of all objects has not been successful (step S5903: NO), the process regards this as a “failure” and terminates the processing. On the other hand, if the acquisition of all objects has been successful (step S5903: YES), the process moves on to step S5904.

In step S5904, after the processing target is set at the start of the object of the database whose processing target has been acquired, processing for all objects to be processed is repeated in the following steps.

In next step S5905, it is determined whether processing on all objects to be processed has been terminated or not. If the processing for all objects to be processed has been terminated (step S5905: YES), the process regards this as a “success” and terminates the processing. On the other hand, if the processing on all objects to be processed has not been terminated (step S5905: NO), the process moves on to step S5906.

In step S5906, object generation processing is executed to generate a default instance of the specified class. Then, in step S5907, object value setting processing is executed, the value of the database object to be processed is referenced and values are set in the fields of the application object generated above. Furthermore, in next step S5908, the application object generated above combined with the acquired database object are added to the object correspondence table. Then, in step S5909, the processing target is changed to the next object, the process goes back to S5905 again and repeats the processing.

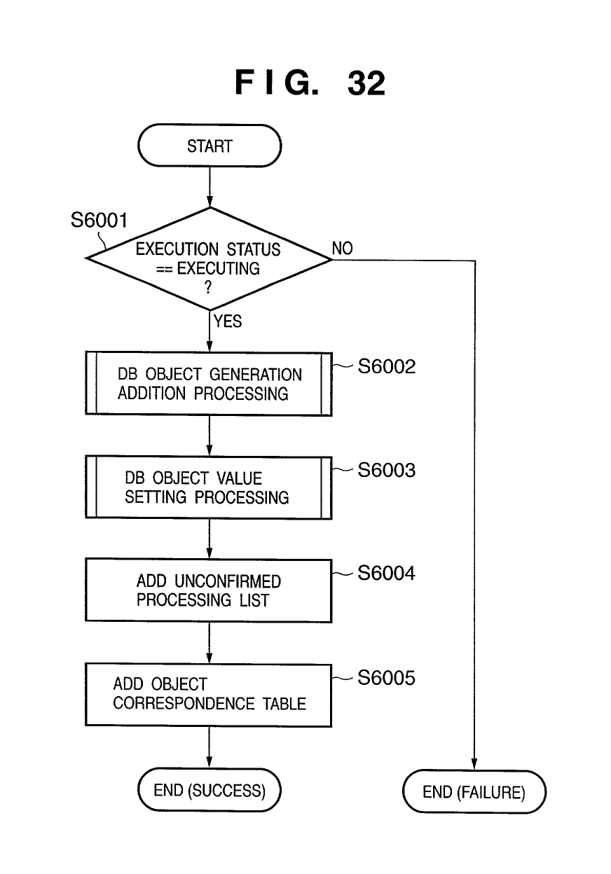

Then, details of the object addition processing in step S1902 will be explained using FIG. 32.

FIG. 32 is a flow chart showing details of the object addition processing in step S1902 of First Embodiment.

When the object addition processing is started, the execution status of the internal data of the DB transaction is referenced in step S6001 to determine whether the execution status is “executing” or not. If the execution status is not “executing” (step S6001: NO), the process regards this as a “failure” and terminates the processing. On the other hand, if the execution status is “executing” (step S6001: YES), the process moves on to step S6002.

Then, in step S6002, DB object generation/addition processing is executed and a database object of the class of the database corresponding to the given application object class is generated and added.

In next step S6003, DB object value setting processing is executed, the value of the given application object is referenced to set a value in each field of the database object generated and added above.

Then, in step S6004, information corresponding to the processing above is added to the aforementioned unconfirmed processing list. In next step S6005, the given application object combined with the database object generated and added above are added to the aforementioned object correspondence table and the process regards this as a “success” and terminates the processing.

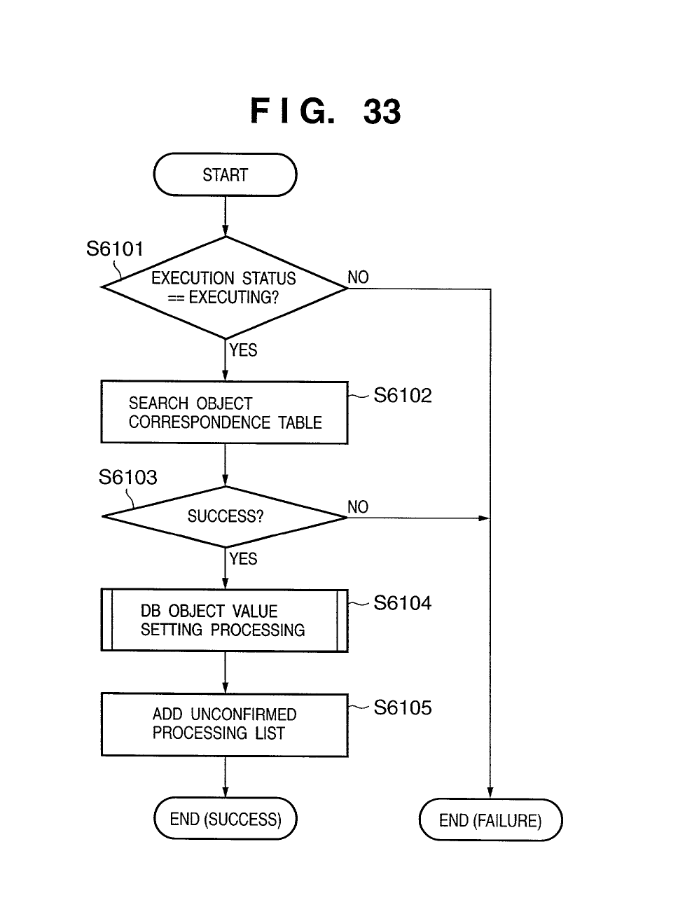

Then, details of the object update processing in step S2002 will be explained using FIG. 33.

FIG. 33 is a flow chart showing details of the object update processing in step S2002 of First Embodiment.

When the object update processing is started, the execution status of the internal data of the DB transaction is referenced in step S6101 to determine whether the execution status is “executing” or not. If the execution status is not “executing” (step S6101: NO), the process regards this as a “failure” and terminates the processing. On the other hand, if the execution status is “executing” (step S6101: YES), the process moves on to step S6102.

Then, in step S6102, the object correspondence table is referenced to search for the database object corresponding to the given application object.

As a result of the search, in next step S6103, it is determined whether the search has been “successful” or not. If the search has not been “successful” (step S6103: NO), the process regards this as a “failure” and terminates the processing. On the other hand, if the search has been “successful” (step S6103: YES), the process moves onto step S6104.

In step S6104, DB object value setting processing is executed, the value of the given application object is referenced and a value is set in each field of the above searched database object.

Then, in step S6105, information corresponding to the processing above is added to the aforementioned unconfirmed processing list and the process regards this as a “success” and terminates the processing.

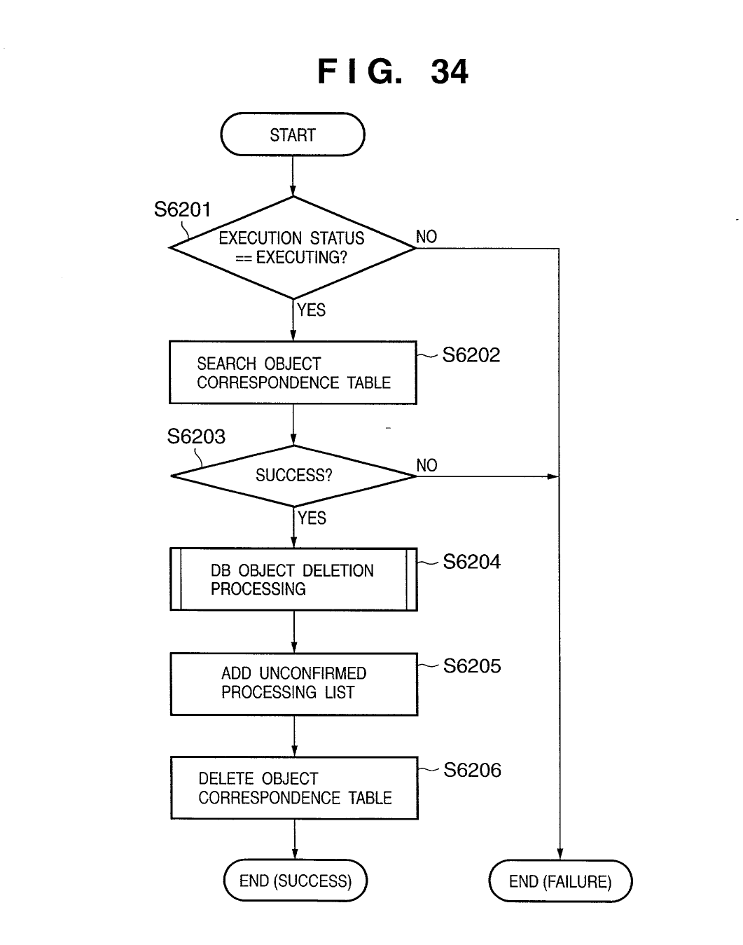

Then, details of the object deletion processing in step S2102 will be explained using FIG. 34.

FIG. 34 is a flow chart showing details of the object deletion processing in step S2102 of First Embodiment.

When the object deletion processing is started, the execution status of the internal data of the DB transaction is referenced in step S6201 to determine whether the execution status is “executing” or not. If the execution status is not “executing” (step S6201: NO), the process regards this as a “failure” and terminates the processing. On the other hand, if the execution status is “executing” (step S6201: YES), the process moves on to step S6202.

Then, in step S6202, the object correspondence table is referenced to search for the database object corresponding to the given application object.

As a result of the search, it is determined in next step S6203 whether the search has been “successful” or not. If the search has not been “successful” (step S6203: NO), the process regards this as a “failure” and terminates the processing. On the other hand, if the search has been “successful” (step S6203: YES), the process moves onto step S6204.

Then, in step S6204, DB object deletion processing is executed to delete the searched database object above.

Then, in step S6205, information corresponding to the processing above is added to the unconfirmed processing list. In next step S6206, the given application object combined with the deleted database object are deleted from the object correspondence table and the process regards this as a “success” and terminates the processing.

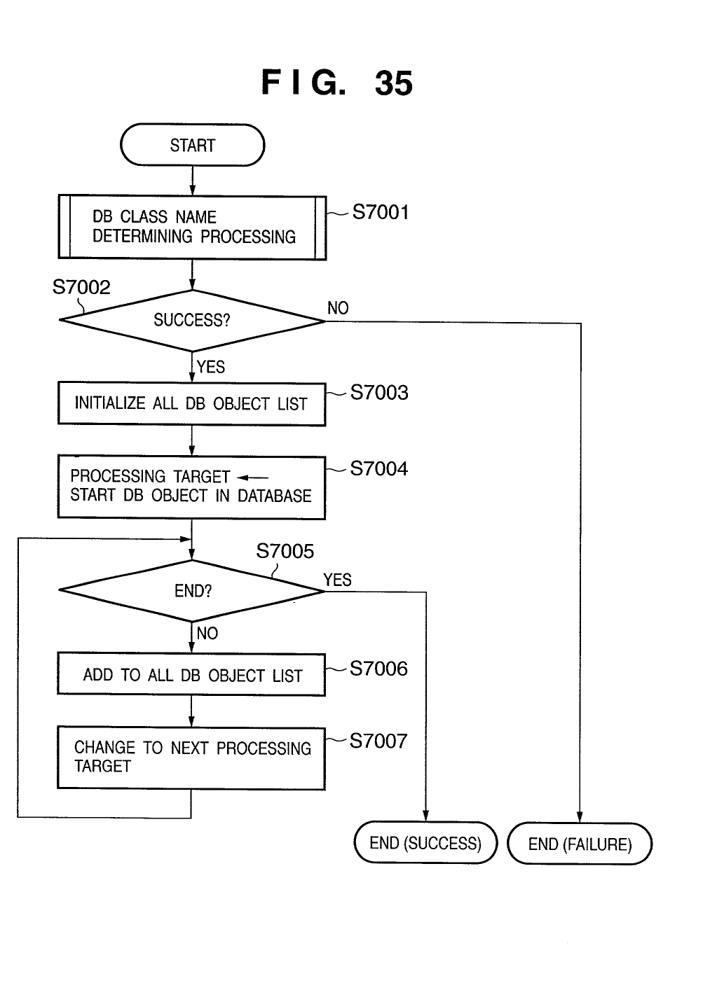

Then, details of the all DB objects acquisition processing in step S5902 will be explained using FIG. 35.

FIG. 35 is a flow chart showing details of the all DB objects acquisition processing in step S5902 of First Embodiment.

When the all DB objects acquisition processing is started, the DB class name determining processing is executed in step S7001 to determine a database class name in the database corresponding to the application class name of the given application class.

As in the case of the database used in First Embodiment, if “.” cannot be used for a class name, the result of substituting it by a character string such as “_” usable in the database is used as the database class name. For example, a database class name “com_xxxx_ks_KSPerson” is determined from an application class name “com.xxxx.ks.KSPerson”.

As a result of the DB class name determining processing, it is determined in next step S7002 whether the determination of the database class name has been “successful” or not. If the determination of the database class name has not been “successful” (step S7002: NO), the process regards this as a “failure” and terminates the processing. On the other hand, if the determination of the database class name has been successful (step S7002: YES), the process moves on to step S7003.

Then, in step S7003, the all database objects list to be output is initialized. Then, in step S7004, the processing target is set at the start of the database object group corresponding to the database class in the database and then processing for all database objects to be processed is repeated in the following steps.

In next step S7005, it is determined whether the processing for all database objects to be processed has been terminated or not. If the processing for all database objects to be processed has been terminated (step S7005: YES), the process regards this as a “success” and terminates the processing. On the other hand, if the processing for all database objects to be processed has not been terminated (step S7005: NO), the process moves on to step S7006.

Then, in step S7006, the database object to be processed is added to the list of all database objects. Then, in step S7007, the processing target is changed to the next database object and the process goes back to step S7005 and repeats the processing.

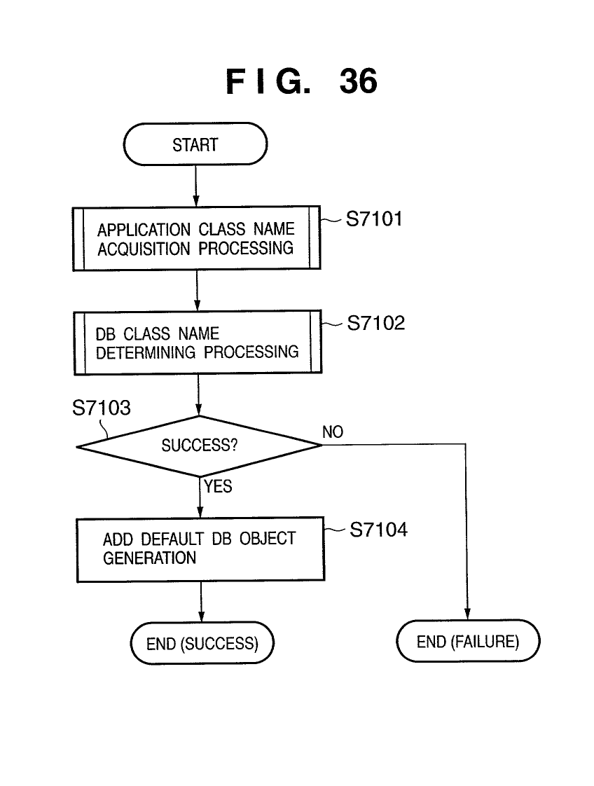

Then, details of the DB object generation/addition processing in step S6002 will be explained using FIG. 36.

FIG. 36 is a flow chart showing details of the DB object generation/addition processing in step S6002 of First Embodiment.

When the DB object generation/addition processing is started, application class name acquisition processing is executed in step S7101 to acquire the application class name of a given application object. Then, in step S7102, the DB class name determining processing is executed to determine the database class name in the database corresponding to the application class name.

As a result of the DB class name determining processing, it is determined in next step S7103 whether the determination of the database class name has been “successful” or not. If the determination of the database class name has not been “successful” (step S7103: NO), the process regards this as a “failure” and terminates the processing. On the other hand, if the determination of the database class name has been “successful” (step S7102: YES), the process moves on to step S7104.

In step S7104, a default database object corresponding to the database class is generated and added and the process regards this as a “success” and terminates the processing.

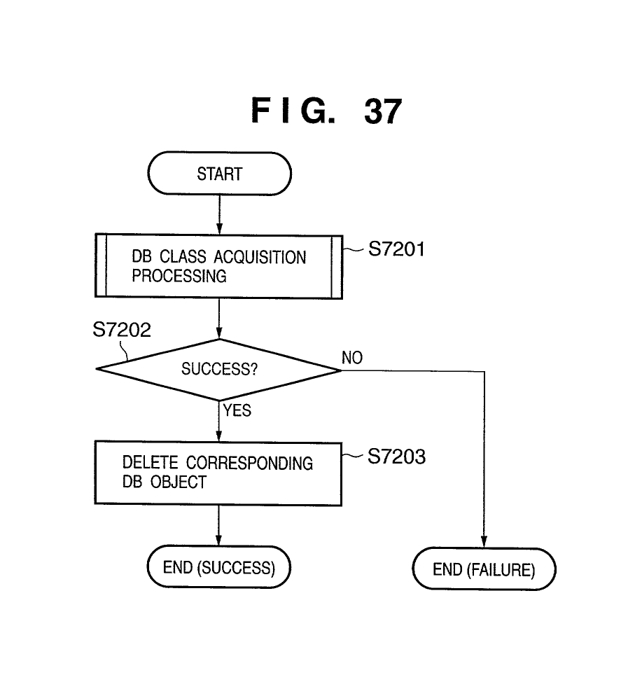

Then, details of the DB object deletion processing in step S6204 will be explained using FIG. 37.

FIG. 37 is a flow chart showing details of the DB object deletion processing in step S6204 of First Embodiment.

When the DB object deletion processing is started, DB class acquisition processing is executed in step S7201 to acquire the database class corresponding to the given database object.

As a result of the DB class acquisition processing, it is determined in next step S7202 whether the acquisition of the database class has been “successful” or not. If the acquisition of the database class has not been “successful” (step S7202: NO), the process regards this as a “failure” and terminates the processing. On the other hand, if the acquisition of the database class has been “successful” (step S7202: YES), the process moves on to step S7203.

In step S7203, the given database object is deleted using the service of the database class and the process regards this as a “success” and terminates the processing.

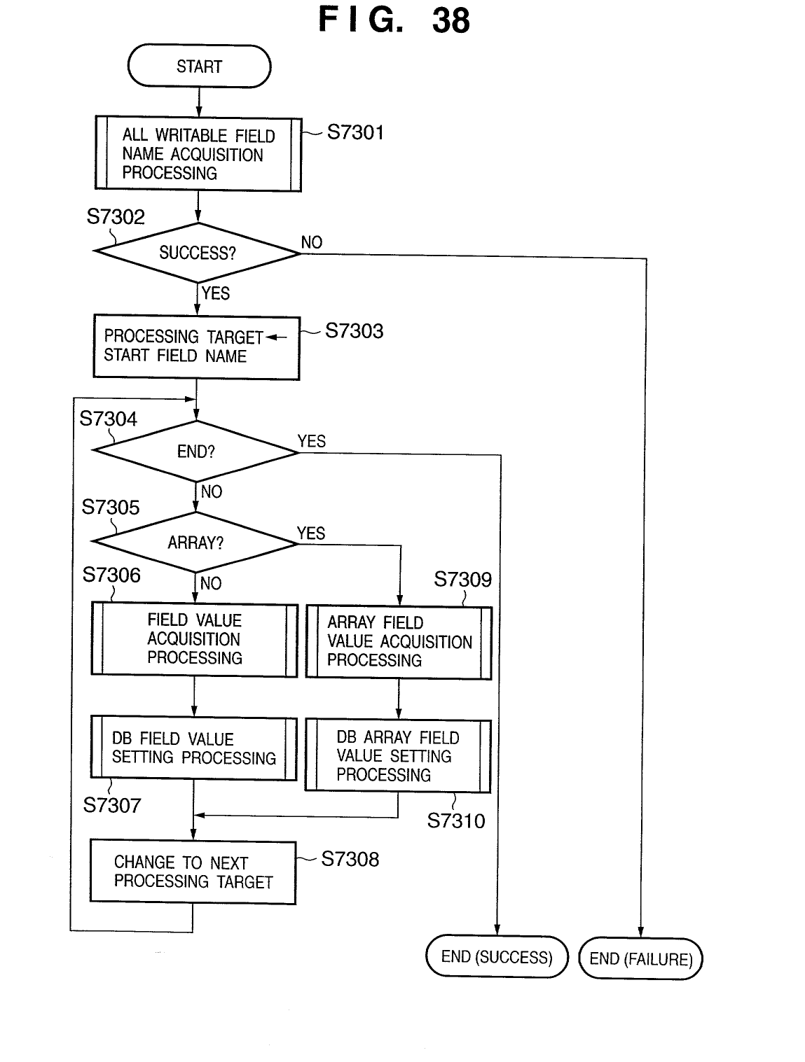

Then, details of the DB object value setting processing in step S5907 and step S6003 in the object addition processing in FIG. 31 and object update processing in FIG. 32 will be explained using FIG. 38.

FIG. 38 is a flow chart showing details of the DB object value setting processing in step S5907 and step S6003 of First Embodiment.

When the DB object value setting processing is started, all writable field name acquisition processing is executed in step S7301, the definition of each field of the given application object is referenced and the field names of all writable fields are acquired.

As a result of all writable field name acquisition processing, it is determined in next step S7302 whether the acquisition of the field names has been successful or not. If the acquisition of the field names has not been successful (step S7302: NO), the process regards this as a “failure” and terminates the processing. On the other hand, if the acquisition of the field names has been successful (step S7302: YES), the process moves on to step S7303.

Then, in step S7303, after the processing target is set at the start of the all writable field name list, processing for all fields to be processed is repeated in the following steps.

In next step S7304, it is determined whether processing for all fields to be processed has been terminated or not. If processing for all fields to be processed has been terminated (step S7304: YES), the process regards this as a “success” and terminates the processing. On the other hand, if processing for all fields to be processed has not been terminated (step S7304: NO), the process moves on to step S7305.

Then, instep S7305, it is determined whether the field to be processed is an array or not. If the field to be processed is not an array (step S7305: NO), the process moves on to step S7306.

In step S7306, field value acquisition processing is executed to acquire a value corresponding to the name of the field to be processed, of the given application object. In next step S7307, DB field value setting processing is executed to store the DB field value in the corresponding field of the database object. Then, in step S7308, the field to be processed is changed to the next field, the process goes back to step S7304 again and repeats the processing.

On the other hand, in step S7305, if the field to be processed is an array (step S7305: YES), the process moves on to step S7309.

In step S7309, array field value acquisition processing is executed to acquire the value corresponding to the name of the field to be processed, of the given application object. In next step S7310, DB array field value setting processing is executed and the DB array field value is stored in the corresponding field of the database object. Then, in step S7308, the field to be processed is changed to the next field, the process goes back to step S7304 again and repeats the processing.

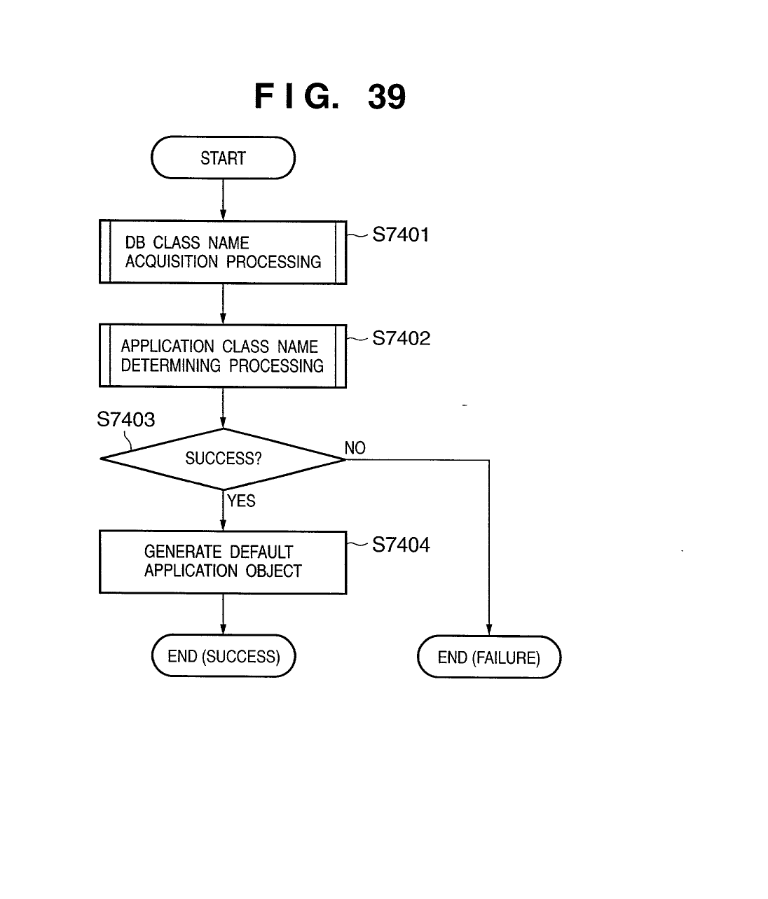

Then, details of the object generation processing in step S5906 will be explained using FIG. 39.

FIG. 39 is a flow chart showing details of the object generation processing in step S5906 of First Embodiment.

When the object generation processing is started, DB class name acquisition processing is executed in step S7401 to acquire the database class name of the given database object. Then, in step S7402, application class name determining processing is executed to determine the application class name corresponding to the database class name.

As a result of the application class name determining processing, it is determined in next step S7403 whether the determination of the application name has been successful or not. If the determination of the application name has not been successful (step S7403: NO), the process regards this as a “failure” and terminates the processing. On the other hand, if the determination of the application name has been successful (step S7403: YES), the process moves on to step S7404.

Then, in step S7404, a default application object corresponding to the application class is generated and the process regards this as a “success” and terminates the processing.

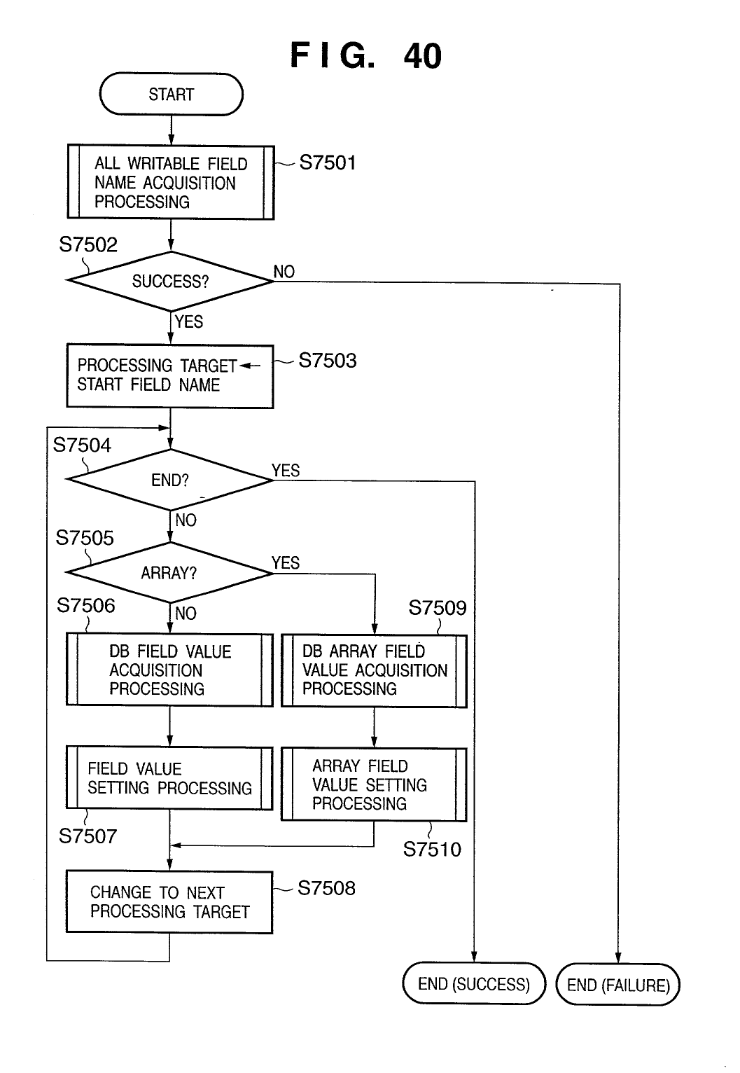

Then, details of the object value setting processing in step S5907 will be explained using FIG. 40.

FIG. 40 is a flow chart showing details of the object value setting processing in step S5907 of First Embodiment.

When the object value setting processing is started, all writable field name acquisition processing is executed in step S7501, the definition of each field of the given application object is referenced and the names of all writable fields are acquired.

As a result of the all writable field name acquisition processing, it is determined in next step S7502 whether the acquisition of the field names has been “successful” or not. If the acquisition of the field names has not been “successful” (step S7502: NO), the process regards this as a “failure” and terminates the processing. On the other hand, if the acquisition of the field names has been “successful” (step S7502: YES), the process moves onto step S7503.

In step S7503, after the name of the field to be processed is set at the start of the acquired all writable field name list, processing for all fields to be processed is repeated in the following steps.

In next step S7504, it is determined whether processing for all fields to be processed has been terminated or not. If processing for all fields to be processed has been terminated (step S7504: YES), the system regards this as a “success” and terminates the processing. On the other hand, if processing for all fields to be processed has not been terminated (step S7504: NO), the process moves on to step S7305.

Then, instep S7505, it is determined whether the field to be processed is an array or not. If the field to be processed is not an array (step S7505: NO), the process moves on to step S7506.

In step S7506, DB field value acquisition processing is executed to acquire a value corresponding to the name of the field to be processed of the given database object. In next step S7507, field value setting processing is executed to store the field value in the corresponding field of the application object. Then, in step S7508, the field to be processed is changed to the next field, the process goes back to step S7504 again and repeats the processing.

On the other hand, in step S7505, if the field to be processed is an array (step S7505: YES), the process moves on to step S7509.

In step S7509, DB array field value acquisition processing is executed to acquire the value corresponding to the name of the field to be processed of the given database object. In next step S7510, array field value setting processing is executed to store the array field value in the corresponding field of the application object. In step S7508, the field to be processed is changed to the next field, and the process goes back to step S7504 again and repeats the processing.

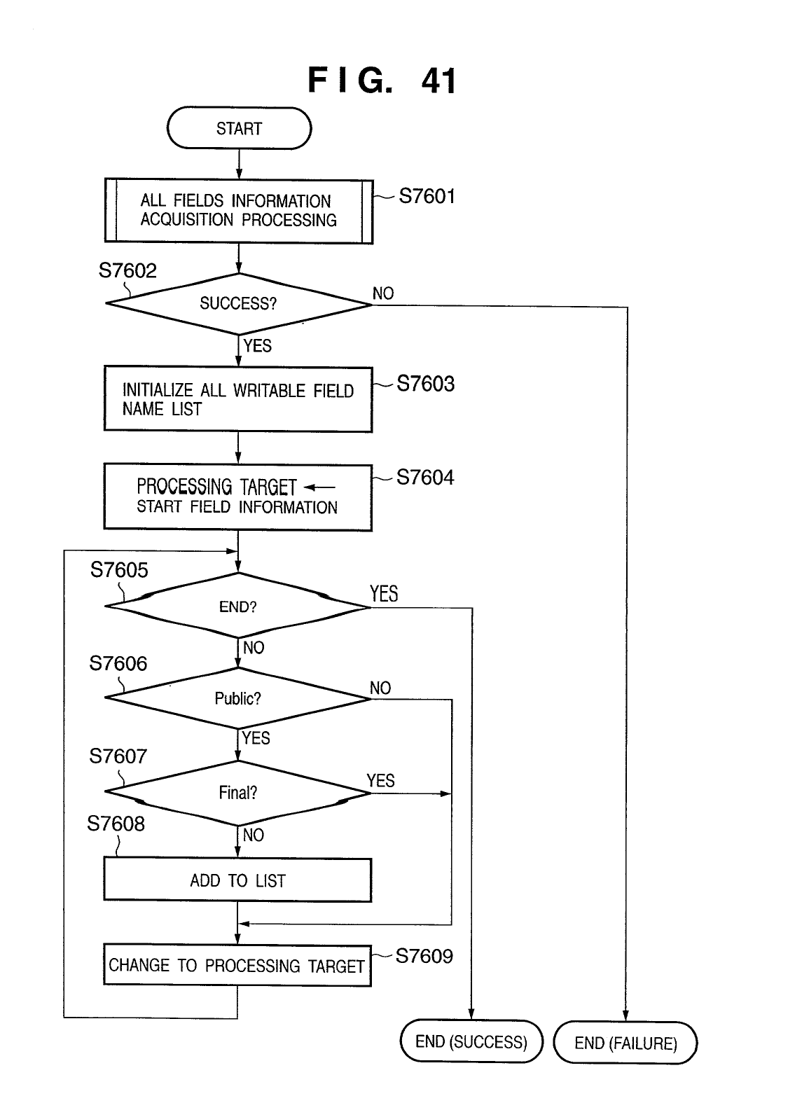

Then, details of all writable field name acquisition processing in step S7301 and step S7501 in the DB object value setting processing in FIG. 38 and the object value setting processing in FIG. 40 will be explained using FIG. 41.

FIG. 41 is a flow chart showing details of the all writable field name acquisition processing in step S7301 and step S7501 of First Embodiment.

When all writable field name acquisition processing is started, all field information acquisition processing is executed in step S7601 to acquire name field information of the given application object.

As a result of the all field information acquisition processing, it is determined in next step S7602 whether the acquisition of the filed information has been successful or not. If the acquisition of the filed information has not been successful (step S7602: NO), the system regards this as a “failure” and terminates the processing. On the other hand, if the acquisition of the filed information has been successful (step S7602: YES), the process moves on to step S7603.

In step S7603, the all writable field name list for output is initialized. In next step S7604, after setting the processing target at the start of the acquired all field information, processing for all processing targets is repeated in the following steps.

In next step S7605, it is determined whether processing on field information of all processing targets has been terminated or not. If the processing on field information of all processing targets has been terminated (step S7605: YES), the system regards this as a “success” and terminates the processing. On the other hand, if the processing on field information of all processing targets has not been terminated (step S7605: NO), the process moves on to step S7606.

Then, in step S7606, it is determined whether the field attribute of the field information can be referenced externally (public) or not. If the field attribute of the field information cannot be referenced externally (step S7606: NO), the process moves onto step S7609. On the other hand, the field attribute of the field information can be referenced externally (step S7606: YES), the process moves on to step S7607.

In step S7607, it is determined whether the field attribute of the field information is writable (final) or not. If the field attribute of the field information is writable (step S7607: YES), the process moves on to step S7609. On the other hand, the field attribute of the field information is not writable (step S7607: NO), the process moves on to step S7608.

In step S7608, the name of the field to be processed is added to the all writable field name list. Then, in step S7609, the field information to be processed is changed to the next field information and the process goes back to step S7605 and repeats the processing.

As explained above, First Embodiment acquires definition information of an application object referenced by an application program for a database in which permanent data is stored and operates the database using the application object and the acquired application object definition information.

This makes it possible to use a database without learning a coding procedure specific to a database module or complicated know-how and allows the developer to concentrate on the development of the own business logic and realize drastic improvement of the development efficiency.

<Second Embodiment>

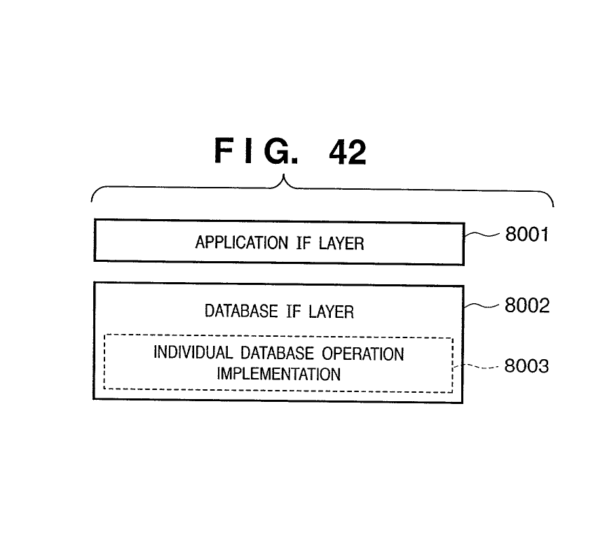

FIG. 42 illustrates layered database operating means of an information processor according to Second Embodiment.

The database operating means of Second Embodiment is constructed of an application IF (interface) layer 8001, a database IF (interface) layer 8002 and an individual database operation implementation 8003.

The application IF layer 8001 provides bridging to absorb differences in various data structures and differences in methods used between the application program and database. More specifically, application objects and database objects are mutually converted and the database methods are wrapped according to the mode requested by the application program.

The database IF layer 8002 provides a higher class or interface for operations of various databases and at the same time provides a method common to the various databases. This makes it possible to realize a method common to all databases and eliminates the need to individually implement common processing independent of individual databases.

The individual database operation implementation 8003 can implement various databases individually by simply expanding the higher class or interface provided by the database IF operation.

Adopting such a hierarchic structure for the database operating means allows the application developer to use different databases without using individual methods. Furthermore, it allows individual database providers to incorporate the provided databases without modifying existing applications.

Furthermore, it allows an application developer who has a different request to realize more specialized functions by developing a dedicated application IF layer.

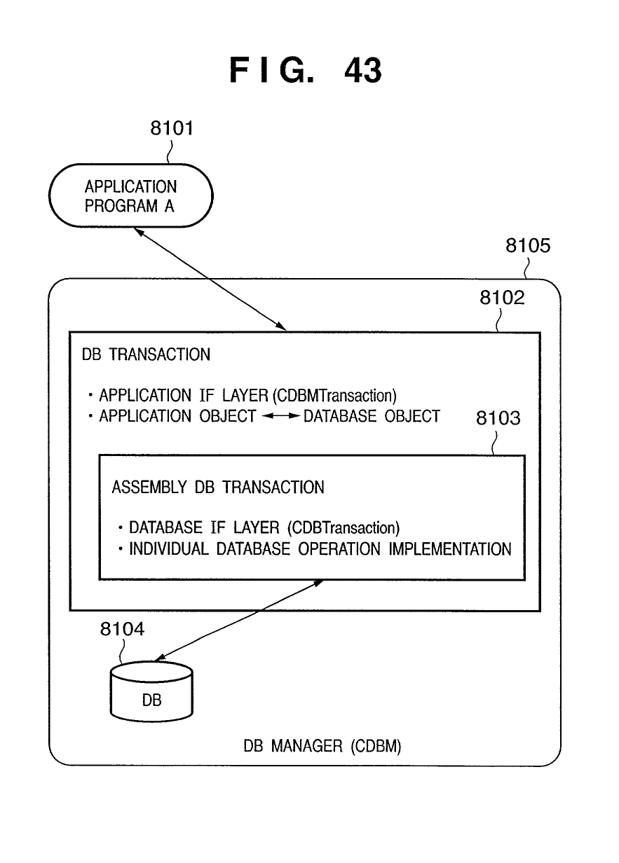

Then, a layered DB transaction structure of Second Embodiment will be explained using FIG. 43.

FIG. 43 illustrates a layered DB transaction structure according to Second Embodiment.

A DB manager 8105 of Second Embodiment generates or discards a DB transaction 8102 that handles a series of transactions with a database 8104 corresponding to a request from an application program A8101.

Here, the DB transaction 8102 is constructed of an application interface layer that interfaces to the application program A8101 and a database interface layer dependent on an implemented DB transaction 8103 of an individual databases.

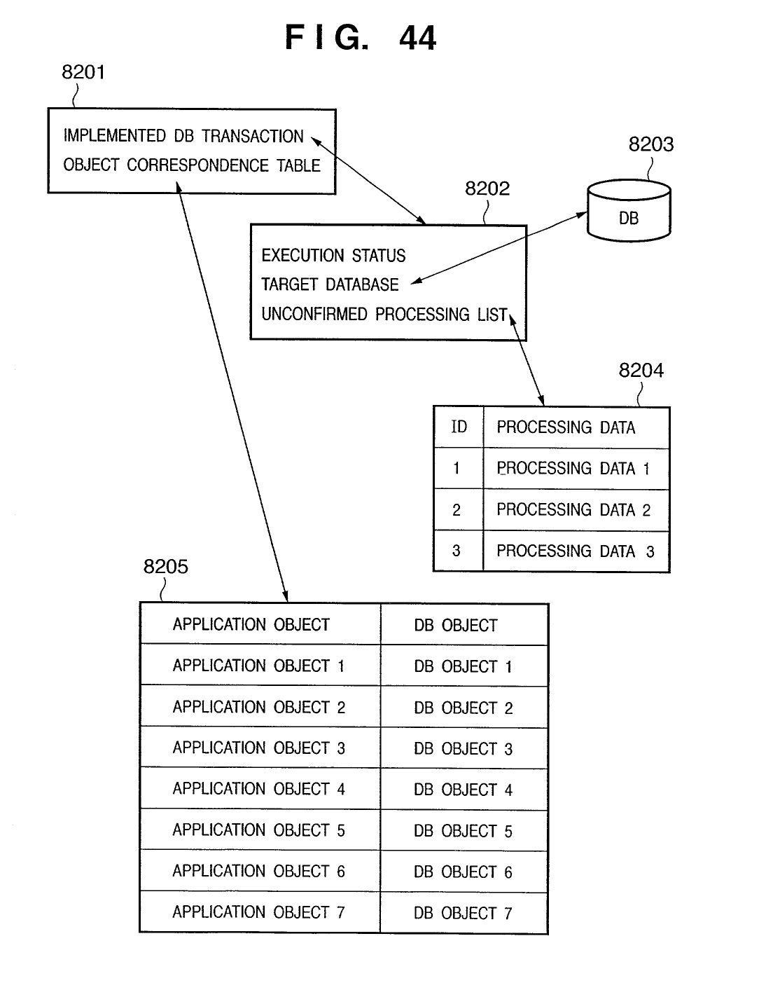

Next, internal data of the layered DB transaction will be explained using FIG. 44.

FIG. 44 illustrates the internal data of the layered DB transaction of Second Embodiment.

As indicated by reference numeral 8201, the layered DB transaction includes internal data such as information 8202 of the actually built in implemented DB transaction and an object correspondence table 8205 that stores the correspondence between application objects that have become processing targets after generation of transactions and DB objects.

Furthermore, the information 8202 of the implemented DB transaction includes an execution status indicating whether a transaction is being executed or not, database information 8203 which is a transaction target and a list of unconfirmed processing 8204 carried out during execution of the transaction.

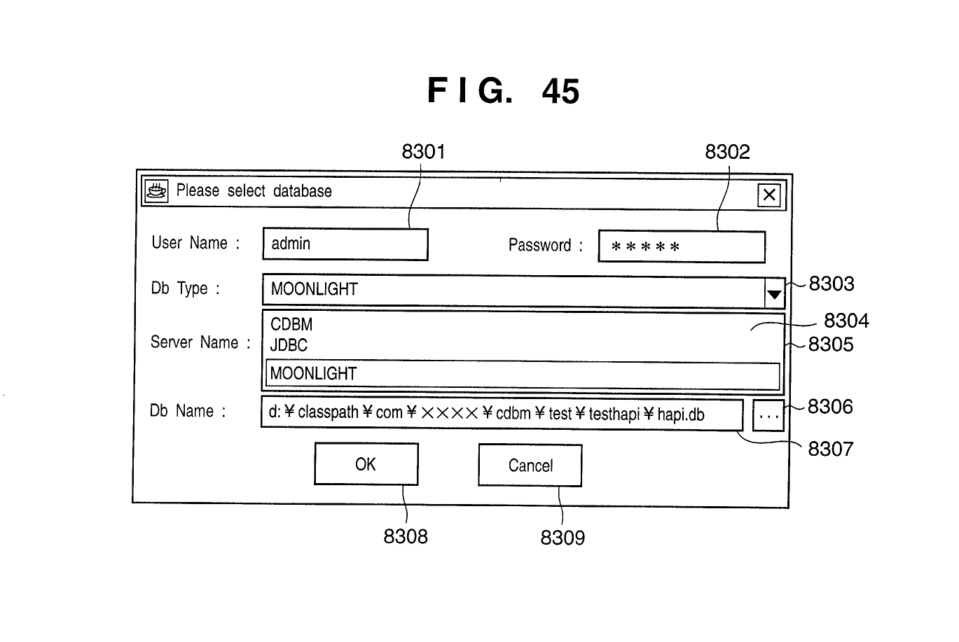

Then, the transaction generation screen when a type of database is selected on the aforementioned transaction generation screen of FIG. 5 will be explained using FIG. 45.

FIG. 45 illustrates an example of the transaction generation screen when a type of the database of Second Embodiment is selected.

Reference numeral 8303 denotes a combo box to specify a type of database and allows the user to select an arbitrary type of database.

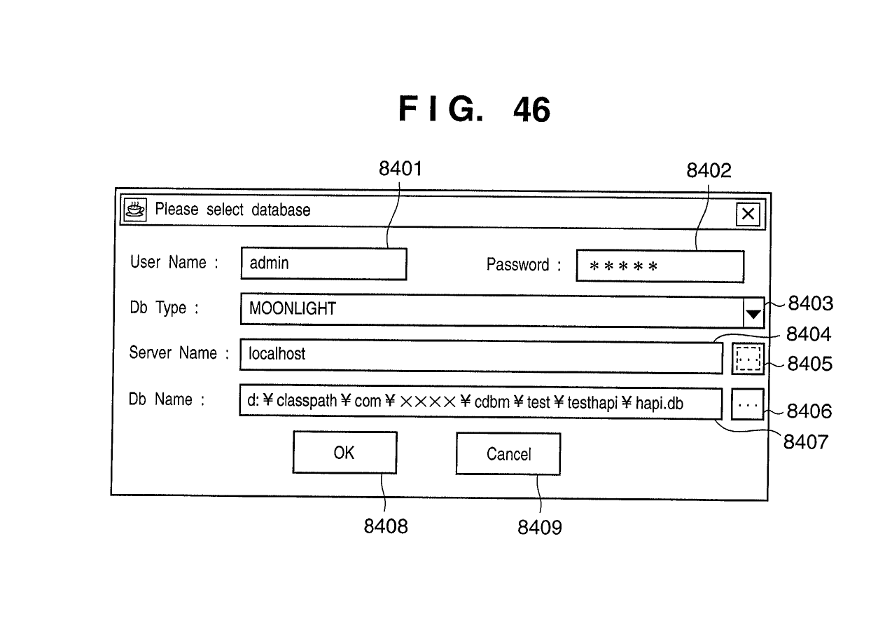

Next, on the aforementioned transaction generation screen in FIG. 5, the transaction generation screen when a server name is entered will be explained using FIG. 46.

FIG. 46 illustrates an example of a transaction generation screen to enter a server name according to Second Embodiment.

Reference numeral 8404 is an area to enter the name of a server that supplies a service of connection to a database and the user can specify an arbitrary server name or specify none.

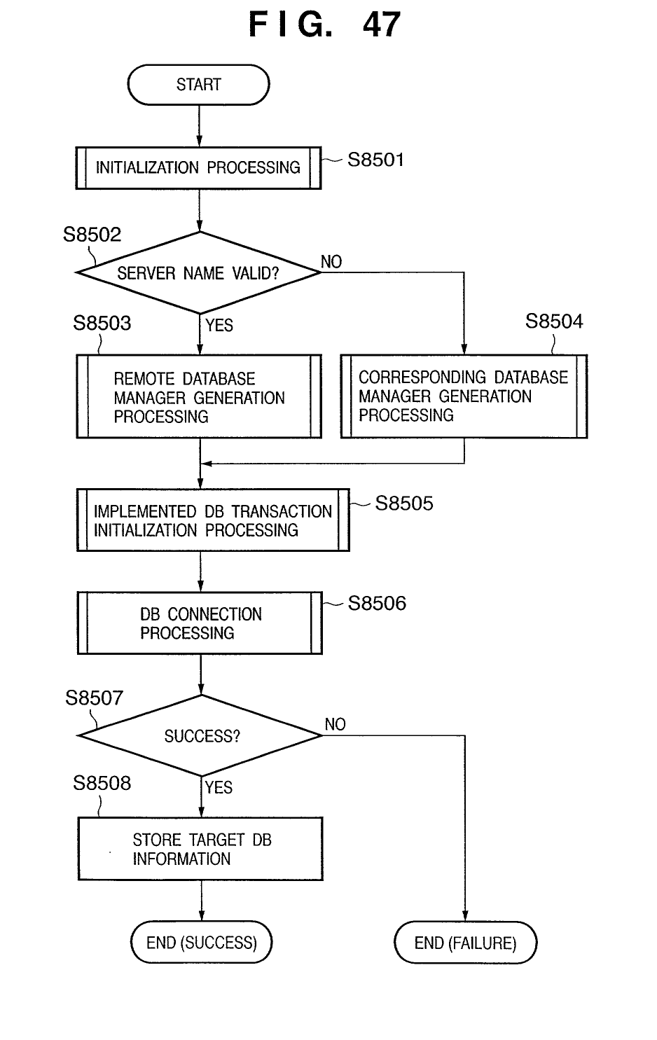

Then, details of the DB transaction generation processing in step S603 according to Second Embodiment will be explained using FIG. 47.

FIG. 47 is a flow chart showing details of the DB transaction generation processing according to Second Embodiment.

When the DB transaction generation processing is started, the initialization processing in step S8501 is executed to initialize the internal data of the DB transaction explained in FIG. 44. In next step S8502, it is determined whether the server name specified on the transaction generation screen explained in FIG. 46 is valid or not. If the server name is valid (step S8502: YES), the process moves on to step S8503, executes remote database manager generation processing to generate a database manager to connect the server specified with the server name. On the other hand, if the server name is not valid (step S8502: NO), the process moves on to step S8504, executes the corresponding database manager generation processing to generate a database manager of the database specified by the transaction generation screen explained in FIG. 45.

In next step S8505, the implemented DB transaction initialization processing supplied by the database manager generated is executed to initialize the internal data of the implemented DB transaction explained in FIG. 44.

In next step S8506, the DB connection processing provided by the database manager generated is executed to connect the database under a specified condition.

As a result of the DB connection processing, it is determined in next step S8507 whether the connection of the database has been successful or not. If the connection of the database has not been successful (step S8507: NO), the system regards this as a “failure” and terminates the processing. On the other hand, if the connection of the database has been successful (step S8507: YES), the process moves on to step S8508.

In step S8508, connection-related information is stored in the internal data of the implemented DB transaction and the system regards this as a “success” and terminates the processing.

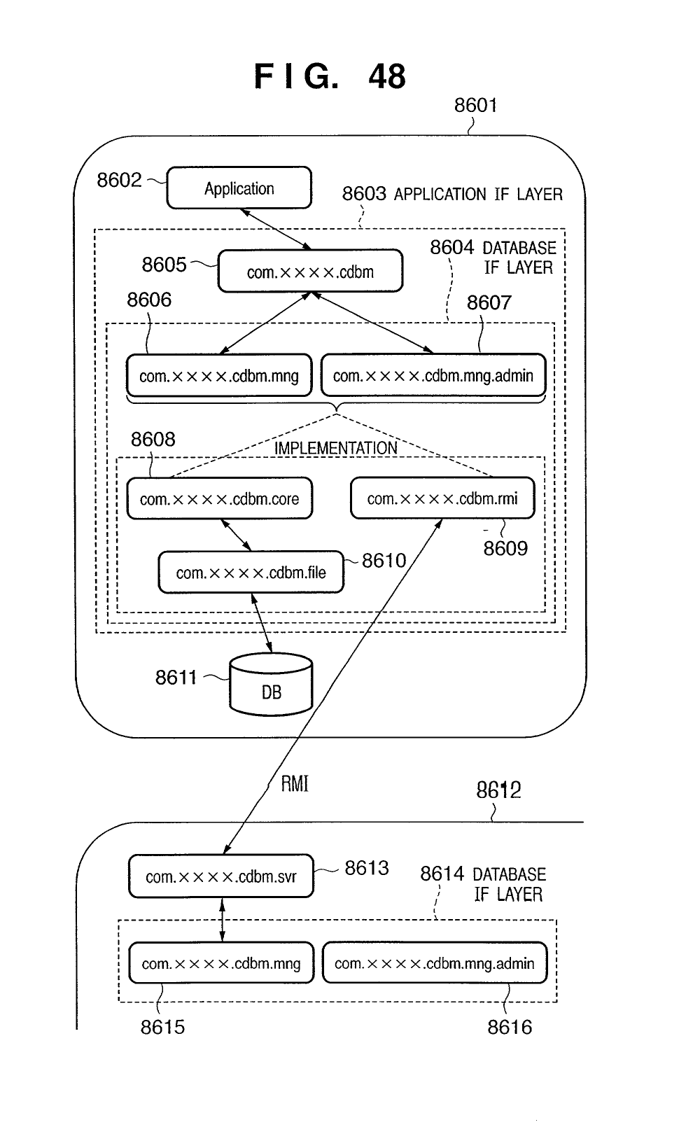

Then, a relationship between packages which are a set of several purposes explained in the layered DB transaction structure will be explained using FIG. 48.

FIG. 48 illustrates an example of a relationship between packages which are a set of several purposes of the layered DB transaction structure according to Second Embodiment.

In the same figure, reference numerals 8601 and 8612 denote sets of systems, devices and processes, etc. and can send/receive objects to/from each other using a protocol such as RMI.

Here, an application program 8602 can access a database 8611 using a package com.xxxx.cdbm 8605 which implements an application IF layer 8603 that exists on the same device 8601.

Furthermore, the application IF layer 8603 is implemeted using packages com.xxxx.cdbm.mng 8606 and com.xxxx.cdbm.mng.admin 8607 of the database IF layer 8604.

However, implementing specific to individual databases is performed by packages com.xxxx.cdbm.core 8608 or com.xxxx.cdbm.rmi 8609, which are expanded interfaces or classes of the above database IF layer 8604. Furthermore, a package com.xxxx.cdbm.file 8610 hides the physical structure of the database 8611 used in the above package 8608.

Furthermore, access to a database that exists in a different device is realized using a package com.xxxx.cdbm.svr 8613 of a different device via a protocol such as RMI implemented in the above package 8609. By the way, implementing of the package 8613 and subsequent packages is arbitrary, but in the same figure, the package 8613 is implemented using packages com.xxxx.cdbm.mng 8615 and com.xxxx.cdbm.mng.admin 8616 of a database IF layer 8614 as in the case of the aforementioned configuration.

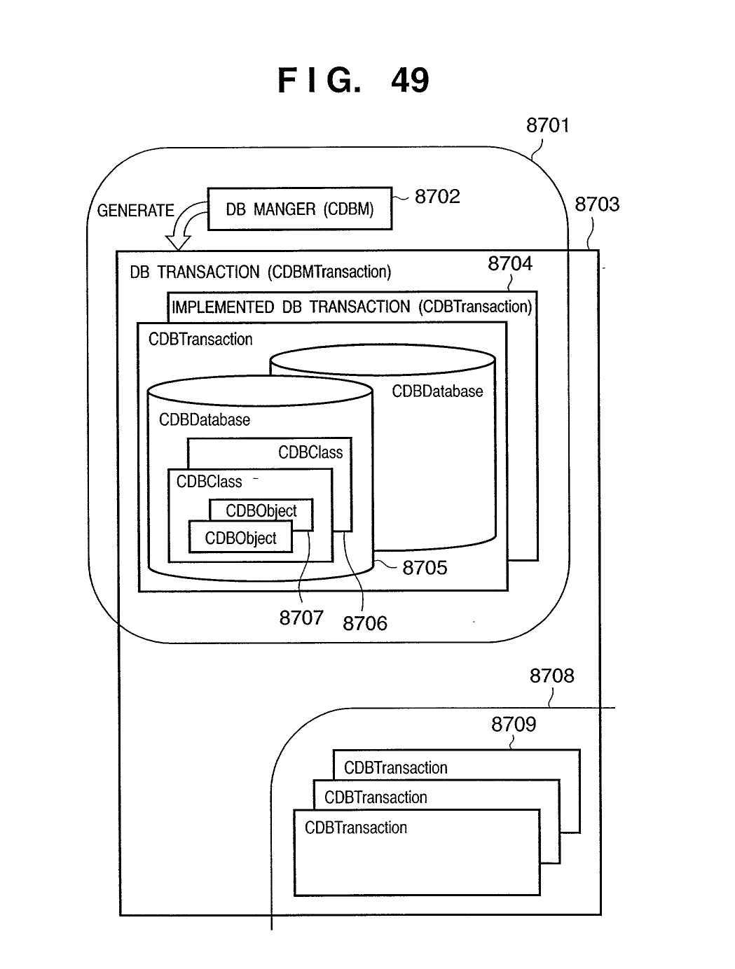

Then, the relationship between classes explained with the layered DB transaction structure will be explained using FIG. 49.

FIG. 49 illustrates an example of the relationship between classes of the layered DB transaction structure according to Second Embodiment.

In the same figure, reference numerals 8701 and 8708 denote sets of systems, devices and processes, etc. with which Second Embodiment operates and can send/receive objects to/from each other using a protocol such as RMI.

Here, the application can generate a DB transaction class CDBMTransaction 8703 and access the database using a DB manager class CDBM 8702 that exists on the same device 8701.

The DB transaction class CDBMTransaction 8703 contains an implemented DB transaction class CDBTransaction 8704 corresponding to a specified database.

The DB transaction class CDBTransaction 8704 contains a database class CDBDatabase 8705 corresponding to a specified database.

The database class CDBDatabase 8705 contains a database definition class CDBClass 8706 corresponding to a definition of stored data.

The database definition class CDBClass 8706 contains a database object class CDBObject 8707 corresponding to the stored data.

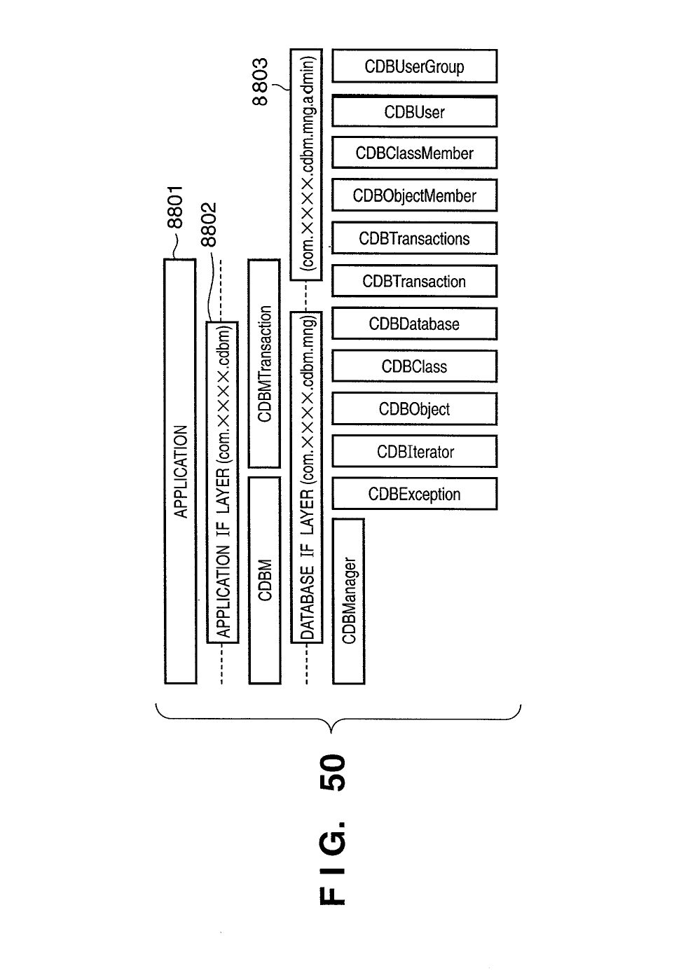

Then, the basics class layer explained with the layered DB transaction structure will be explained using FIG. 50.

FIG. 50 illustrates an example of a basic class layer of the layered DB transaction structure according to Second Embodiment.

In the same figure, an application 8801 accesses a database using a service provided by an application IF layer com.xxxx.cdbm 8802.

Each class of the application IF layer com.xxxx.cdbm 8802 is processed using a service provided by a database IF layer com.xxxx.cdbm.mng and com.xxxx.cdbm.mng.admin 8803.

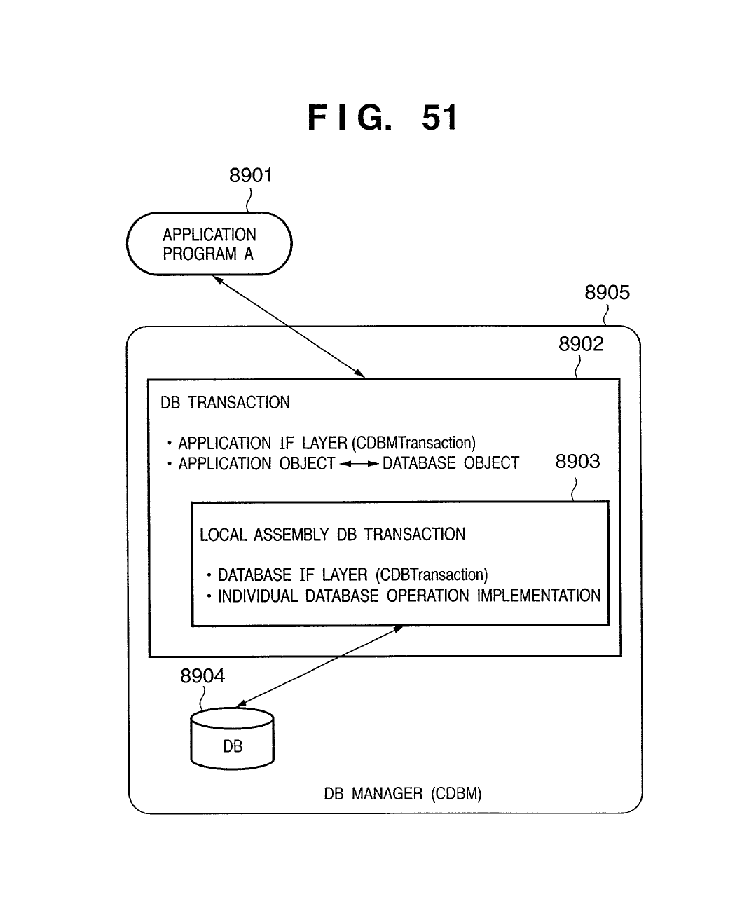

Then, the layered DB transaction structure when a database exists on the same device as that of the application program will be explained using FIG. 51.

FIG. 51 illustrates an example of the layered transaction structure when a database exists on the same device as that of an application program according to Second Embodiment.

A DB manager 8905 of Second Embodiment generates or discards a DB transaction 8902 handling a series of transactions with a databases 8904 corresponding to a request from an application programs A8901.

Here, the DB transaction 8902 is constructed of an application interface layer that interfaces to the application program A8901 and a database interface layer dependent on a local implemented DB transaction 8903 of a database that exists in the same device.

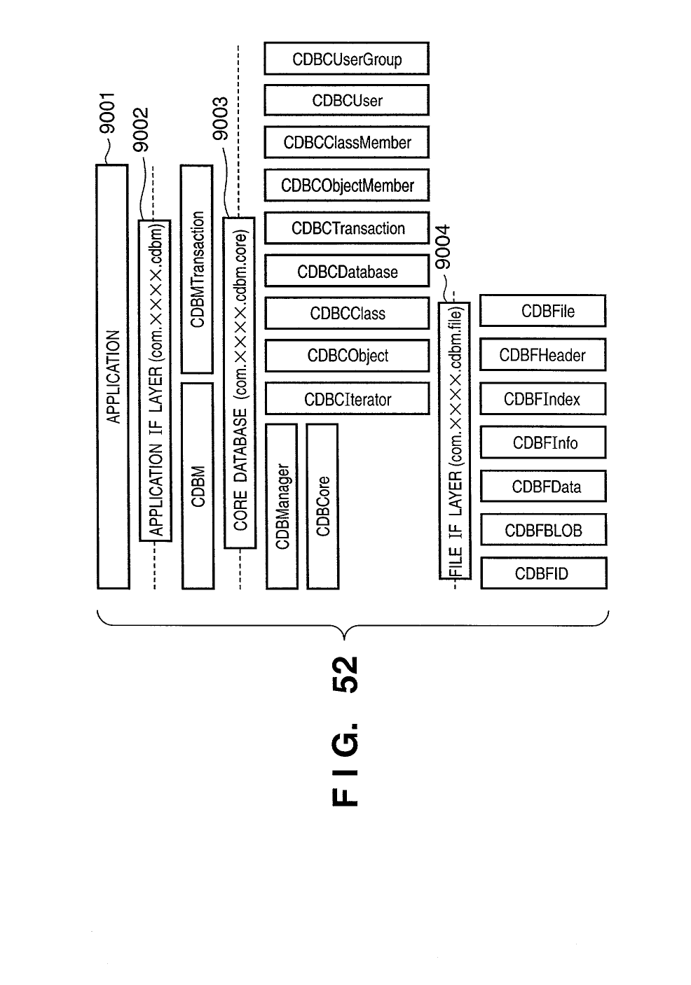

Then, a basic class layer when the basic class layer is expanded to a local database will be explained using FIG. 52.

FIG. 52 illustrates an example of the basic class layer when expanded to the local database according to Second Embodiment.

In the same figure, an application 9001 accesses a database using a service provided by an application IF layer com.xxxx.cdbm 9002.

Furthermore, each class of the application IF layer com.xxxx.cdbm 9002 is processed using services provided by the database IF layers com.xxxx.cdbm.mng and com.xxxx.cdbm.mng.admin explained in FIG. 50. However, its implementation is provided by a core database com.xxxx.cdbm.core 9003. That is, the core database com.xxxx.cdbm.core 9003 is implemented in a mode expanding the interface and class provided by the database IF layers com.xxxx.cdbm.mng and com.xxxx.cdbm.mng.admin explained in FIG. 50.

Here, the core database com.xxxx.cdbm.core 9003 is implemented using a file IF layer com.xxxx.dcbm.file 9004 that hides the physical structure of the database.

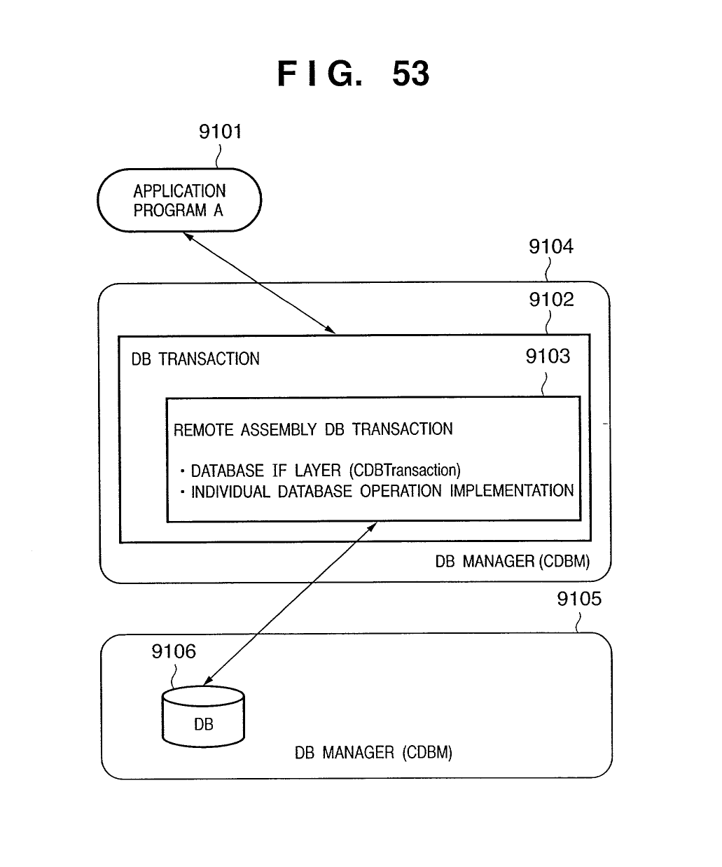

Then, a layered DB transaction structure when a database exists in a device different from that of the application program will be explained using FIG. 53.

FIG. 53 illustrates an example of the layered DB transaction when a database exists in a device different from that of the application program according to Second Embodiment.

A DB manager 9104 of Second Embodiment generates or discards a DB transaction 9102 that handles a series of transactions with a database 9106 in response to a request from an application program A9101.

Here, the DB transaction 9102 is constructed of an application interface layer that interfaces to the application program A9101 and a database interface layer that depends on a remote implemented DB transaction 9103 with a database that exists in a different device 9105.

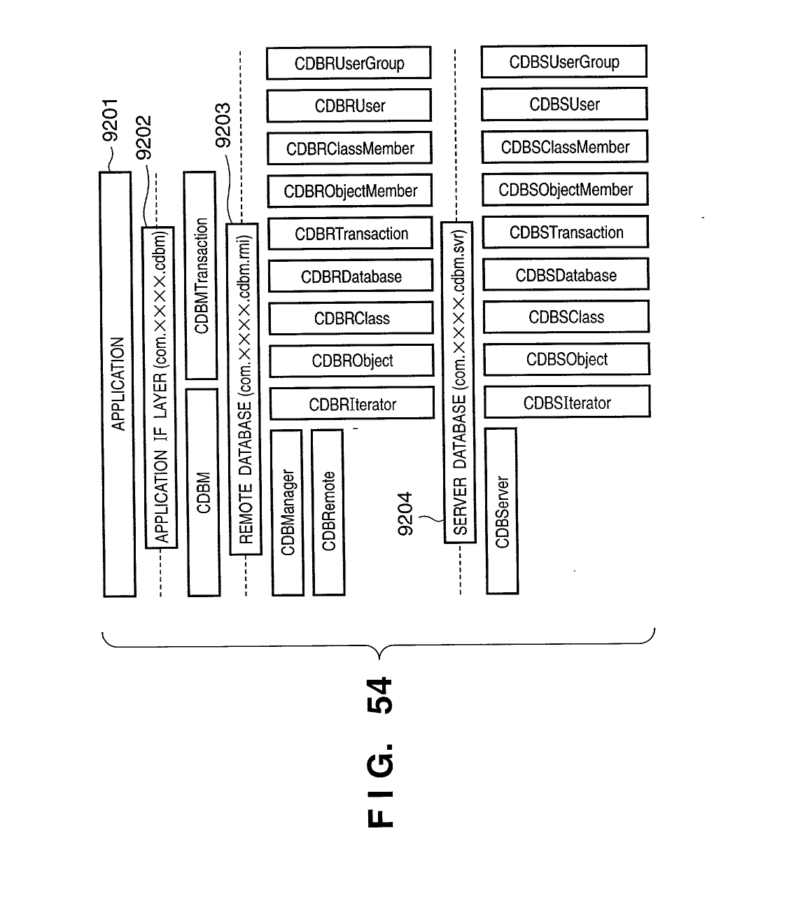

Then, a basic class layer when expanded to a remote database expanded will be explained using FIG. 54.

FIG. 54 illustrates an example of the basic class layer when expanded to a remote database according to Second Embodiment.

In the same figure, an application 9201 accesses a database using a service provided by an application IF layer com.xxxx.cdbm 9202.

Furthermore, each class of the application IF layer com.xxxx.cdbm 9202 is processed using services provided by the database IF layers com.xxxx.cdbm.mng and com.xxxx.cdbm.mng.admin explained in FIG. 50. However, its implementation is provided by a remote database com.xxxx.cdbm.rmi 9203 as shown in the same figure. That is, the remote database com.xxxx.cdbm.rmi 9203 is provided in a mode expanding the interface and class provided by the database IF layers com.xxxx.cdbm.mng and com.xxxx.cdbm.mng.admin explained in FIG. 50.

Here, the remote database com.xxxx.cdbm.rmi 9203 is implemented using a server database com. xxxx.cdbm.svr 9204 that provides a remote interface to access a database on a different device.

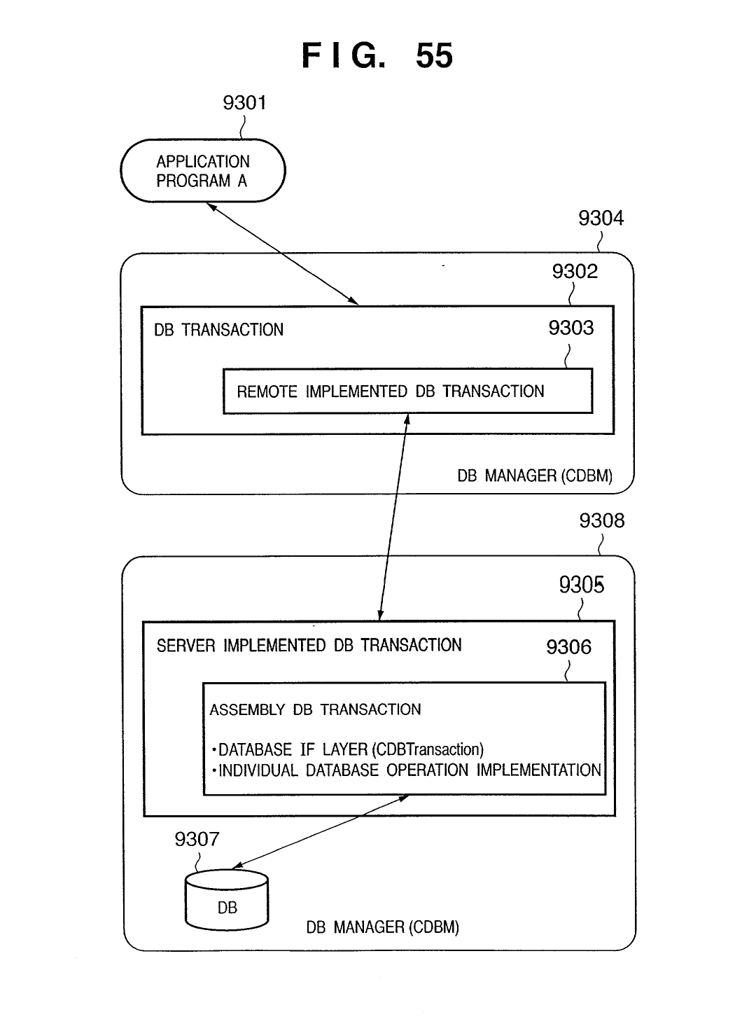

Then, a layered DB transaction structure when a database is supplied to an application program on a different device of the layered DB transaction structures will be explained using FIG. 55.

FIG. 55 illustrates an example of a layered DB transaction when a database is supplied to an application program on a different device according to Second Embodiment.

A DB manager 9304 of Second Embodiment generates or discards a DB transaction 9302 that handles a series of transactions with a database 9307 in response to a request from an application program A9301.

Here, the DB transaction 9302 is constructed of an application interface layer that interfaces to the application program A9301 and a remote database interface layer that depends on the remote implemented DB transaction 9303 with the database 9307 that exists in a different device 9308.

On the other hand, the DB manager 9308 that provides a database service provides a server implemented DB transaction 9305 expanded so that the database IF layer dependent on the implemented DB transaction 9306 of the database 9307 can be used from a different device.

As shown above, it is possible for the application side to hide the remote interface with the database that exists in a different device using the above remote implemented DB transaction 9303 and for the database side to expand a local service so that the local service can also be used from a different device using the server implemented DB transaction 9305.

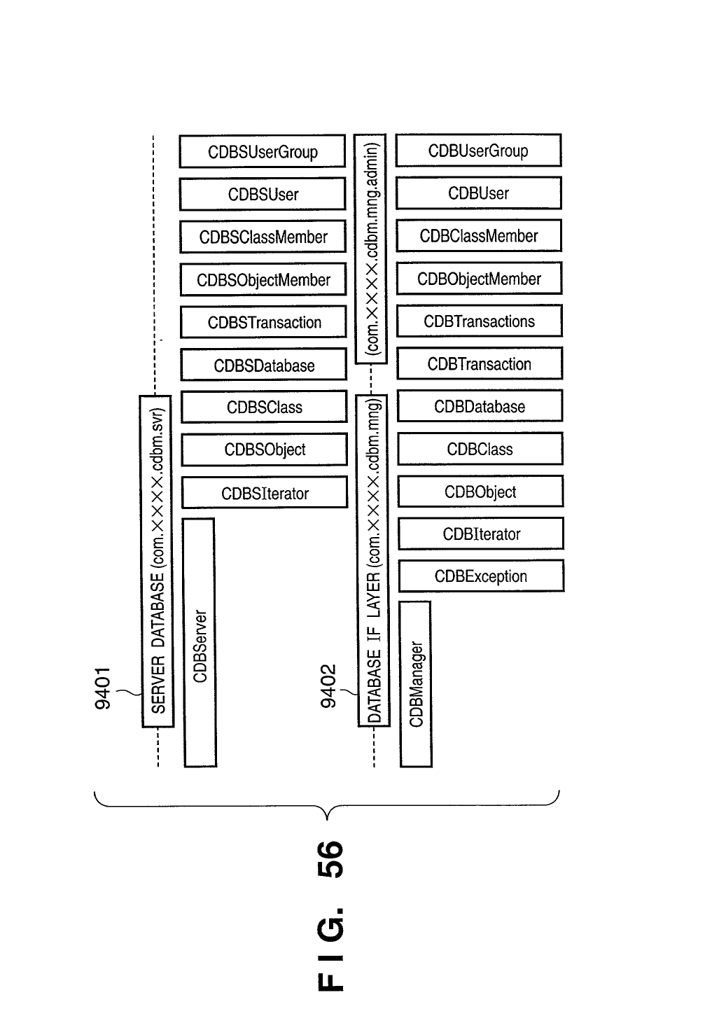

Then, a basic class layer when a remote interface is expanded so that a database IF layer of the basic class layer can also be used from a different device will be explained using FIG. 56.

FIG. 56 illustrates an example of the basic class layer when the remote interface is expanded so that a database IF layer according to Second Embodiment can also be used from a different device.

In the same figure, a remote interface is expanded by the server database 9401 in order to allow a different device to access a database IF layer 9402.

As described above, being provided with a database that stores permanent data, an application interface that interprets and processes an operation by an application program, a database interface that interprets and processes an operation common to databases and an individual database that executes database-specific processing, Second Embodiment absorbs differences in the type of database or differences whether the database exists in a local device or a server without producing extra overhead on the local database. This makes it possible to use the database to handle permanent data without the need for the developer to get familiar with individual interfaces and allows the developer to concentrate on the development of the own business logic, producing an effect of improving the development efficiency drastically.

<Third Embodiment>

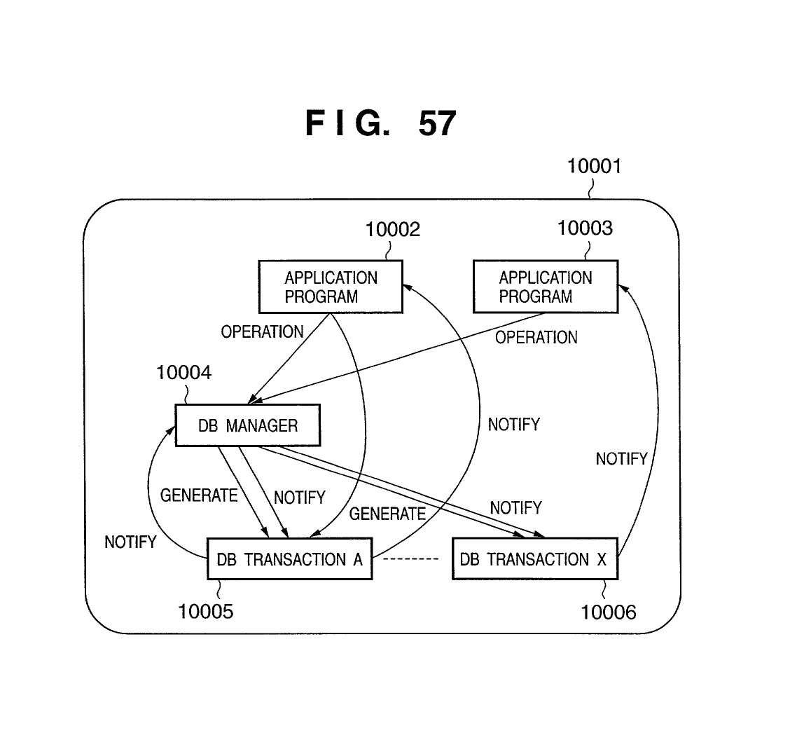

FIG. 57 illustrates a flow of notification information accompanying changes, etc. in a database according to Third Embodiment.

In the same figure, a DB transaction A10005 is generated using an application program 10002 and a DB manager 10004 that exists on an identical device 10001. Likewise, a DB transaction X10006 is generated using an application program 10003.

Here, in connection with a change caused by the processing carried by the DB transaction A10005, notification information is notified to the DB manager 10004. The DB manager 10004 notifies the DB transaction A10005 and DB transaction X10006 under its control of the notification information notified. Upon reception of the above notification, the DB transaction A10005 notifies it to the application program 10002 and likewise the DB transaction X10006 notifies it to the application program 10003.

Through the above flow, the application programs that have received the notification information execute appropriate processing such as redisplay of database information according to their respective decisions.

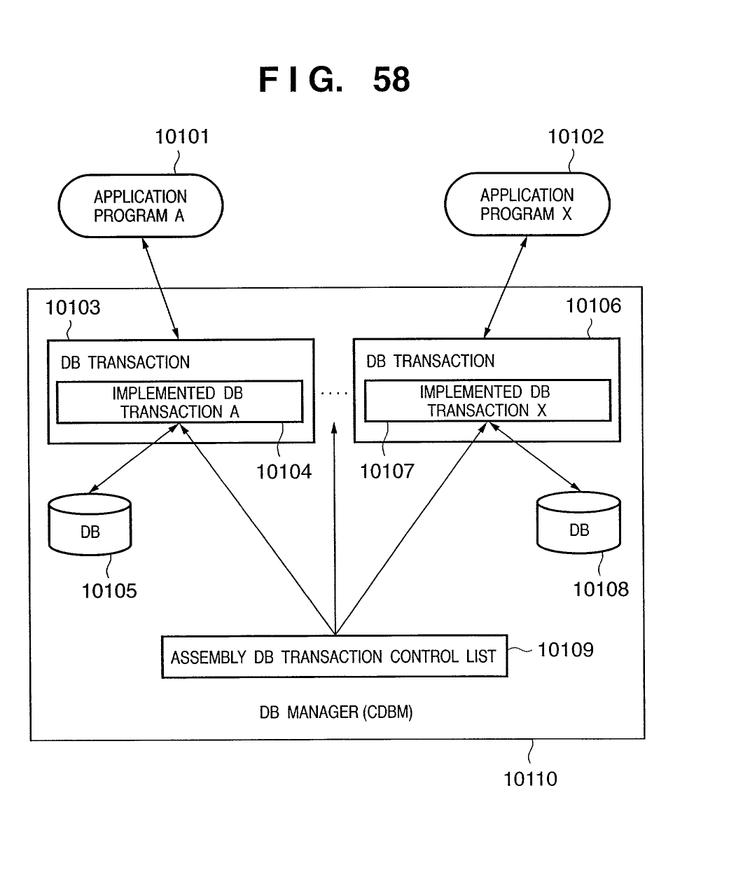

Then, a layered DB transaction structure according to Third Embodiment will be explained using FIG. 58. The DB transaction structure in Third Embodiment introduces a concept of an implemented DB transaction control list to the DB transaction structure in Second Embodiment.

FIG. 58 illustrates the layered DB transaction structure of the information processor according to Third Embodiment.

A DB manager 10110 of Third Embodiment generates or discards a DB transaction 10103 handling a series of transactions with a databases 10105 in response to a request from an application program A10101. Here, the DB transaction 10103 is constructed of an application interface layer that interfaces to the application program A10101 and an implemented DB transaction A10104 which is a database interface layer dependent on the implementation of individual databases. Likewise, the DB manager 10110 generates a DB transaction 10106 handling a series of transactions with the databases 10108 in response to a request from the application programs X10102 and an implemented DB transaction X10107.

A group of these implemented DB transaction generated are stored in and controlled by an implemented DB transaction control list 10109.

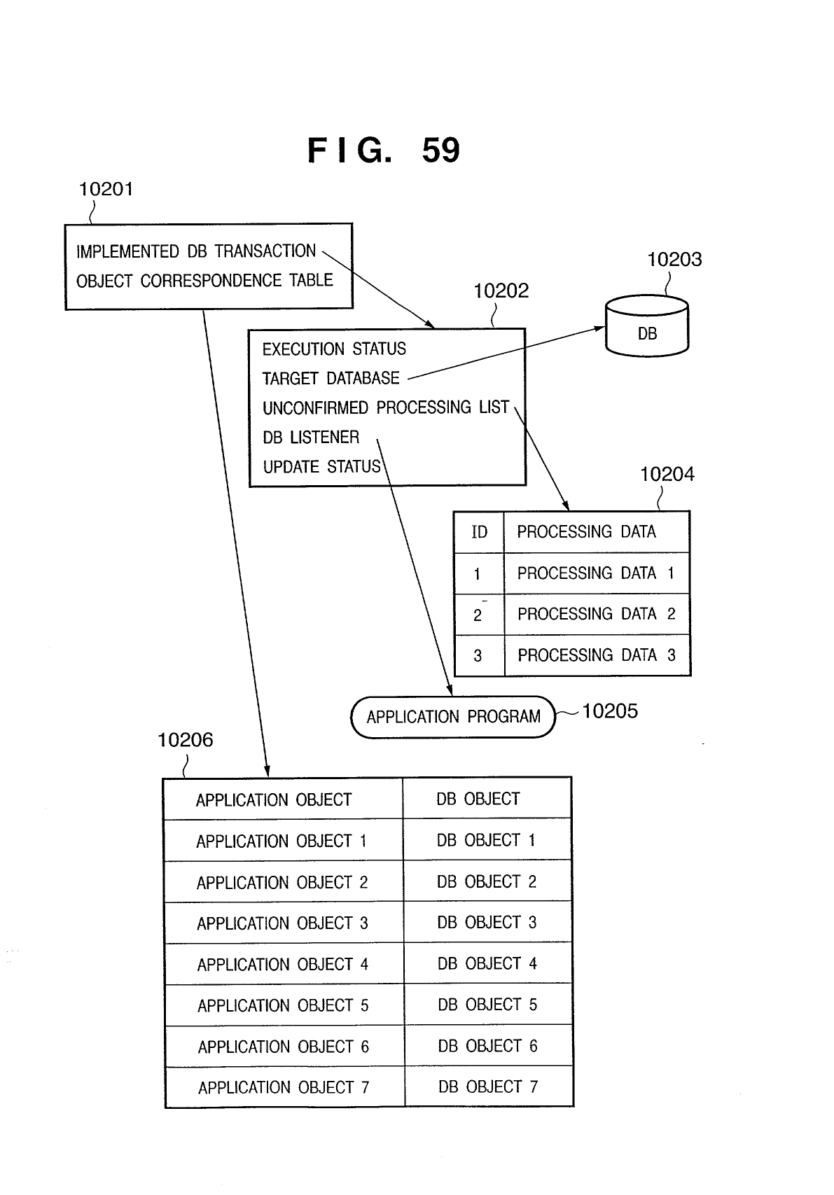

Then, internal data of a layered DB transaction will be explained using FIG. 59.

FIG. 59 illustrates the internal data of a layered DB transaction according to Third Embodiment.

As indicated by reference numeral 10201, the layered DB transaction includes internal data of information 10202 of the implemented DB transaction actually implemented and an object correspondence table 10206 that stores the correspondence between application objects that have become processing targets after creation of transactions and DB objects.

Furthermore, the information 10202 of the implemented DB transaction includes an execution status that indicates whether a transaction is “executing” or not, database information 10203 which is a transaction target, a list of unconfirmed processes 10204 carried out in execution of the transaction, a DB listener that contains information of the destination to which a database change is notified (e.g., application program 10205) and an update status that stores the situation of the database change.

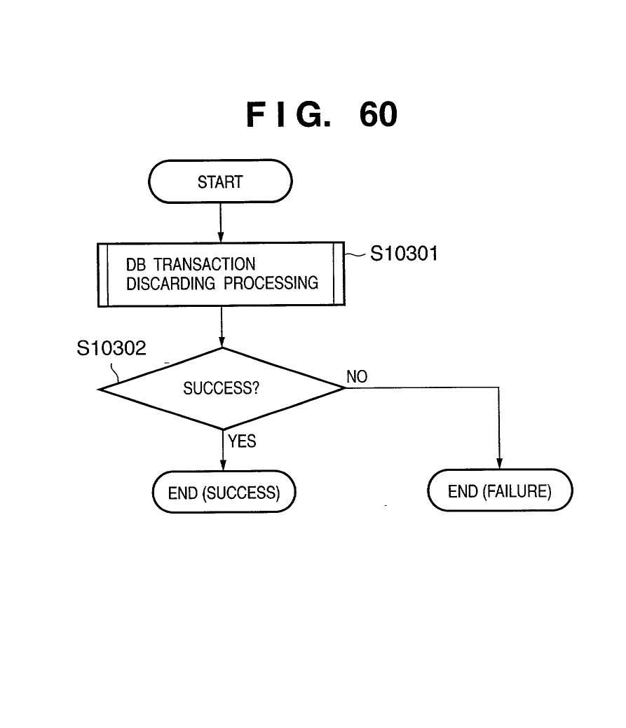

Then, details of transaction discarding processing in step S409 according to Third Embodiment will be explained using FIG. 60.

FIG. 60 is a flow chart showing details of the transaction discarding processing in step S409 according to Third Embodiment.

When the transaction discarding processing is started, DB transaction discarding processing is executed in step S10301 to discard the corresponding DB transaction. As a result of the DB transaction processing, it is determined in next step S10302 whether the discarding of the DB transaction has been successful or not. If the discarding of the DB transaction has been successful (step S10302: YES), the system regards this as a “success” and terminates the processing. On the other hand, if the discarding of the DB transaction has not been successful (step S10302: NO), the system regards this as a “failure” and terminates the processing.

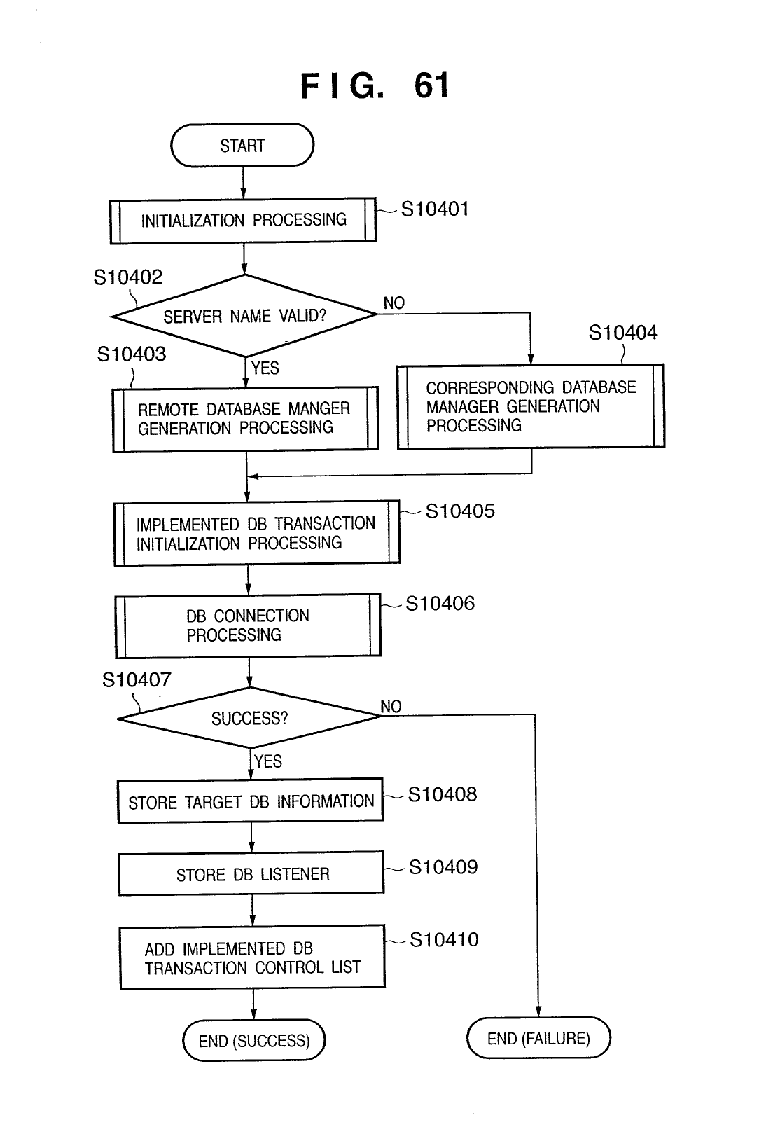

Then, details of the DB transaction generation processing in step S603 according to Third Embodiment will be explained using FIG. 61.

FIG. 61 is a flow chart showing details of DB transaction generation processing according to Third Embodiment.

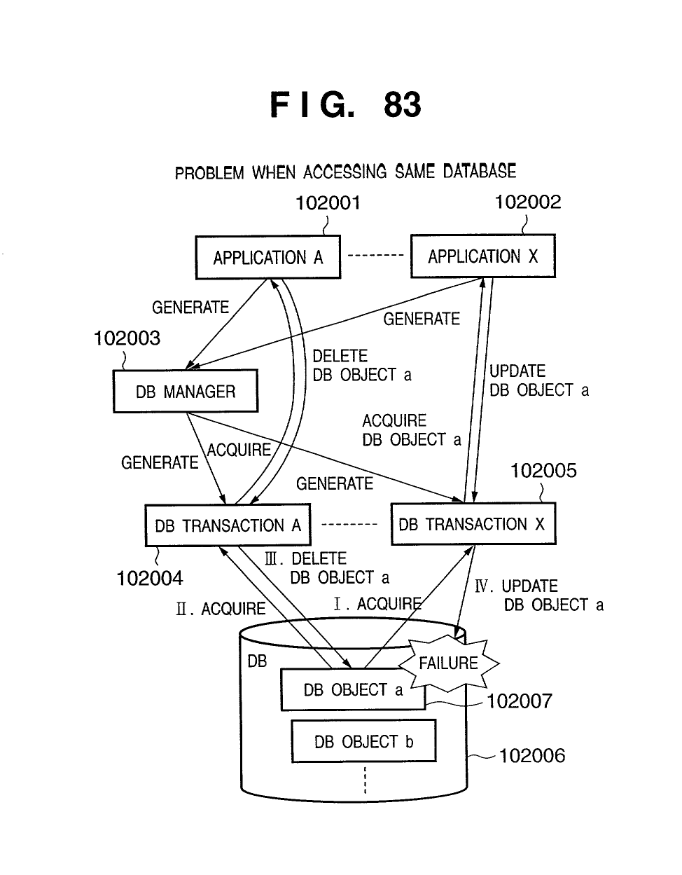

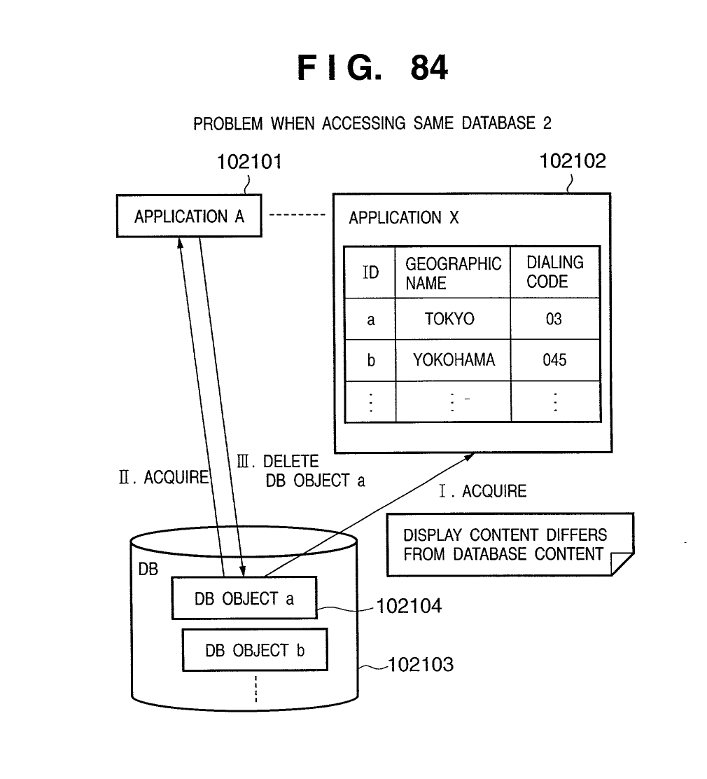

When the DB transaction generation processing is started, initialization processing is executed in step S10401 to initialize the internal data of the layered DB transaction explained in FIG. 59. It is determined in next step S10402 whether the server name specified on the transaction generation screen explained in FIG. 84 is valid or not. If the server name is valid (step S10402: YES), the process moves on to step S10403 and executes remote database manager generation processing to generate a database manager to connect to the server specified with the server name. On the other hand, if the server name is not valid (step S10402: NO), the process moves on to step S10404 and executes the corresponding database manager generation processing to generate the database manager of the database specified on the transaction generation screen explained in FIG. 83.

In next step S10405, the implemented DB transaction initialization processing provided by the database manager generated is executed to initialize the internal data of the implemented DB transaction explained in FIG. 59.

In next step S10406, DB connection processing provided by the database manager generated above is executed to connect to the database under specified conditions. As a result of the DB connection processing, it is determined in next step S10407 whether the connection of the database has been successful or not. If the connection of the database has not been successful (S10407: NO), the system regards this as a “failure” and terminates the processing. On the other hand, if the connection of the database has been successful (S10407: YES), the process moves on to step S10408.

In step S10408, the connection-related information is stored in the internal data of the implemented DB transaction. Then, in step S10409, the given database change notification destination is stored in the DB listener. Then, in next step S10410, the implemented DB transaction generated above is added to the implemented DB transaction control list and the system regards this as a “success” and terminates the processing.

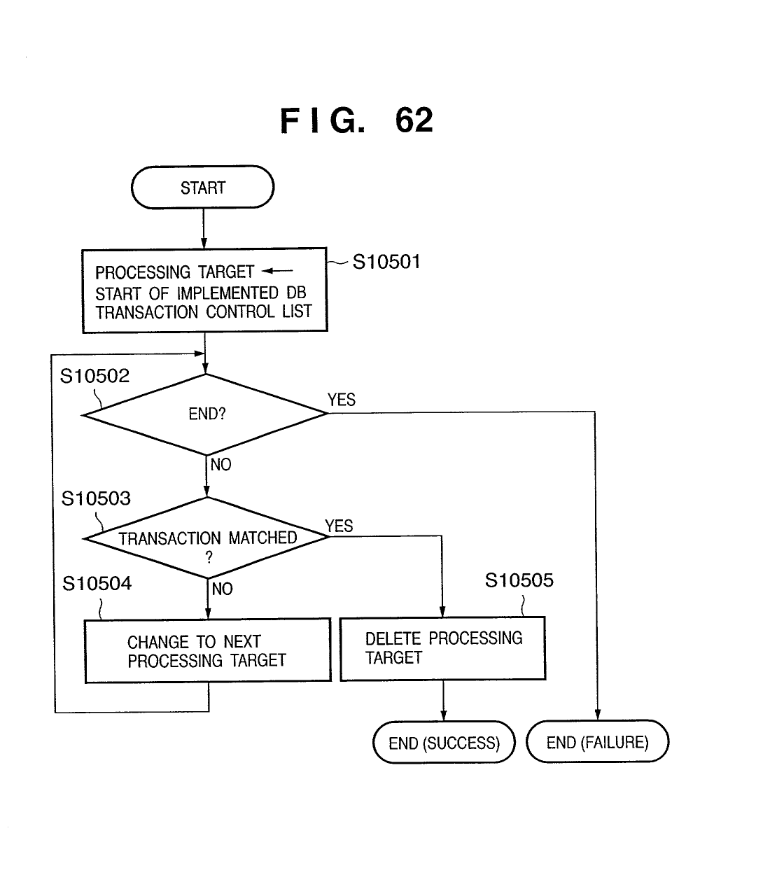

Then, in next step S10301, the DB transaction discarding processing in step S10301 will be explained using FIG. 62.

FIG. 62 is a flow chart showing details of DB transaction discarding processing in step S10301 according to Third Embodiment.

When the DB transaction discarding processing is started in step S10501, the processing target is set at the start of the implemented DB transaction control list and then processing for all implemented DB transactions to be processed is repeated from the following steps.

In next step S10502, it is determined whether the processing for all implemented DB transactions to be processed has been terminated or not. If the processing for all implemented DB transactions to be processed has been terminated (step S10502: YES), the system regards this as a “failure” and terminates the processing. On the other hand, if the processing for all implemented DB transactions to be processed has not been terminated (step S10502: NO), the process moves on to step S10503.

Then, it is determined in step S10503 whether the implemented DB transaction to be processed matches the implemented DB transaction to be discarded or not. If the implemented DB transaction to be processed matches the implemented DB transaction to be discarded (S10503: YES), the process moves on to step S10505, deletes the implemented DB transactions to be processed from the implemented DB transaction control list and the system regards this as a “success” and terminates the processing.

On the other hand, if the implemented DB transaction to be processed does not match the implemented DB transaction to be discarded (S10503: NO), the process moves on to step S10504, changes the implemented DB transaction to be processed to the next implemented DB transaction, goes back to step S10502 again and repeats the processing.

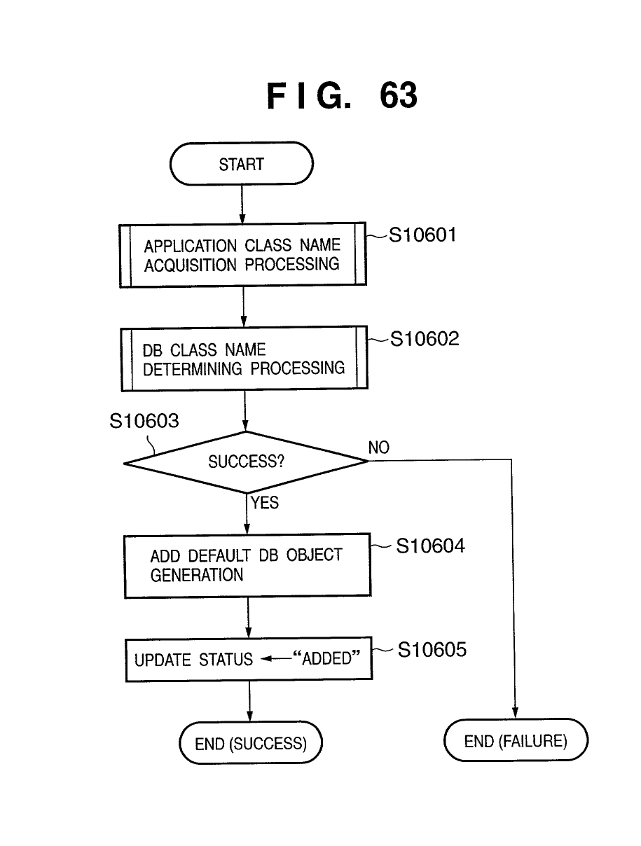

Next, details of the DB object generation/addition processing in step S6002 according to Third Embodiment will be explained using FIG. 63.

FIG. 63 is a flow chart showing details of the DB object generation/addition processing in step S6002 according to Third Embodiment.

When the DB object generation/addition processing is started, application class name acquisition processing is executed in step S10601 to acquire the application class name of the given application object. Then, in step S10602, the DB class name determining processing is executed to determine the database class name in the database corresponding to the application class name.

As a result of the DB class name determining processing, it is determined in next step S10603 whether the determination of the database class name has been successful or not. If the determination of the database class name has not been successful (S10603: NO), the system regards this as a “failure” and terminates the processing.

On the other hand, if the determination of the database class name has been successful (S10603: YES), the process moves on to step S10604.

Then, in step S10604, a default database object corresponding to the database class is generated and added. Then, in step S10605, an “Added” flag indicating that data has been added to the update status is added and the system regards this as a “success” and terminates the processing.

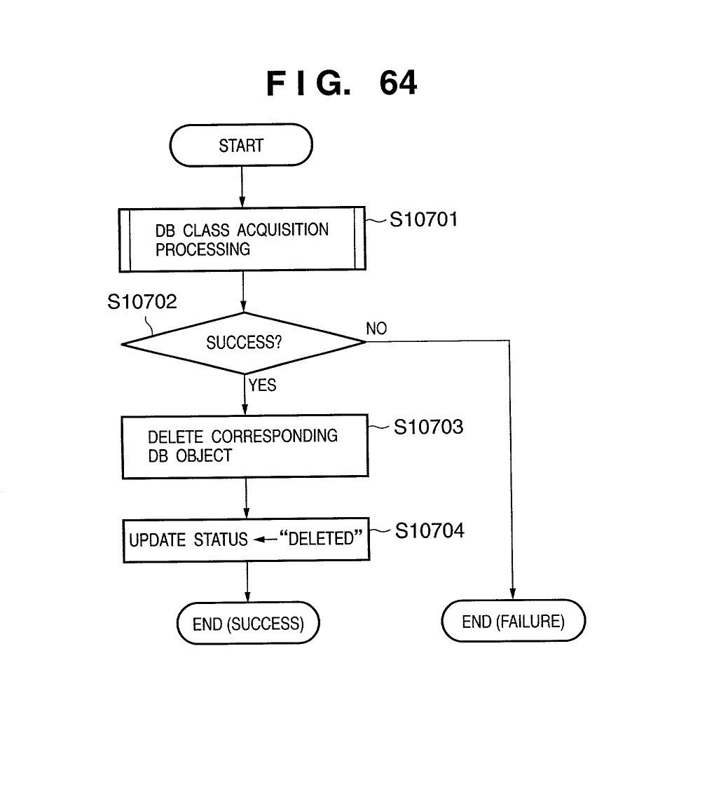

Then, details of the DB object deletion processing in step S6204 according to Third Embodiment will be explained using FIG. 64.

FIG. 64 is a flow chart showing details of DB object deletion processing according to Third Embodiment.

When the DB object deletion processing is started, DB class acquisition processing is executed in step S10701 to acquire a database class corresponding to the given database object.

As a result of the DB class acquisition processing, it is determined in next step S10702 whether the acquisition of the database class has been successful or not. If the acquisition of the database class has not been successful (step S10702: NO), the system regards this as a “failure” and terminates the processing. On the other hand, if the acquisition of the database class has been successful (step S10702:YES), the process moves on to step S10703.

In step S10703, the given database object is deleted using the service of the database class. Then, in step S10704, a “Deleted” flag indicating that the data has been deleted is added to the update status and the system regards this as a “success” and terminates the processing.

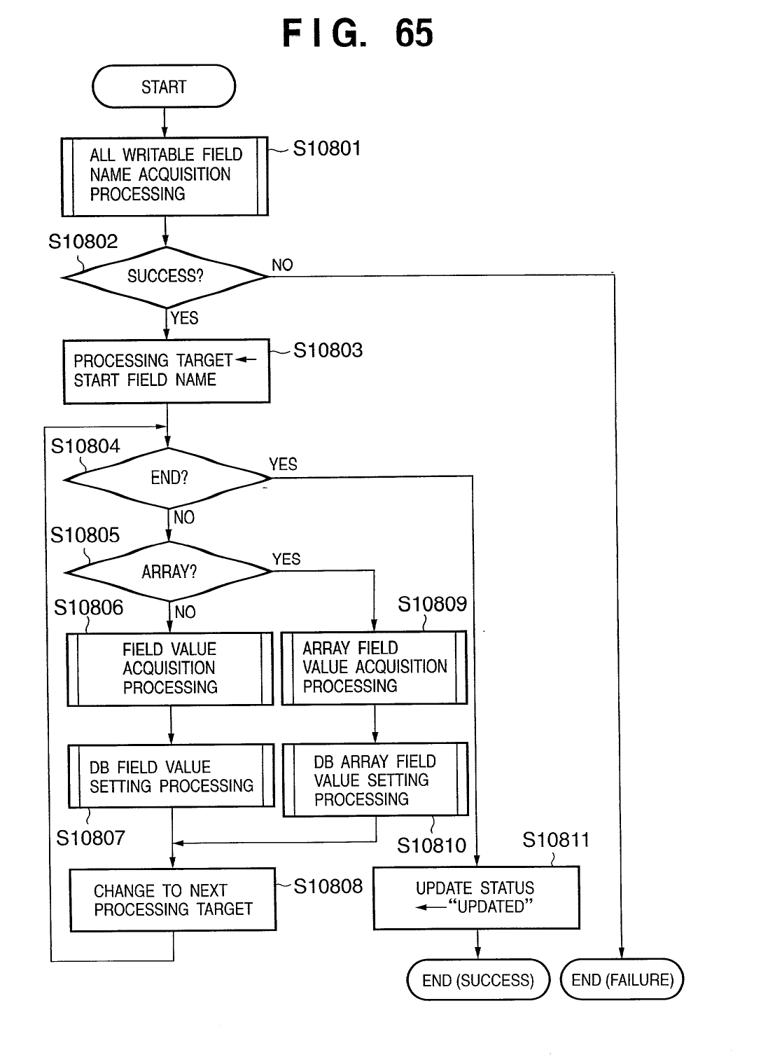

Then, details of the DB object value setting processing in step S5907 and step S6003 in the object addition processing in FIG. 31 and the object update processing in FIG. 32 according to Third Embodiment will be explained using FIG. 65.

FIG. 65 is a flow chart showing details of the DB object value setting processing in step S5907 and step S6003 according to Third Embodiment.

When the DB object value setting processing is started, all writable field name acquisition processing is executed in step S10801 and the definition of each field of the given application object is referenced to acquire all writable field names.

As a result of the all writable field name acquisition processing, it is determined in next step S10802 whether the acquisition of the field name has been successful or not. If the acquisition of the field name has not been successful (step S10802: NO), the system regards this as a “failure” and terminates the processing. On the other hand, if the acquisition of the field name has been successful (step S10802: YES), the process moves on to step S10803.

Then, in step S10803, the processing target is set at the start of the acquired all writable field name list and the processing on all fields to be processed is repeated in the following steps.

In next step S10804, it is determined whether the processing on all fields to be processed has been terminated or not. If the processing on all fields to be processed has been terminated (step S10804: YES), the process moves on to step S10811, gives an “Updated” flag indicating that data has been updated to the update status, the system regards this as a “success” and terminates the processing. On the other hand, if the processing on all fields to be processed has not been terminated (step S10804: NO), the process moves on to step S10805.

Then, it is determined in step S10805 whether the field to be processed is an array or not. If the field to be processed is not an array (S10805: NO), the process moves on to step S10806.

In step S10806, field value acquisition processing is executed to acquire the value corresponding to the field name to be processed of the given application object. In next step S10807, DB field value setting processing is executed to store the DB field value in the field corresponding to the database object. Then, in step S10808, the field to be processed is changed to the next field, the process goes back to step S10804 again and repeats the processing.

On the other hand, if the field to be processed is an array (S10805: YES), the process moves on to step S10809.

In step S10809, array field value acquisition processing is executed to acquire the value corresponding to the field name to be processed of the given application object. In next step S10810, DB field value setting processing is executed to store the DB field value in the field corresponding to the database object. Then, in step S10808, the field to be processed is changed to the next field, the process goes back to step S10804 again and repeats the processing.

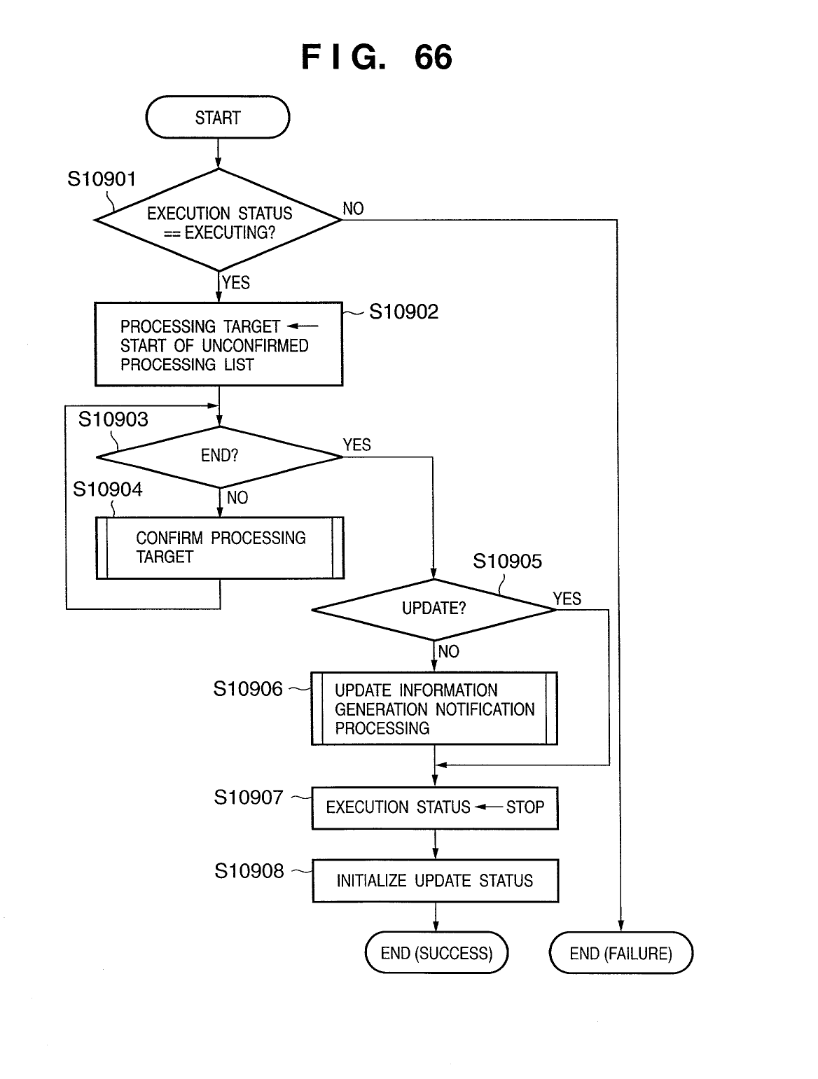

Then, details of the DB transaction confirmation processing in step S1804, step S1904, step S2004 and step 2104 according to Third Embodiment in the all object acquisition confirmation processing in FIG. 18, object addition confirmation processing in FIG. 19, object update confirmation processing in FIG. 20, object deletion confirmation processing in FIG. 21 will be explained using FIG. 66.

FIG. 66 is a flow chart showing details of the DB transaction confirmation processing in step S1804 and step S1904, step S2004 and step S2104 according to Third Embodiment.

When the DB transaction confirmation processing is started, the execution status of the internal data of the layered DB transaction explained in FIG. 59 is referenced to determine whether the execution status is “executing” or not. If the execution status is not “executing” (step S10901: NO), the system regards this as a “failure” and terminates the processing. On the other hand, if the execution status is “executing” (step S10901: YES), the process moves on to step S10902.

Then, in step S10902, the processing target is set at the start of the unconfirmed processing list and the processing on all processing targets is repeated in the following steps.

In next step S10903, it is determined whether the processing on all processing targets has been terminated or not. If the processing on all processing targets has not been terminated (step S10903: NO), the process moves on to step S10904, executes the processing target confirmation processing to confirm the processing content carried out on the target database and moves on to step S10903.

On the other hand, if the processing on processing targets has been terminated (step S10903: YES) in step S10903, the process moves on to step S10905.

In step S10905, the update status is referenced to determine whether the status has been updated or not. If the status has been updated (S10905: YES), the process moves on to step S10907. On the other hand, if the status has not been updated (S10905: NO), the process moves on to step S10906.

Then, in step S10906, update information generation notification processing is executed to notify the update information to the corresponding database.

Then, in next step S10907, the execution status is changed to “stop”. Then, in step S10908, the update status is initialized and the system regards this as a “success” and terminates the processing.

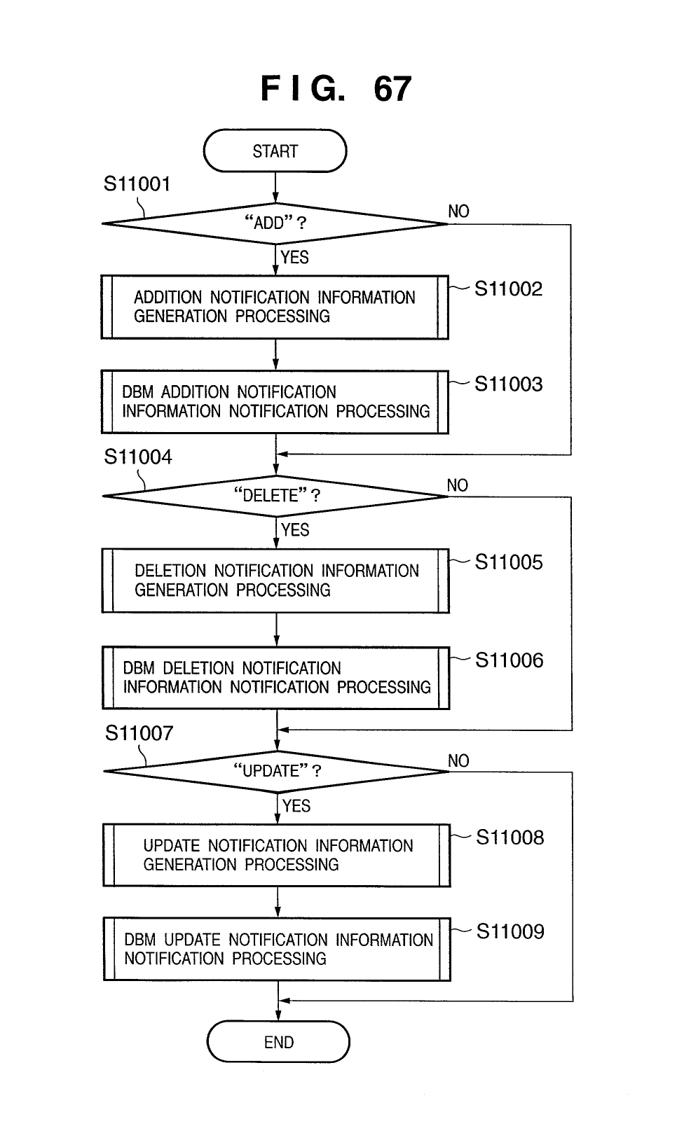

Then, details of the update information generation notification processing in step S10906 will be explained using FIG. 67.

FIG. 67 is a flow chart showing details of the update information generation notification processing in step S10906 according to Third Embodiment.

When the update information generation notification processing is started, in step S11001, the update status of the internal data of the layered DB transaction explained in FIG. 59 is referenced to determine whether the update status is “Added” or not. If the update status is not “Added” (S11001: NO), the process moves on to step S11004. On the other hand, if the update status is “Added” (S11001: YES), the process moves on to step S11002.

In step S11002, addition notification information generation processing is executed to generate addition notification information to be notified. Then, in step S11003, DBM addition notification information notification processing is executed to notify the addition notification information generated to the database.

In next step S11004, the update status of the internal data of the DB transaction explained in FIG. 59 is referenced to determine whether the update status is “Deleted” or not. If the update status is not “Deleted” (step S11004: NO), the process moves on to step S11007. On the other hand, if the update status is “Deleted” (step S11004: YES), the process moves on to step S11005.

In step S11005, deletion notification information generation processing is executed to generate deletion notification information to be notified. Then, in step S11006, DBM deletion notification information processing is executed to notify the deletion notification information generated to the corresponding database.

In next step S11007, the update status of the internal data of the DB transaction explained in FIG. 59 is referenced to determine whether the update status is “Updated” or not. If the update status is not “Updated” (step S11007: NO), the processing is terminated. On the other hand, if the update status is “Updated” (step S11007: YES), the process moves on to step S11008.

In step S11008, update notification information generation processing is executed to generate update notification information to be notified. Then, in step S11009, DBM update notification information notification processing is executed to notify the update notification information generated to the corresponding database.

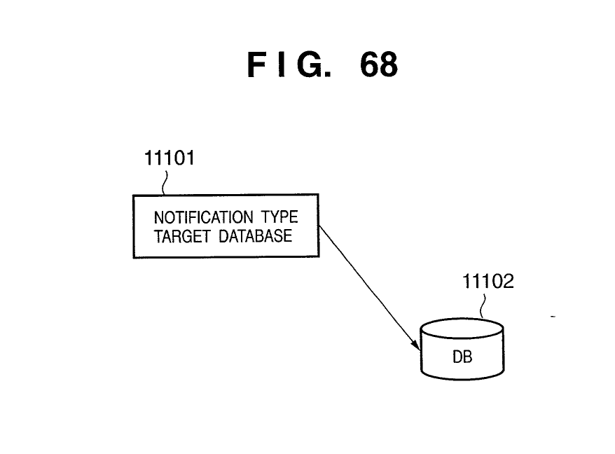

Then, notification information generated by the update notification information generation notification processing in step S11008 will be explained using FIG. 68.

FIG. 68 illustrates an example of notification information generated by the update notification information generation processing in step S11008 according to Third Embodiment.

Notification information 11101 includes a target database 11102 that contains a notification type indicating the type of notification information and the corresponding database.

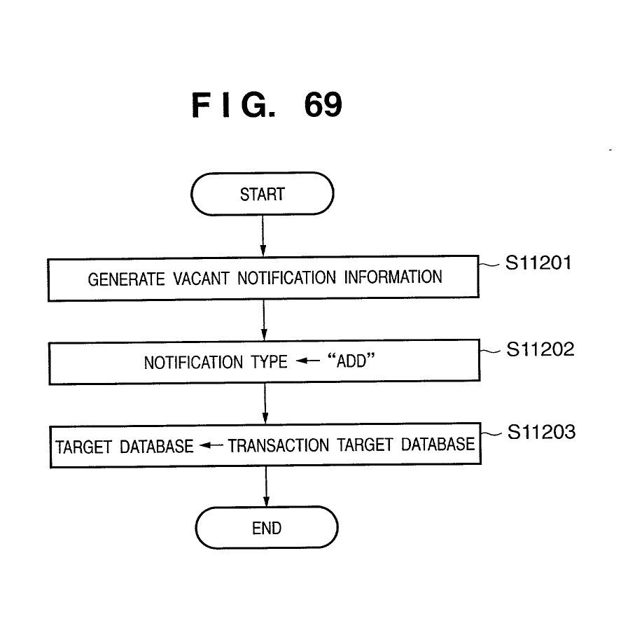

Then, details of the addition notification information generation processing in step S11002 will be explained using FIG. 69.

FIG. 69 is a flow chart showing details of the addition notification information generation processing in step S11002 according to Third Embodiment.

When the addition notification information generation processing is started, the above notification information is generated in step S11201. In next step S11202, an “Added” flag indicating that data has been added to the database is set in the notification type of the above notification information. In next step S11203, the information of the target database of the transaction itself is set in the target database of the above notification information and the processing is terminated.

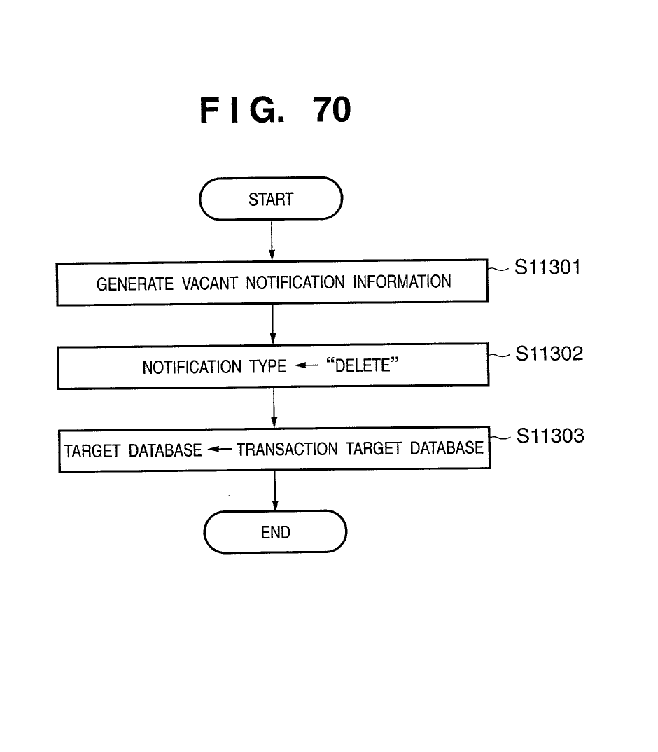

Then, details of the deletion notification information generation processing in step S11005 will be explained using FIG. 70.

FIG. 70 is a flow chart showing details of the deletion notification information generation processing in step S11005 according to Third Embodiment.

When the deletion notification information generation processing is started, the above notification information is generated in step S11301. In next step S11302, a “Deleted” flag indicating that data has been deleted from the database is set in the notification type of the above notification information. In next step S11303, the information of the target database of the transaction itself is set in the target database of the above notification information and the processing is terminated.

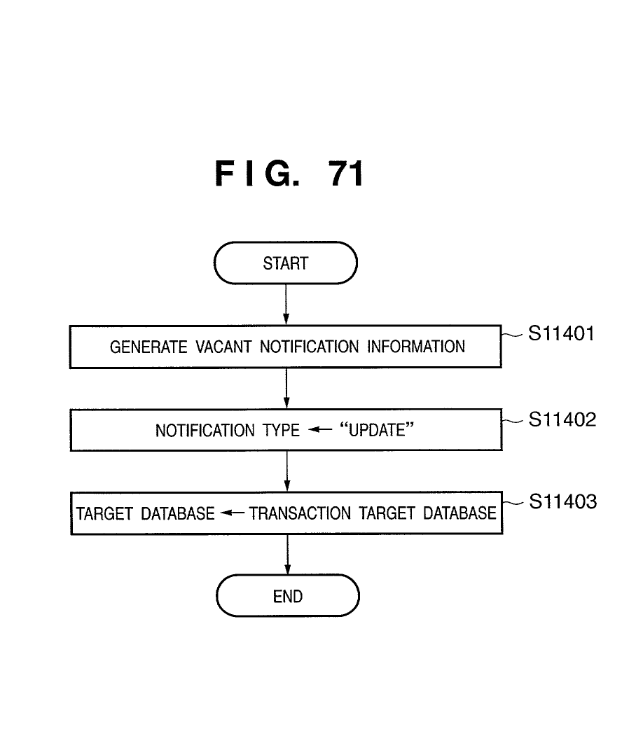

Then, details of the update notification information generation processing in step S11008 will be explained using FIG. 71.

FIG. 71 is a flow chart showing details of the update notification information generation processing in step S11008 according to Third Embodiment.

When the update notification information generation processing is started, the above notification information is generated in step S11401. In next step S11402, an “Updated” flag indicating that data of the database has been updated is set in the notification type of the above notification information. In next step S11403, the information of the target database of the transaction itself is set in the target database of the above notification information and the processing is terminated.

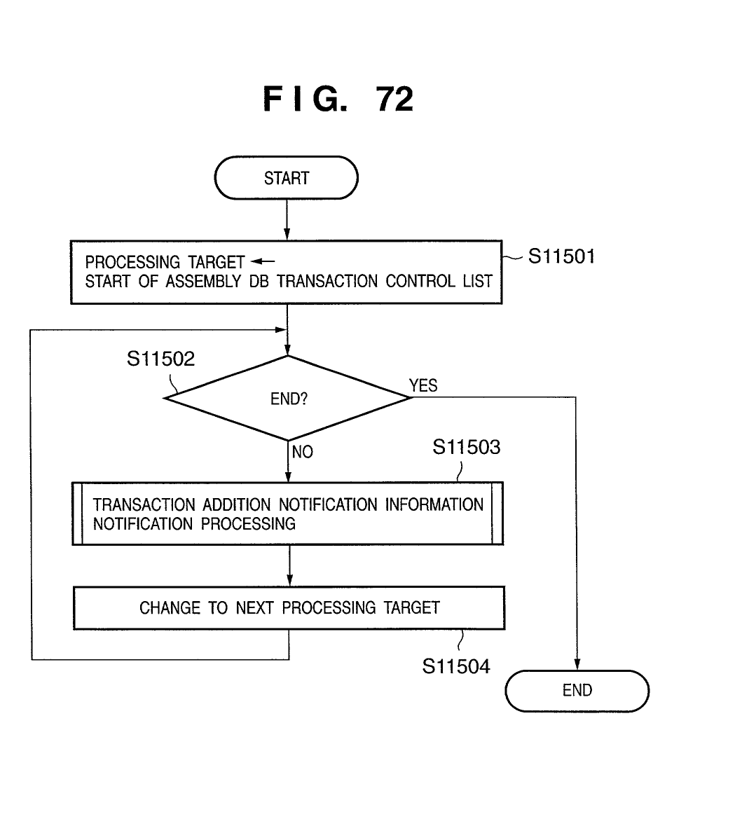

Then, the DBM addition notification information notification processing in step S11003 will be explained using FIG. 72.

FIG. 72 is a flow chart showing details of the DBM addition notification information notification processing in step S11003 according to Third Embodiment.

When the DBM addition notification information notification processing is started in step S11501, the transaction to be processed is set at the start of the implemented DB transaction control list of the DBM itself and then processing on all transactions to be processed is repeated in the following steps.

In next step S11502 it is determined whether processing on all transactions to be processed has been terminated or not. If processing on all transactions to be processed has been terminated (step S11502: YES), the processing is terminated. On the other hand, if the processing on all transactions to be processed has not been terminated (step S11502: NO), the process moves on to step S11503.

In step S11503, transaction addition notification information notification processing provided by the transaction to be processed is executed and the notification information is notified to the corresponding database. In next step S11504, the transaction to be processed is changed to the next transaction, the process goes back to step 11502 again and repeats the processing.

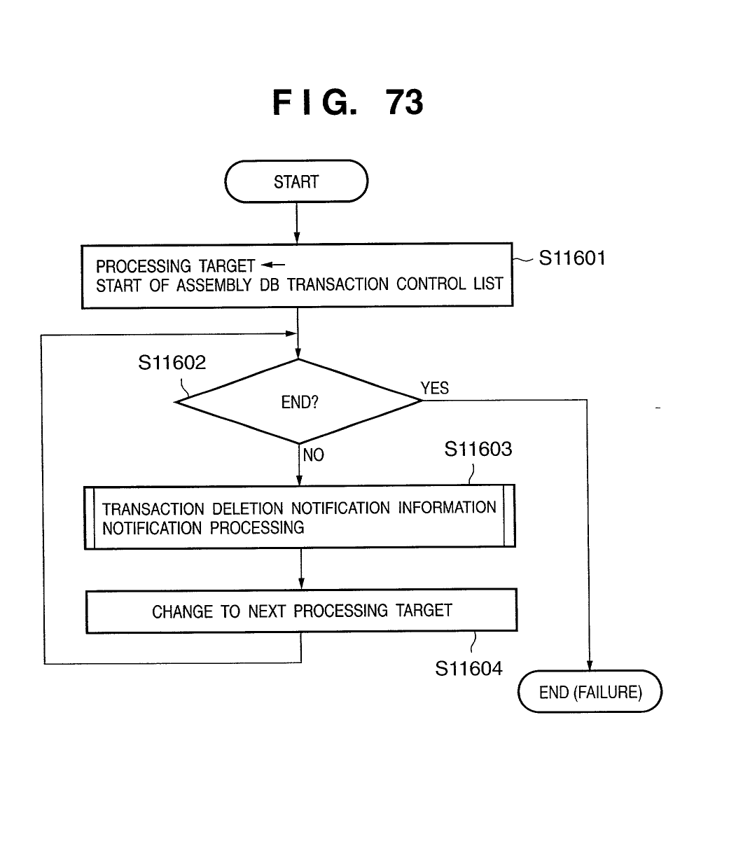

Then, details of the DBM deletion notification information notification processing in step S11006 will be explained using FIG. 73.

FIG. 73 is a flow chart showing details of the DBM deletion notification information notification processing in step S11006 according to Third Embodiment.

When the DBM deletion notification information notification processing is started, in step S11601, the transaction to be processed is set at the start of the implemented DB transaction control list of the DBM itself and then processing on all transactions to be processed is repeated in the following steps.

In next step S11602 it is determined whether processing on all transactions to be processed has been terminated or not. If processing on all transactions to be processed has been terminated (step S11602: YES), the processing is terminated. On the other hand, if processing on all transactions to be processed has not been terminated (step S11602: NO), the process moves on to step S11603.

In step S11603, transaction deletion notification information notification processing provided by the transaction to be processed is executed and the notification information is notified to the corresponding database. In next step S11604, the transaction to be processed is changed to the next transaction, the process goes back to step 11602 again and repeats the processing.

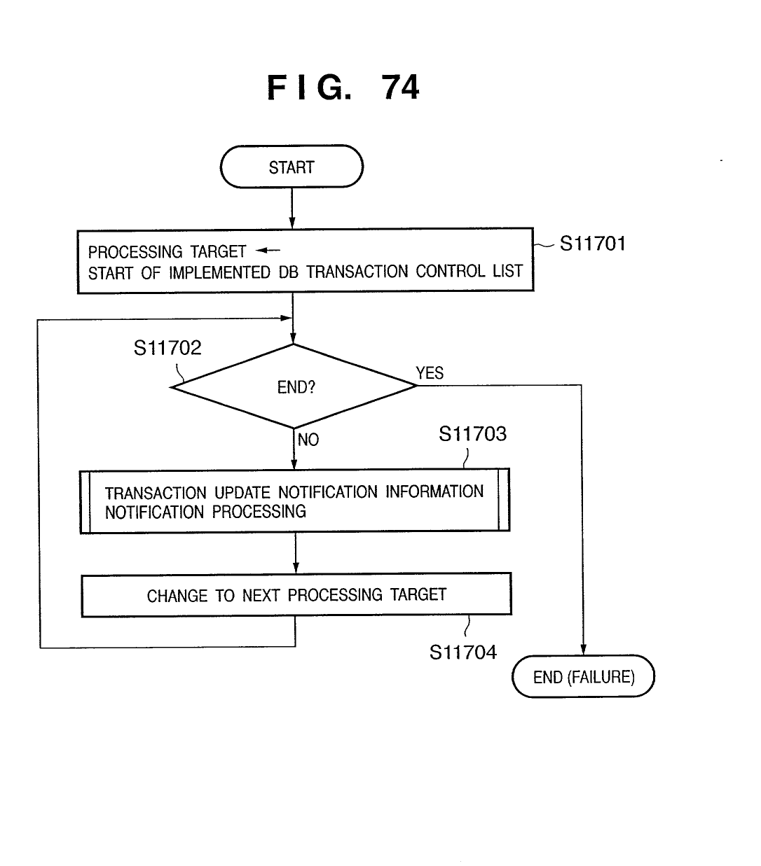

Then, details of the DBM update notification information notification processing in step S11009 will be explained using FIG. 74.

FIG. 74 is a flow chart showing details of the DBM update notification information notification processing in step S11009 according to Third Embodiment.

When the DBM update notification information notification processing is started, in step S11701, the transaction to be processed is set at the start of the implemented DB transaction control list of the DBM itself and then processing on all transactions to be processed is repeated in the following steps.

In next step S11702, it is determined whether processing on all transactions to be processed has been terminated or not. If processing on all transactions to be processed has been terminated (step S11702: YES), the processing is terminated. On the other hand, if processing on all transactions to be processed has not been terminated (step S11702: NO), the process moves on to step S11703.

In step S11703, transaction update notification information notification processing provided by the transaction to be processed is executed and the notification information is notified to the corresponding database. In next step S11704, the transaction to be processed is changed to the next transaction, the process goes back to step 11702 again and repeats the processing.

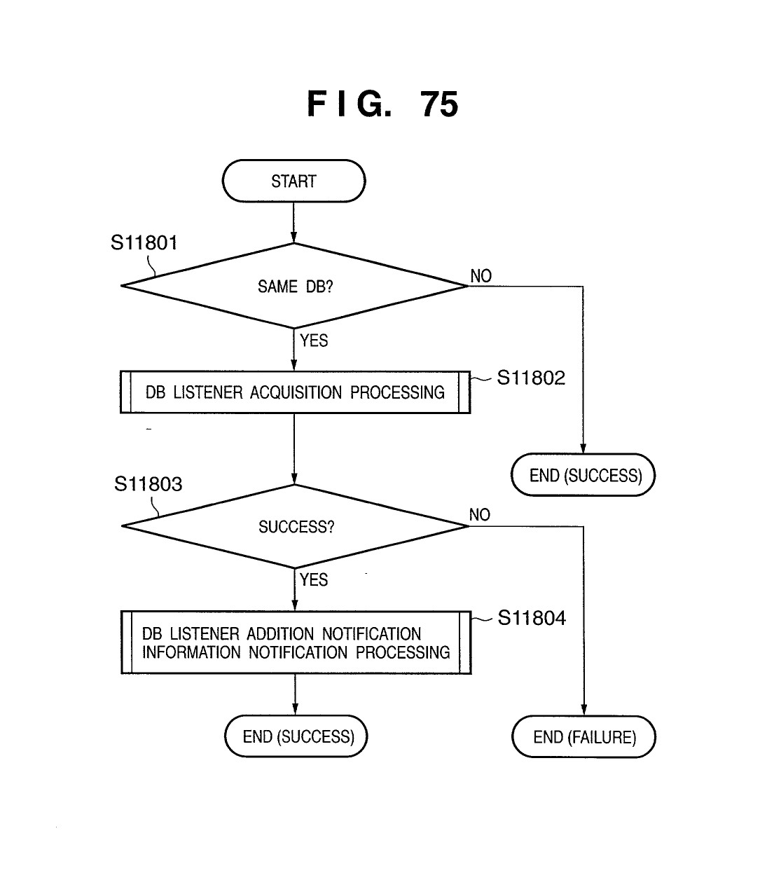

Then, details of the transaction addition notification information notification processing in step S11503 will be explained using FIG. 75.

FIG. 75 is a flow chart showing details of the transaction addition notification information notification processing in step S11503 according to Third Embodiment.

When the transaction addition notification information notification processing is started, it is determined in step S11801 whether the target database of the notification information matches the target database of the notification information or not. If the target database of the notification information does not match the target database of the notification information (step S11801: NO), since there is not need for notification, the system regards this as a “success” and terminates the processing. On the other hand, if the target database of the notification information matches the target database of the notification information (step S11801: YES),the process moves on to step S11802.

In step S11802, DB listener acquisition processing is executed to acquire the previously registered database change notification destination.

Then, it is determined in step S11803 whether the acquisition of the database change notification destination has been successful or not. If the acquisition of the database change notification destination has not been successful (step S11803: NO), since notification has failed, the system regards this as a “failure” and terminates the processing. On the other hand, if the acquisition of the database change notification destination has been successful (step S11803: YES), the process moves on to step S11804.

In step S11804, the DB listener addition notification information notification processing provided by the database change notification destination is executed, the process notifies the notification information to the corresponding database, regards this as a “success” and terminates the processing.

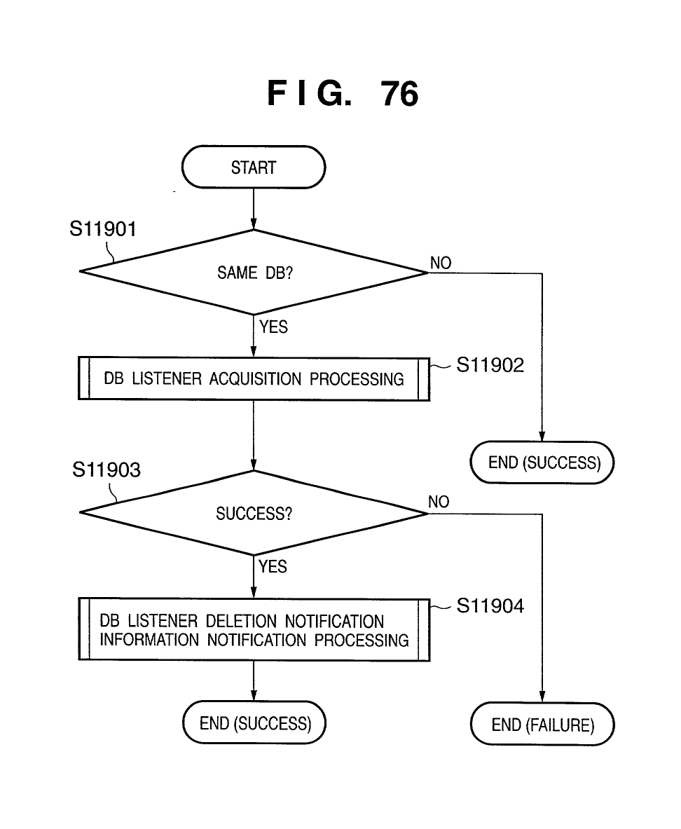

Then, details of the transaction deletion notification information notification processing in step S11603 will be explained using FIG. 76.

FIG. 76 is a flow chart showing details of the transaction deletion notification information notification processing in step S11603 according to Third Embodiment.

When the transaction deletion notification information notification processing is started, it is determined in step S11901 whether the target database of the notification information matches the target database of the transaction itself or not. If the target database of the notification information does not match the target database of the transaction itself (step S11901: NO), since there is no need for notification, the system regards this as a “success” and terminates the processing. On the other hand, if the target database of the notification information matches the target database of the transaction itself (step S11901: YES), the process moves on to step S11902.

In step S11902, DB listener acquisition processing is executed to acquire the previously registered database change notification destination.

Then, it is determined in step S11903 whether the acquisition of the database change notification destination has been successful or not. If the acquisition of the database change notification destination has not been successful (step S11903: NO), since notification has failed, the system regards this as a “failure” and terminates the processing. On the other hand, if the acquisition of the database change notification destination has been successful (step S11903: YES), the process moves on to step S11904.

In step S11904, the DB listener deletion notification information notification processing provided by the database change notification destination is executed, the system notifies the notification information to the corresponding database, regards this as a “success” and terminates the processing.

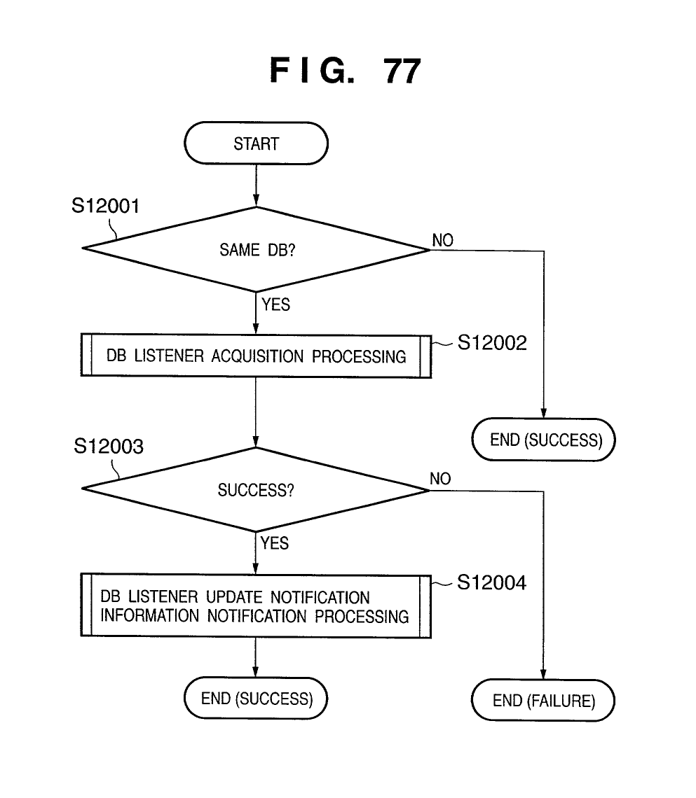

Then, details of the transaction update notification information notification processing in step S11703 will be explained using FIG. 77.

FIG. 77 is a flow chart showing details of the transaction update notification information notification processing in step S11703 according to Third Embodiment.

When the transaction update notification information notification processing is started, it is determined in step S12001 whether the target database of the notification information matches the target database of the transaction itself or not. If the target database of the notification information does not match the target database of the transaction itself (step S12001: NO), since there is not need for notification, the system regards this as a “success” and terminates the processing. On the other hand, if the target database of the notification information matches the target database of the transaction itself (step S12001: YES),the process moves on to step S12002.

In step S12002, DB listener acquisition processing is executed to acquire the previously registered database change notification destination. Then, it is determined in step S12003 whether the acquisition of the database change notification destination has been successful or not. If the acquisition of the database change notification destination has not been successful (step S12003: NO), since notification has failed, the system regards this as a “failure” and terminates the processing. On the other hand, if the acquisition of the database change notification destination has been successful (step S12003: YES), the process moves on to step S12004.

In step S12004, the DB listener update notification information notification processing provided by the database change notification destination is executed, the process notifies the notification information to the corresponding database, regards this as a “success” and terminates the processing.

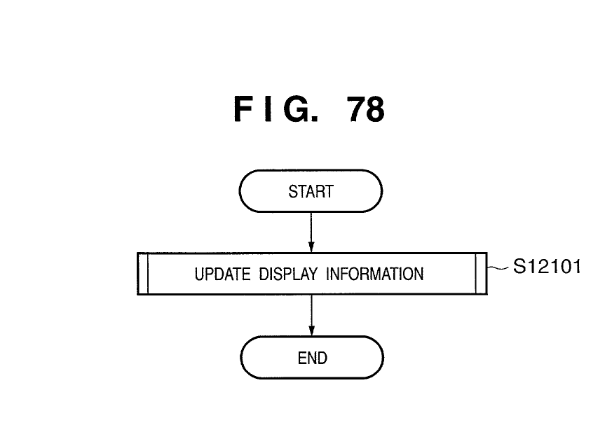

Then, details of the DB listener addition notification information notification processing in step S11804 will be explained using FIG. 78.

FIG. 78 is a flow chart showing details of the DB listener addition notification information notification processing in step S11804 according to Third Embodiment.

When the DB listener addition notification information notification processing is started, in step S12101, display information update processing is executed to update the information being displayed according to the notification information above and execute redrawing.

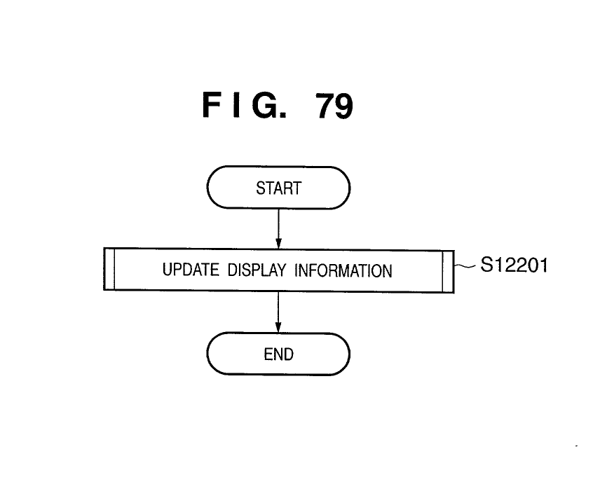

Then, details of the DB listener deletion notification information notification processing in step S11904 will be explained using FIG. 79.

FIG. 79 is a flow chart showing details of the DB listener deletion notification information notification processing in step S11904 according to Third Embodiment.

When the DB listener deletion notification information notification processing is started, in step S12201, display information update processing is executed to update the information being displayed according to the notification information above and execute redrawing.

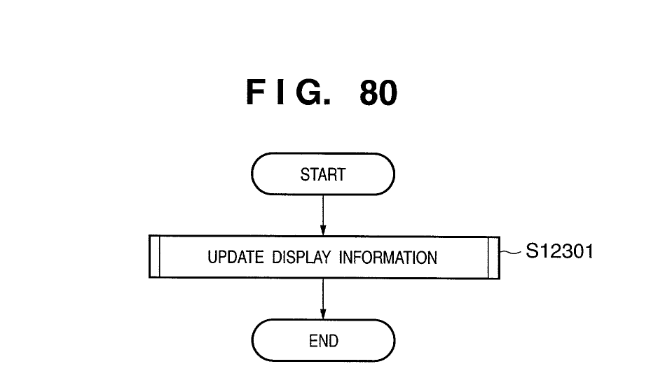

Then, details of the DB listener update notification information notification processing in step S12004 will be explained using FIG. 80.

FIG. 80 is a flow chart showing details of the DB listener update notification information notification processing in step S12004 according to Third Embodiment.

When the DB listener update notification information notification processing is started, in step S12301, display information update processing is executed to update the information being displayed according to the notification information above and execute redrawing.

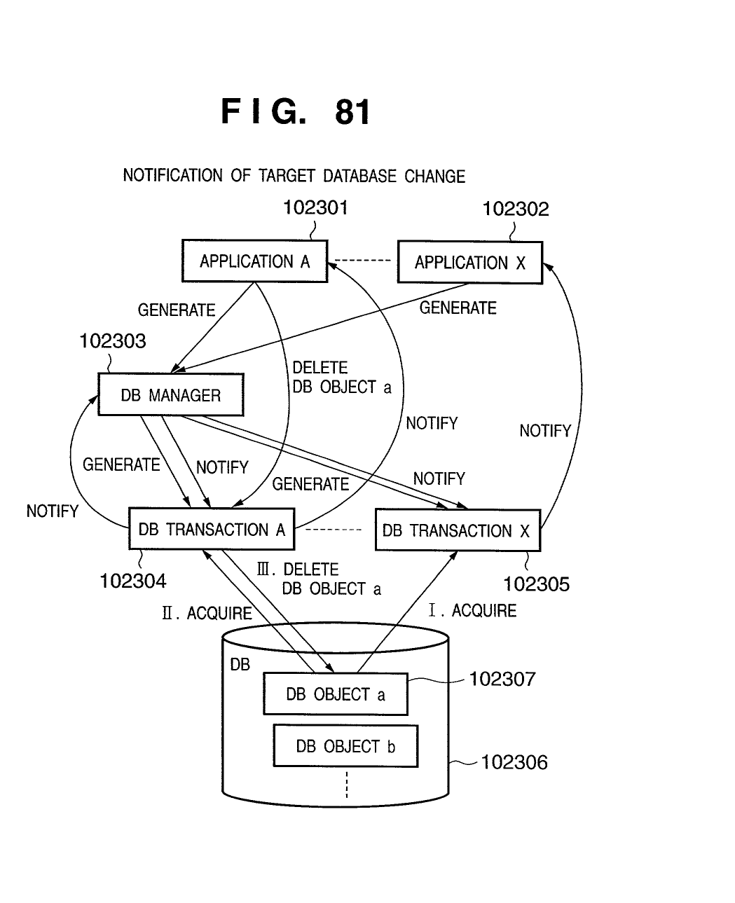

Then, FIG. 81 illustrates an example of solving problems when a plurality of applications accesses same database according to this Embodiment.

In the same figure, an application A102301 and application X102302 are generating a DB transaction A102304 and a DB transaction X102305 using a DB manager 102303 to access an identical database 102306.

Here, while the application X102302 acquires (I) a DB object a102307 stored in the database 102306, if the application A102301 acquires (II) or deletes (III) the DB object a102307, notification information indicating that the DB transaction A102304 has deleted the DB object a102307 is notified to the DB manager 102303.

The DB manager 102303 notifies the above notification information to the DB transaction A102304 and DB transaction X102305 under its control and their respective DB transactions notify the above notification information to the corresponding applications.

This processing allows the change of the database 102306 caused by the application A102301 to be notified to the application X102302, and therefore the application X102302 recognizes that the DB object a102307 has been deleted and can thereby take appropriate action. In FIG. 81, the application X102302 has not carried out an update operation in response to the deletion of the DB object a102307.

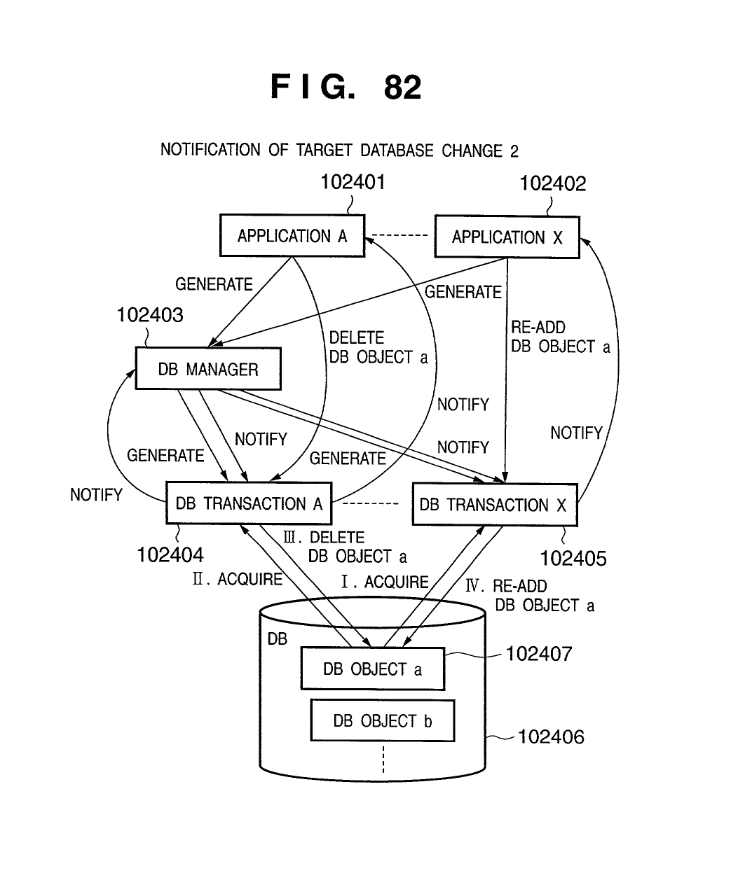

Then, FIG. 82 illustrates another example of solving problems when a plurality of applications accesses same database according to this Embodiment.

In the same figure, an application A102401 and application X102402 a regenerating a DB transaction A102404 and a DB transaction X102405 using a DB manager 102403 to access an identical database 102406.

Here, while the application X102402 acquires (I) a DB object a102407 stored in the database 102406, if the application A102401 acquires (II) or deletes (III) the DB object a102407, notification information indicating that the DB transaction A102404 has deleted the DB object a102407 is notified to the DB manager 102403.

The DB manager 102403 notifies the above notification information to the DB transaction A102404 and DB transaction X102405 under its control and their respective DB transactions notify the above notification information to the corresponding applications.

This processing allows the change of the database 102406 caused by the application A102401 to be notified to the application X102402, and therefore the application X102402 recognizes that the DB object a102407 has been deleted and can thereby take appropriate action. In FIG. 82, the application X102402 has re-added (IV) the DB object a102407 after the change in response to the deletion of the DB object a102407.

As described above, according to Third Embodiment for a database storing permanent data, a notification destination to which changes of the database are notified is registered to control a series of a plurality of database transactions corresponding to the database. Then, when a change occurs to the database handled by the database transaction itself, the control destination that controls the database transaction is notified and when notified of the change of the database from the control destination, the database itself notifies the change content to a plurality of database transactions under its control. In addition, the change content is notified to the registered corresponding notification destination.

This allows the change of the database to be notified to the related application programs so that the application programs can execute appropriate processing. Third Embodiment also allows the application to know the change of the target database without putting a restriction that data being accessed by an application is not accessible to other applications, making it possible to avoid unexpected failures, execute appropriate processing such as redrawing and implement appropriate processing.

The preferred embodiments of the present invention have been described so far and it goes without saying that it is possible to attain the object of the present invention also by supplying a software program that implements the functions of the foregoing embodiments to a system or apparatus, making a computer (or CPU or MPU) of the system or apparatus read and execute the program.

In this case, the computer program itself implements the functions of the foregoing embodiments and the program and the storage medium that stores the program or program product constitute the present invention. It also goes without saying that not only the computer implements the functions of the foregoing embodiments by executing the program codes read by the computer but also the operating system (OS), etc. operating on the computer carries out part or all of the actual processing and the functions of the foregoing embodiments are implemented by that processing.

Furthermore, it also goes without saying that the present invention also includes a case where program codes read from a storage medium are written into memory provided for a function expansion card inserted in the computer or a function expansion unit connected to the computer, then the CPU, etc. incorporated in the function expansion card or function expansion unit carries out part or all of the actual processing and the functions of the foregoing embodiments are implemented by that processing.

As many apparently widely different embodiments of the present invention can be made without departing from the spirit and scope thereof, it is to be understood that the invention is not limited to the specific embodiments thereof except as defined in the claims.

What is claimed is:

1. An information processor that accepts accesses to a database by applications, comprising notifying means for notifying, when the content of said database is changed by one of said applications, the rest of said applications of the change.

2. The information processor according to claim 1, wherein said notifying means carries out said notification when a plurality of said applications accesses same data of said database.

3. The information processor according to claim 1, wherein the change of the content of said database includes any one of a deletion from, addition to or update of the data of said database.

4. The information processor according to claim 1, further comprising database change notification destination registering means for registering the notification destination of said notification by said notifying means, wherein said notifying means carries out said notification to said registered notification destination.

5. The information processor according to claim 1, further comprising database change status means for indicating whether said database has been changed or not, wherein said notifying means carries out said notification only when said database change status means indicates that said database has been changed.

6. The information processor according to claim 5, further comprising:
database adding means for carrying out data addition processing on said database; and
status addition information adding means for adding, when said database adding means has executed said addition processing, information that data has been added, to said database change status means.

7. The information processor according to claim 5, further comprising:
database deleting means for carrying out data deletion processing on said database; and
status deletion information adding means for adding, when said database deleting means has executed said deletion processing, information that data has been deleted, to said database change status means.

8. The information processor according to claim 5, further comprising:
database updating means for carrying out data update processing on said database; and
status update information adding means for adding, if said database updating means has executed said update processing, information that data has been updated, to said database change status means.

9. The information processor according to claim 1, wherein said notifying means comprising:
database transaction means for carrying out a series of predetermined processes on said database; and
database controlling means for controlling said database transaction means.

10. The information processor according to claim 9, wherein said database transaction means comprises database control notifying means for, when processing of said database transaction means has caused a change to said database, notifying the change to said database controlling means,
said database controlling means comprises transaction notifying means for, when said database transaction means under the control of said database controlling means has carried out said notification, carrying out notification thereof, and
said database transaction means, when said database controlling means has carried out said notification, notifies said predetermined application thereof.

11. The information processor according to claim 10, wherein said database controlling means includes a transaction control list for storing information of said database transaction means, and
said transaction notifying means carries out said notification to said database transaction means stored in said transaction control list.

12. The information processor according to claim 11, further comprising:
database transaction generating means for generating said database transaction means;
transaction control list adding means for, when said database transaction generating means has generated said database transaction means, adding information of said generated database transaction generating means to said transaction control list.

13. The information processor according to claim 11, further comprising:
database transaction discarding means for discarding said database transaction means; and
transaction control list deleting means for, when said database transaction discarding means has discarded said database transaction means, deleting information of said discarded database transaction means from said transaction control list.

14. The information processor according to claim 10, wherein said database transaction means comprises database transaction confirming means for confirming the change made to said database, and
said database control notifying means carries out said notification when said database transaction confirming means executes processing.

15. The information processor according to claim 10, wherein said database control notifying means comprises notification information generating means for generating notification information for said notification and notifies said generated notification information.

16. The information processor according to claim 15, wherein said notification information includes the type of the change of said database and information of said changed database.

17. The information processor according to claim 10, wherein said transaction notifying means comprises notification determining means for determining whether said notification should be carried out or not and carries out said notification only when said notification determining means determines that said notification should be carried out.

18. The information processor according to claim 17, wherein said notification determining means determines that said notification should be carried out when said database of the notification destination matches said database to be processed by said transaction means.

19. The information processor according to claim 1, further comprising notification corresponding means for carrying out processing corresponding to notification by said notifying means.

20. An information processing method that accepts accesses to a database by applications, comprising the step of notifying, when the content of said database is changed by one of said applications, the rest of said applications of the change.

21. A storage medium that stores a program for rendering a computer that accepts accesses to a database by applications to function as notifying means for notifying, when the content of said database is changed by one of said applications, the rest of said applications of the change.

22. A program for rendering a computer that accepts accesses to a database by applications to function as notifying means for notifying, when the content of said database is changed by one of said applications, the rest of said applications of the change.
